(19) United States
(12) Patent Application Publication
(10) Pub. No.: US 2026/0323438 A1
(43) Pub. Date: Oct. 15, 2026

(54) METHODS AND DEVICES FOR CONFIGURING MEASUREMENT FOR A FAST CELL SWITCH

(71) Applicant: Google LLC, MOUNTAIN VIEW, CA (US)

(72) Inventor: Chih-Hsiang WU, Taoyuan City (TW)

(21) Appl. No.: 19/483,849

(22) PCT Filed: May 16, 2024
(86) PCT No.: PCT/US2024/029711

§ 371 Date: Nov. 12, 2025

Related U.S. Application Data
(60) Provisional application No. 63/467,830, filed on May 19, 2023.
(60) Provisional application No. 63/527,943, filed on Jul. 20, 2023.

(51) Int. Cl. H04W 36/04; H04L 5/00; H04W 36/00

(52) U.S. Cl. CPC H04W 36/04; H04L 5/0051; H04W 36/0033; H04W 36/0058

(57) ABSTRACT

Methods and devices operate within a radio access network to facilitate a fast serving cell change using a lower-layer triggered mobility, LTM, procedure, reducing latency and overhead relative to L3-triggered cell-switching procedures. A wireless communication method (900A) performed by a distributed unit, DU, of a network entity includes receiving (904), from a centralized unit, CU, of the network entity, a CU-to-DU message identifying a target cell and directing the distributed unit to prepare an LTM DU configuration for switching a UE from a source cell to the target cell. The wireless communication method further includes transmitting (910), to the CU, the LTM DU configuration and a reference signal resource configuration for at least one reference signal to be transmitted on the target cell.

### FIELD OF THE DISCLOSURE

This disclosure relates to wireless communications and, more particularly, to configuring measurements for a fast cell switch for a user equipment, UE.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol, PDCP, sublayer of the radio protocol stack provides services such as transfer of user-plane data, ciphering, integrity protection, etc. For example, the PDCP layer defined for the Evolved Universal Terrestrial Radio Access, EUTRA, radio interface (see 3^{rd} Generation Partnership Project, 3GPP, specification TS 36.323) and New Radio, NR, (see 3GPP specification TS 38.323) provides sequencing of protocol data units, PDUs, in the uplink direction (from a user device, also known as a user equipment, UE, to a base station) as well as in the downlink direction (from the base station to the UE).

Further, the PDCP sublayer provides signaling radio bearers, SRBs and data radio bearers, DRBs, to the Radio Resource Control, RRC, sublayer. Generally speaking, the UE and a base station may use SRBs to exchange RRC messages as well as non-access stratum, NAS, messages and may use DRBs to transport data on a user plane.

UEs may use several types of SRBs and DRBs. When operating in dual connectivity, DC, the cells associated with the base station operating the master node, MN, define a master cell group, MCG, and the cells associated with the base station operating as the secondary node, SN, define the secondary cell group, SCG. So-called SRB1 resources carry RRC messages, which in some cases include NAS messages over the dedicated control channel, DCCH, and SRB2 resources support RRC messages that include logged measurement information or NAS messages, also over the DCCH but with lower priority than SRB1 resources. More generally, SRB1 and SRB2 resources, which allow the UE and the MN to exchange RRC messages related to the MN and embedded RRC messages related to the SN, may be referred to as MCG SRBs. SRB3 resources, which allow the UE and the SN to exchange RRC messages related to the SN, may be referred to as SCG SRBs. Split SRBs allow the UE to exchange RRC messages directly with the MN via lower layer resources of the MN and the SN. Further, DRBs using the lower-layer resources of only the MN may be referred as MCG DRBs, DRBs using the lower-layer resources of only the SN may be referred as SCG DRBs, and DRBs using the lower-layer resources of both the MCG and the SCG may be referred to as split DRBs.

The UE in some scenarios may concurrently utilize resources of multiple radio access network, RAN, nodes (e.g., base stations or components of a distributed base station), interconnected by a backhaul. When these network nodes support different radio access technologies, RATs, this type of connectivity is referred to as Multi-Radio Dual Connectivity, MR-DC. When a UE operates in MR-DC, one base station operates as a master node, MN, that covers a primary cell, PCell, and the other base station operates as a secondary node, SN, that covers a primary secondary cell, PSCell. The UE communicates with the MN (via the PCell) and the SN (via the PSCell). In other scenarios, the UE utilizes resources of one base station at a time. One base station and/or the UE determines that the UE should establish a radio connection with another base station. For example, one base station may determine to hand the UE over to the second base station and initiate a handover procedure.

The UE moving from a coverage area of one cell to a coverage area of another cell in a RAN causes, at some point, a serving cell change for the UE. To perform the serving cell change, the RAN configures the UE to transmit Layer 3, L3, measurement results. Based on L3 measurement results received from the UE, the RAN transmits a RRC reconfiguration message configuring Reconfiguration with Synchronization (e.g., the RRC reconfiguration message includes a ReconfigurationWithSync Information Element, IE) for change of the serving cell (e.g., PCell or PSCell). In cases where the UE operates in carrier aggregation, CA, of at least one secondary cell, SCell, with the PCell or PSCell, the RAN has to release the at least one SCell due to the change of the PCell or PSCell. The serving cell change involves complete L2 (and L1) resets, leading to longer latency, larger overhead and longer interruption time. Thus, the 3GPP community has recently started to develop new mobility techniques to reduce latency and overhead for fast serving cell change. However, configuring measurements in anticipation of the fast serving cell change is an aspect not yet addressed.

### SUMMARY

Lower-layer Triggered Mobility, LTM, is a term used for new mobility techniques that reduce latency and overhead for a fast serving cell change. In LTM, a user equipment, UE, switches from communicating via a source cell to communicating via a target cell without explicit radio resource control, RRC, signaling. The LTM is triggered by a layer 1, L1, measurement report (i.e., a UE report of reference signal quality). Currently, it is not clear how to configure the L1 measurement for a UE initially connected to a source cell managed by a distributed unit, DU, of a network entity, NE. The NE also includes a centralized unit, CU, and may include multiple DUs. The target cell may be managed by a different DU than the DU managing the source cell.

In various embodiments, the DU that manages a source cell receives a CU-to-DU message identifying a target cell and directing the DU to prepare an LTM DU configuration for switching the UE from connecting via the source cell to connecting via the target cell. The DU then generates and transmits, to the CU, a reference signal resource configuration for at least one reference signal to be transmitted on the target cell, together with the LTM DU configuration. In response to receiving the reference signal resource configuration from the CU, the DU that manages the target cell transmits the at least one reference signal according to the reference signal resource configuration thereby enabling the UE to generate the L1 measurement report that initiates the LTM. That is, based on a UE report on measurements of the at least one reference signal, the DU transmits, to the UE, an LTM command directing the UE to switch to communicating via the target cell (i.e., executing the LTM). After the LTM, the UE may be connected to the same DU (that manages both the source and the target cell) or may be connected to a different DU of the same NE. The UE may communicate in dual connectivity, DC, mode, where the DU may be a secondary node, SN. The master node, MN, may be another DU of the NE.

### BRIEF DESCRIPTION OF THE DRAWINGS

FIG. 1A is a block diagram of a radio access network, RAN, system with a user equipment, UE, and network entities, NEs, able to perform methods for managing fast cell switch procedures such as a lower-layer triggered mobility, LTM, according to various embodiments.

FIG. 1B is a block diagram of a network entity, NE, such as a base station that includes a centralized unit, CU, and a distributed unit, DU, able to operate in the system of FIG. 1A.

FIG. 2A is a block diagram of an example protocol stack for the UE of FIG. 1A to communicate with NEs.

FIG. 2B is a block diagram of an example protocol stack for the UE of FIG. 1A to communicate with a CU and a DU of an NE.

FIG. 2C is a block diagram illustrating structural elements of a UE and an NE configured to perform methods for managing LTM according to an embodiment.

FIG. 3 illustrates a first scenario for a UE and an NE operating according to an embodiment.

FIG. 4 illustrates a second scenario for a UE and an NE operating according to another embodiment.

FIGS. 5A and 5B illustrate third scenarios for UEs and NEs operating according to other embodiments.

FIGS. 6A and 6B illustrate fourth scenarios for UEs and NEs operating according to yet other embodiments.

FIGS. 7A and 7B illustrate fifth scenarios for UEs and NEs operating according to some embodiments.

FIGS. 8A and 8B illustrate sixth scenarios for UEs and NEs operating according to some other embodiments.

FIGS. 9A and 9B are flowcharts of methods performed by a DU according to some embodiments.

FIGS. 10A, 10B, and 10C are flowcharts of methods performed by a CU according to some embodiments.

FIG. 11 is a flowchart of a method performed by a DU according to an embodiment.

FIG. 12 is a flowchart of a method performed by a CU according to an embodiment.

FIG. 13 is a flowchart of a method performed by a network entity according to an embodiment.

### DETAILED DESCRIPTION

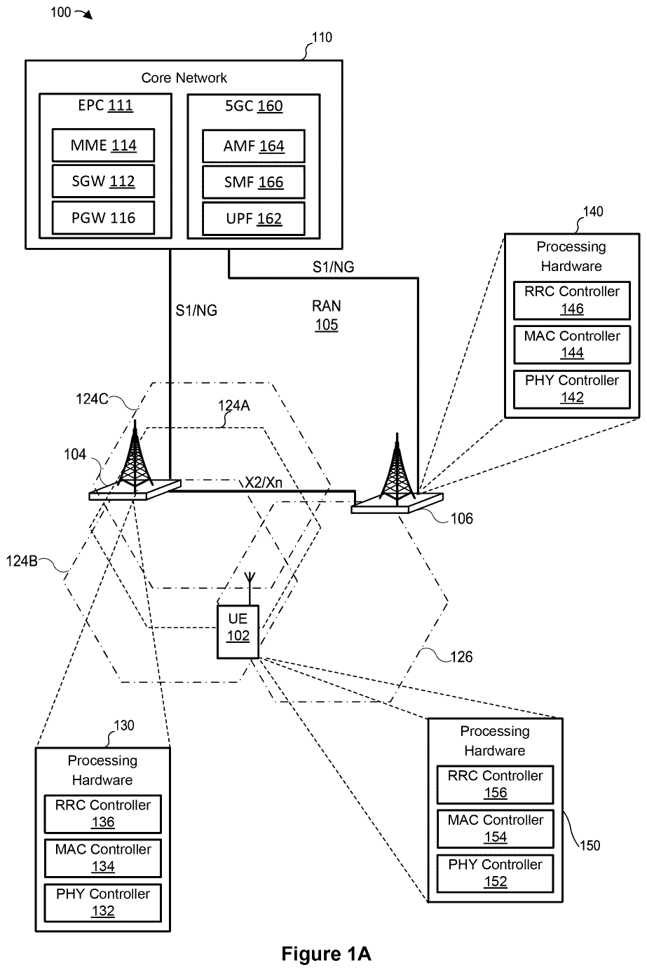

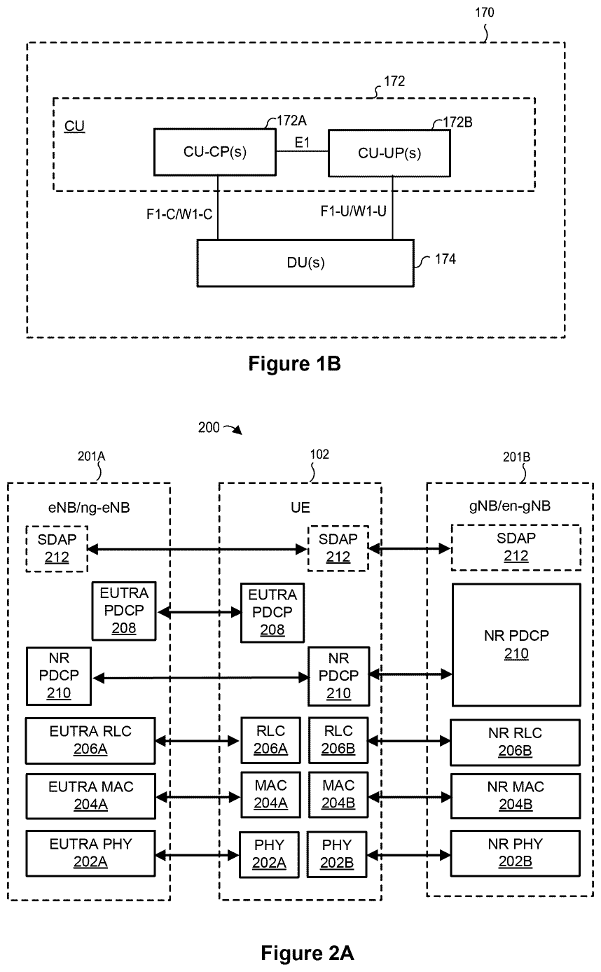

FIG. 1A depicts an example wireless communication (i.e., a radio access network, RAN) system 100 with communication devices able to perform methods for managing fast cell switch procedures such as a lower-layer triggered mobility, LTM. The wireless communication system 100 includes a UE 102, a base station, BS, 104, a base station 106 and a core network, CN, 110. Note that, more generally, base stations are network entities, NEs. The UE 102 initially connects to the base station 104. In some scenarios, the base station 104 may perform a secondary node (SN) addition to configure the UE 102 to operate in dual connectivity (DC) with the base station 104 and the base station 106. The base stations 104 and 106 operate as a master node (MN) and an SN for the UE 102, respectively.

In various configurations of the wireless communication system 100, the base station 104 may be implemented as a master evolved node B, MeNB, or a master next generation node B, MgNB, and the base station 106 may be implemented as a secondary gNB, SgNB. The UE 102 may communicate with the base station 104 and the base station 106 via the same radio access technology, RAT, such as evolved universal terrestrial radio access, EUTRA, or new radio, NR, or via different RATs. When the base station 104 is a MeNB and the base station 106 is a SgNB, the UE 102 may be in EUTRA-NR DC, EN-DC, with the MeNB and the SgNB.

In some cases, a MeNB or an SeNB is implemented as a next generation evolved node B, ng-eNB, rather than an eNB. When the base station 104 is a master ng-eNB, Mng-eNB, and the base station 106 is a SgNB, the UE 102 may be in next generation EUTRA-NR dual connectivity, NGEN-DC, with the Mng-eNB and the SgNB. When the base station 104 is an MgNB and the base station 106 is an SgNB, the UE 102 may be in NR-NR DC, NR-DC, with the MgNB and the SgNB. When the base station 104 is an MgNB and the base station 106 is a secondary ng-eNB, Sng-eNB, the UE 102 may be in NR-EUTRA DC, NE-DC, with the MgNB and the Sng-eNB.

In the scenarios where the UE 102 hands over from the base station 104 to the base station 106, the base stations 104 and 106 operate as the source base station, S-BS, and a target base station, T-BS, respectively. The UE 102 may operate in DC with the base station 104 and an additional base station (not shown in FIG. 1A), for example, prior to the handover. The UE 102 may continue to operate in DC with the base station 106 and the additional base station or operate in single connectivity, SC, with the base station 106, after completing the handover. The base stations 104 and 106 in this case operate as a source MN, S-MN, and a target MN, T-MN, respectively.

A core network, CN, 110 may be an evolved packet core, EPC, 111 or a fifth-generation core, 5GC, 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 may support an X2 or Xn interface. Among other components, the EPC 111 may include a Serving Gateway, SGW, 112, a Mobility Management Entity, MME, 114, and a Packet Data Network Gateway, PGW, 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol Multimedia Subsystem, IMS, network. The 5GC 160 includes a User Plane Function, UPF, 162 and an Access and Mobility Management, AMF, 164, and/or Session Management Function, SMF, 166. The UPF 162 is generally configured to transfer user-plane packets related to audio calls, video calls, Internet traffic, etc., the AMF 164 is configured to manage authentication, registration, paging, and other related functions, and the SMF 166 is configured to manage protocol data unit, PDU, sessions.

As illustrated in FIG. 1A, the base station 104 supports cell 124A, and the base station 106 supports a cell 126. The cells 124A and 126 may partially overlap, so that the UE 102 may communicate in DC with the base station 104 and the base station 106, where one of the base stations 104 and 106 is an MN and the other is an SN. The base station 104 may support additional cell(s) such as cells 124B and 124C, and the base station 106 may support additional cell(s) (not shown in FIG. 1A). The cells 124A, 124B and 124C may partially overlap, so that the UE 102 may communicate in carrier aggregation (CA) with the base station 104. The base station 104 may operate the cells 124A, 124B and 124C via one or more transmit and receive points, TRPs. More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure also may be used within other suitable radio access and/or core network technologies such as sixth generation (6G) radio access and/or 6G core network or 5G NR-6G DC.

With continued reference to FIG. 1A, the base station 104 is equipped with processing hardware 130 that may include one or more general-purpose processors (e.g., CPUs) and a non-transitory computer-readable memory storing instructions that the one or more general-purpose processors execute. Additionally or alternatively, the processing hardware 130 may include special-purpose processing units. The processing hardware 130 may include a physical layer, PHY, controller 132 configured to transmit data and control signal(s) on physical downlink, DL, channels and DL reference signals with one or more user devices (e.g., UE 102) via one or more cells (e.g., the cell(s) 124A, 124B and/or 124C) and/or one or more TRPs. The PHY controller 132 is also configured to receive data and control signal on physical uplink (UL) channels and/or UL reference signals with the one or more user devices via one or more cells (e.g., the cell(s) 124A, 124B, and/or 124C) and/or one or more TRPs. The processing hardware 130 in an example implementation includes a media access control, MAC, controller 134 configured to perform MAC functions with one or more user devices. The MAC functions include a random access, RA, procedure, managing UL timing advance for the one or more user devices, and/or communicating UL/DL MAC PDUs with the one or more user devices. The MAC functions also include LTM-related functions as described below. The processing hardware 130 may further include a radio resource control, RRC, controller 136 to implement procedures and messaging at the RRC sublayer of the protocol communication stack. For example, the RRC controller 136 may be configured to support RRC messaging associated with handover procedures, and/or to support the necessary operations when the base station 104 operates as an MN relative to an SN or as an SN relative to an MN. The base station 106 may include processing hardware 140 that is similar to processing hardware 130. In particular, components 142, 144, and 146 may be similar to the components 132, 134, and 136, respectively.

The UE 102 is equipped with processing hardware 150 that may include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells (e.g., the cell(s) 124A, 124B, 124C, and/or 126) and/or one or more TRPs. The PHY controller 152 is also configured to transmit data and control signal on physical UL channels and/or UL reference signals with the base station 104 or 106 via one or more cells (e.g., the cell(s) 124A, 124B, 124C, and/or 126) and/or one or more TRPs. The processing hardware 150 in an example implementation includes a MAC controller 154 configured to perform MAC functions with base station 104 or 106. For example, the MAC functions include a random access procedure, managing UL timing advance for the one or more user devices, and communicating UL/DL MAC PDUs with the base station 104 or 106. In another example, the MAC functions include LTM-related functions described below. The processing hardware 150 may further include an RRC controller 156 to implement procedures and messaging at the RRC sublayer of the protocol communication stack.

In operation, the UE 102 in DC may use a radio bearer (e.g., a data radio bearer, DRB, or a signaling radio bearer, SRB) that at different times terminates at the MN 104 or the SN 106. The UE 102 may apply one or more security keys when communicating on the radio bearer, in the uplink. UL, (from the UE 102 to a base station) and/or downlink (from a base station to the UE 102) direction.

FIG. 1B depicts an example distributed implementation of a base station such as the base station 104 or 106. The base station in this implementation may include a centralized unit, CU, 172 and one or more distributed units, DUs, 174. The CU 172 may be made of one or more subunits CU-CP(s) 172A (focusing on control plane, CP) and CU-UP(s) 172B (focusing on user plane, UP). Interfaces E1 and F1 or W1 ensure interconnections of such distributed base station units. The CU 172 is equipped with processing hardware that may include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller 142 configured to manage or control one or more RRC configurations and/or RRC procedures when the base station 106 operates as an SN. The DU 174 is also equipped with processing hardware that may include one or more general-purpose processors such as CPUs and non-transitory computer-readable memory storing machine-readable instructions executable on the one or more general-purpose processors, and/or special-purpose processing units. In some examples, the processing hardware in an example implementation includes a MAC controller configured to manage or control one or more MAC operations or procedures (e.g., a random access procedure) and a radio link control, RLC, controller configured to manage or control one or more RLC operations or procedures when the base station 106 operates as an MN or an SN. The process hardware may further include a physical layer controller configured to manage or control one or more physical layer operations or procedures.

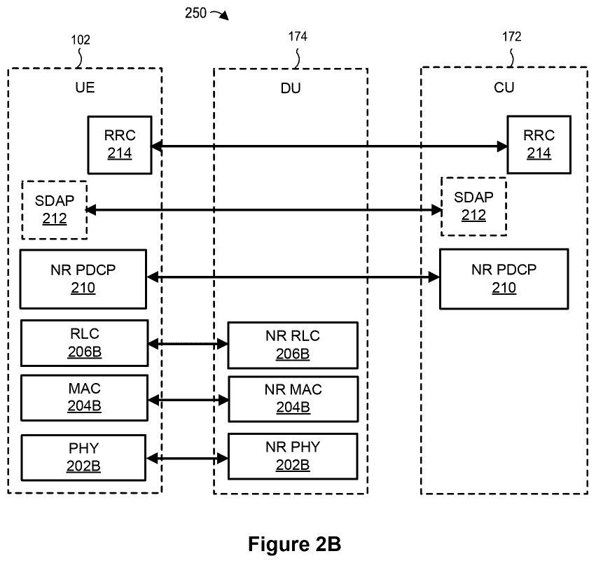

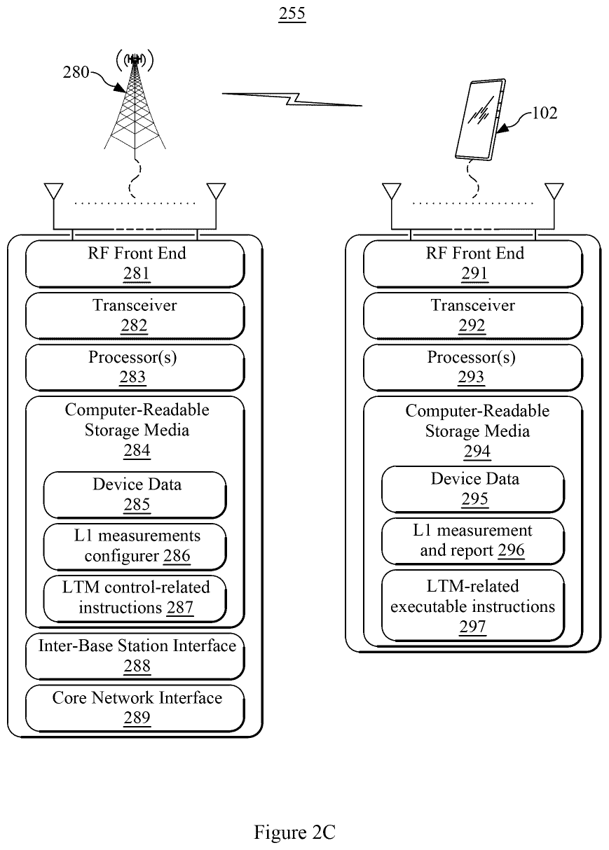

FIG. 2A illustrates, in a simplified manner, an example protocol stack 200 according to which the UE 102 may communicate with an eNB/ng-eNB or a gNB (e.g., one or more of the base stations 104, 106).

In the example protocol stack 200, a PHY 202A of the EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn may provide data transfer services to Service Data Adaptation Protocol, SDAP, 212 or an RRC sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 may support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol, IP, layer, layered directly or indirectly over the EUTRA PDCP sublayer 208 or the NR PDCP sublayer 210) that may be referred to as service data units, SDUs, and output packets (e.g., to the RLC layer 206A or 206B) that may be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 may provide SRBs or RRC sublayer (not shown in FIG. 2A) to exchange RRC messages or non-access-stratum (NAS) messages. On a user plane, the EUTRA PDCP sublayer 208 and the NR PDCP sublayer 210 may provide DRBs to support data exchange. Data exchanged on the NR PDCP sublayer 210 may be SDAP PDUs, IP packets or Ethernet packets.

FIG. 2B illustrates, in a simplified manner, an example protocol stack 250, which the UE 102 may communicate with a DU (e.g., DU 174) and a CU (e.g., CU 172). The radio protocol stack 250 is functionally split in a manner similar to the radio protocol stack 200 in FIG. 2A. The CU 172 at any of the base stations such as 104 or 106 may hold all the control and upper layer functionalities (e.g., RRC 214, SDAP 212, NR PDCP 210), while the lower layer operations (e.g., NR RLC 206B, NR MAC 204B, and NR PHY 202B) may be delegated to the DU 174. To support connection to a 5GC, NR PDCP 210 provides SRBs to RRC 214, and NR PDCP 210 provides DRBs to SDAP 212 and SRBs to RRC 214.

FIG. 2C is a block diagram illustrating structural elements of a UE and an NE (e.g., base station) configured to perform methods for managing LTM according to an embodiment. NE 280 (which may be operate as 104, 106 in FIGS. 1A, 170 in FIGS. 1B, 201A, 201B in FIG. 2A, 174 or 172 in FIG. 2B) and UE 102 communicate wirelessly. NE 280 may be a base station, BS, but more generally, the term “network entity” stands for a wireless device with a well-defined network functionality (e.g., BS's functionality is connecting UEs to the core network including managing communications to and from the UEs). NE 280 and UE 102 may include additional functions and interfaces omitted from FIG. 2C in the interest of brevity.

NE 280 may provide the functionality of an gNB (i.e., a 5G or 6G base station). NE 280's functionality may be distributed across multiple entities (e.g., a central unit, CU, a distributed unit, DU, and a radio unit, RU). NE 280 includes antennas, a Radio Frequency, RF, front end 281 and a transceiver 282 for communicating with UE 102 and other UEs and NEs. NE 280's antennas and RF front end 281 may be tuned to one or more frequency bands (e.g., subcarriers), for example as defined by 3GPP LTE, 5G NR, and 6G communication standards and implemented by transceiver 282.

NE 280 further includes processor(s) 283 and computer-readable storage media (CRM) 284. Processor(s) 283 may include single or multiple-core processors, and CRM 284 includes any suitable memory/storage except propagating signals. For example, memory/storage may include random-access memory, RAM, static RAM, SRAM, dynamic RAM, DRAM, non-volatile RAM, NVRAM, read-only memory, ROM, and/or flash memory. CRM 284 stores device data 285, which includes network scheduling data, radio resource management data, applications, and/or an operating system, which are executable by processor(s) 283 to enable wireless communication with UE 102 as well as with other NEs and UEs.

CRM 284 also stores an L1 measurement configurer 286 and LTM control-related executable instructions 287. NE 280 also includes inter-base station interface 288 and core-network interface 289. Inter-base station interface 288 may be a standardized interface, such as an Xn and/or X2 interface, for exchanging user-plane and control-plane data with another NE (e.g., in case of a handover). Core-network interface 289 enables NE's user-plane data and control-plane information exchange with core network functions and/or entities.

UE 102 includes antennas connected to a RF front end 291, and a transceiver 292. The UE may include multiple transceivers for supporting various technologies. The antennas and RF front end 291 may be tuned to one or more frequency bands (e.g., subcarriers), for example, as defined by 3GPP LTE, 5G NR, and 6G communication standards and implemented by respective transceivers. UE 102 also includes one or more processor(s) 293, and computer-readable storage media (CRM) 294. Processor(s) 293 may be single or multiple-core processors, and CRM 294 includes any suitable memory/storage other than propagating signals. For example, memory/storage may include RAM, static RAM, dynamic RAM, non-volatile RAM, ROM, and/or flash memory. CRM 294 stores device data 295 necessary for UE's communications, L1 measurement and report generator 296 and LTM-control-related executable instructions 297.

In some embodiments, the NE's and the UE's L1 measurement and LTM execution may be implemented not only as software but also as hardware logic and/or circuitry.

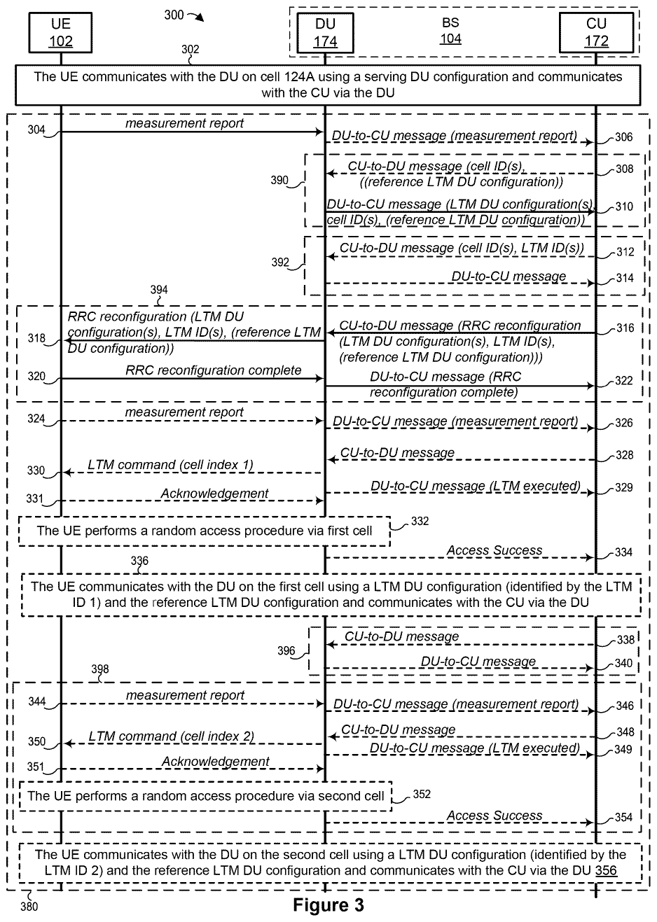

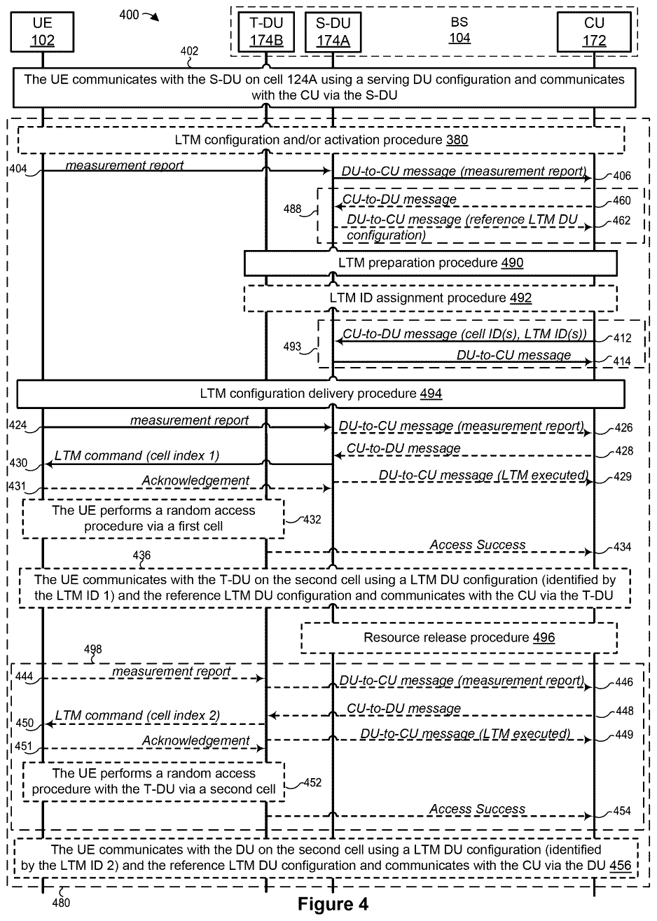

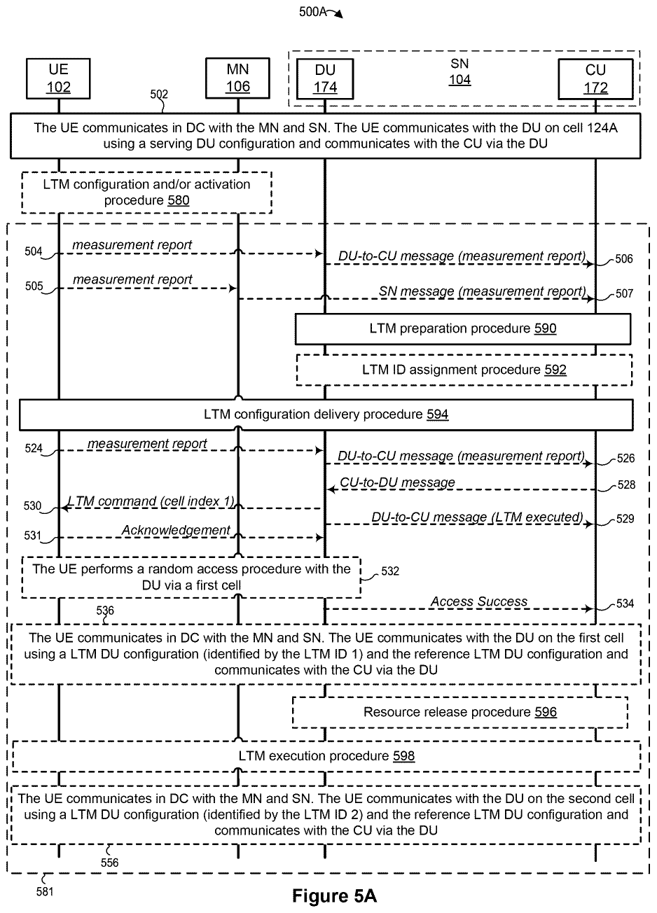

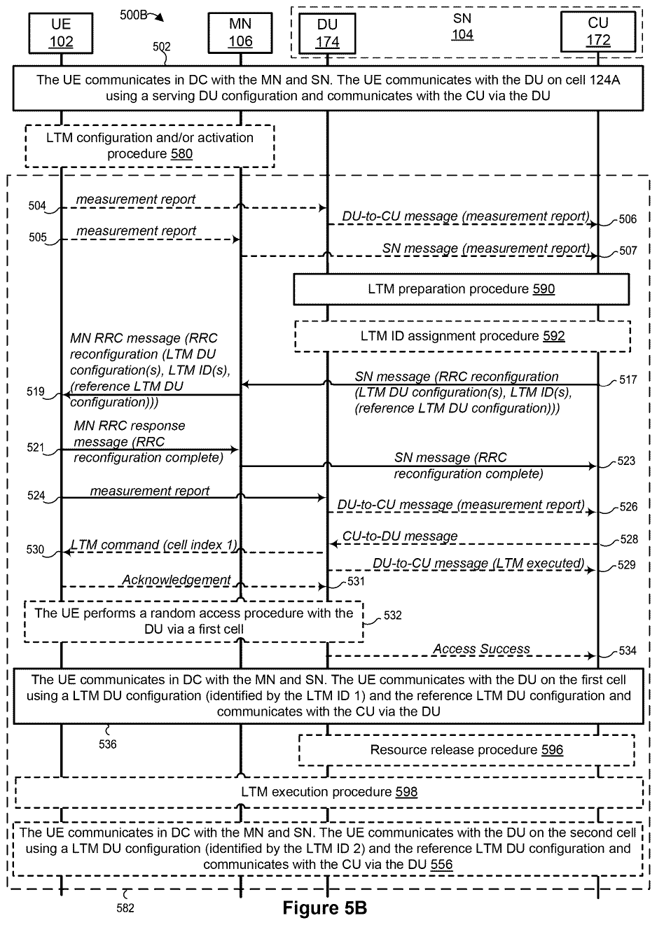

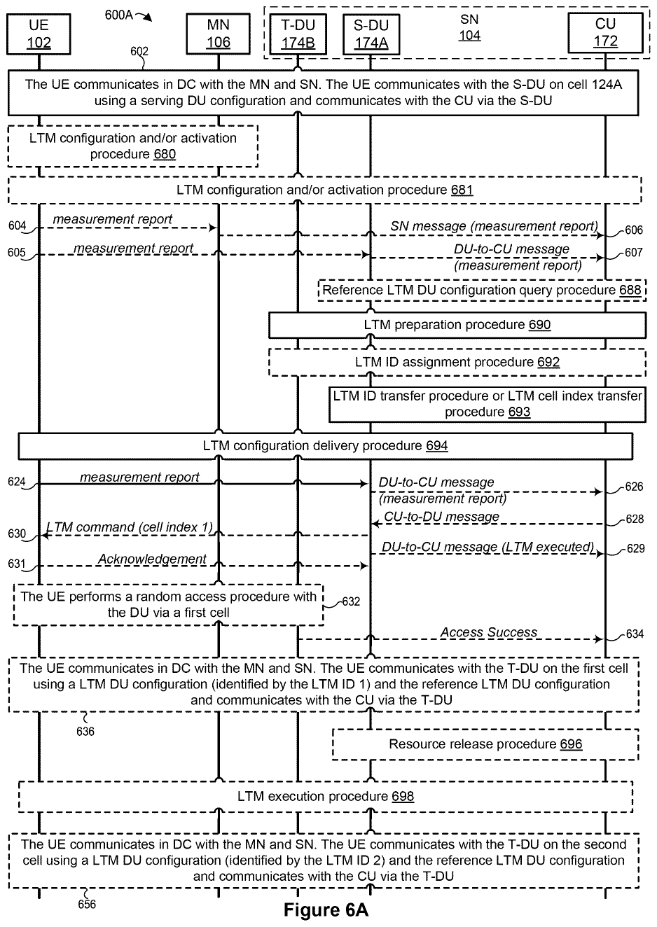

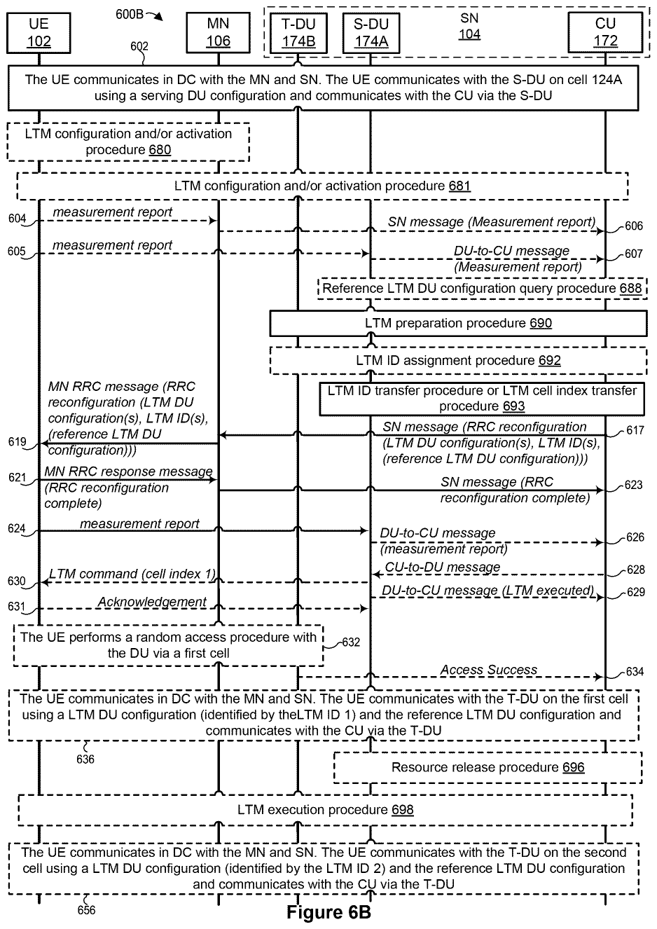

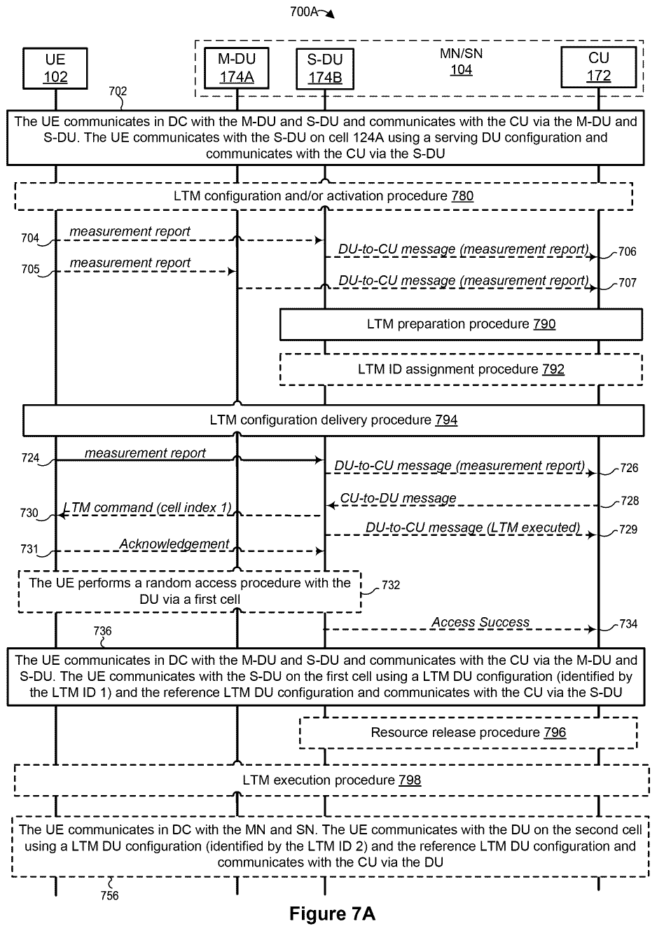

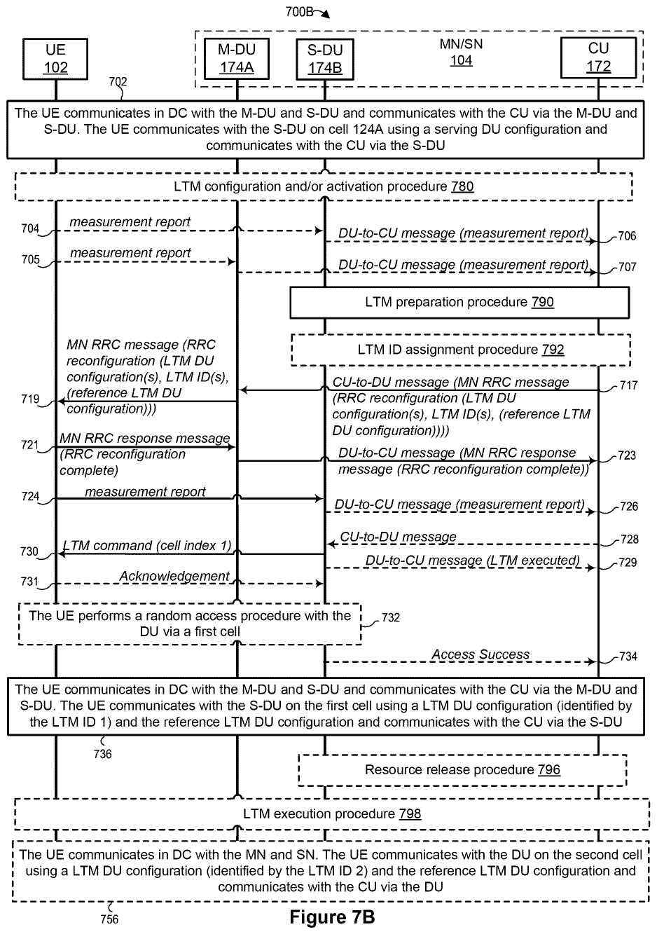

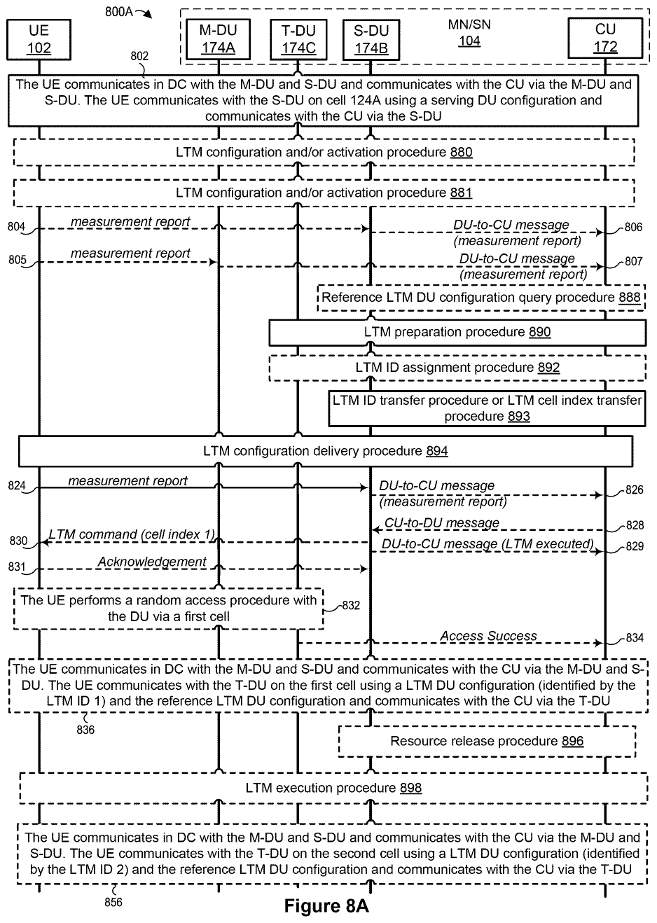

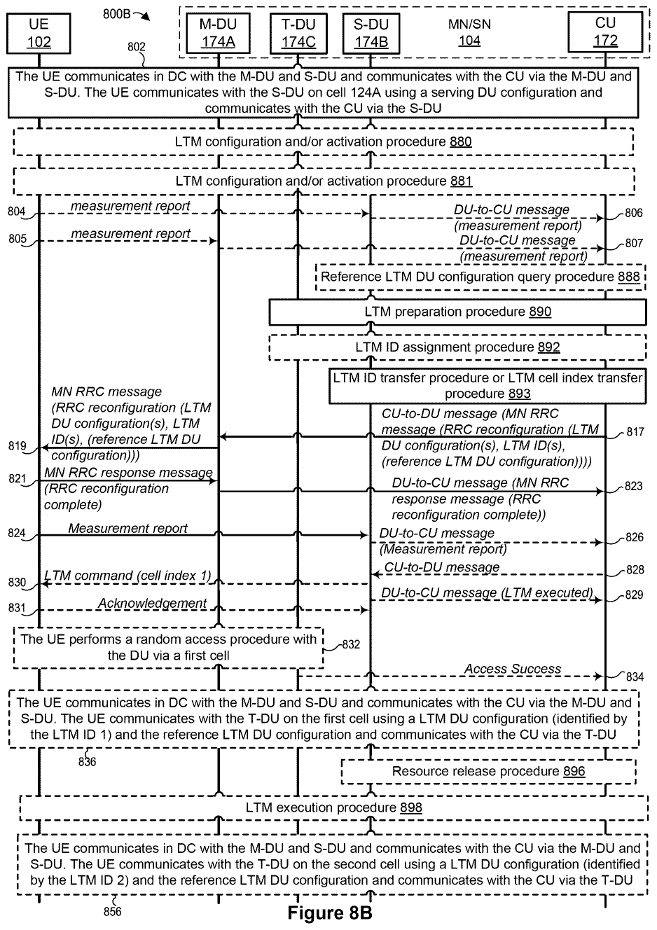

Next, several example scenarios in which the base station operating in the system of FIG. 1A transmits a configuration to the UE 102 and later activates a configuration for communication between the UE 102 and base station. Generally speaking, events in FIGS. 3-8B that are similar are labeled with similar reference numbers (e.g., event 304 in FIG. 3 is similar to event 404 of FIG. 4, event 504 of FIGS. 5A and 5B, event 604 of FIGS. 6A and 6B, event 704 of FIGS. 7A and 7B, and event 804 in FIGS. 8A and 8B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the base station 104 includes a CU 172 and a DU 174 and the DU 174 operates the cell 124A. The UE 102 initially communicates 302 with the DU 174 on the cell 124A using a serving DU configuration and communicates with the CU 172 via the DU 174, e.g., using a serving CU configuration. In other words, the DU 174 is a serving DU that communicates with the UE 102. In some implementations, the UE 102 in carrier aggregation, CA, communicates with the DU 174 on the cell 124A and other cell(s) (e.g., cell 124D not shown in FIG. 1A) using the serving DU configuration. The DU 174 operates the other cell(s). In other implementations, the UE 102 communicates with the DU 174 on the cell 124A only. In some implementations, the UE 102 communicates with the DU 174 on the cell 124A and/or other cell(s) via one or multiple TRPs. In some implementations, the cell 124A may be a PCell. In such cases, the other cell(s) include SCell(s) and/or additional cell(s) associated with the PCell or a SCell. In other implementations, the cell 124A may be a SCell, and one of the other cell(s) is a PCell. In such cases, the other cell(s) may also include additional cell(s) associated with the PCell or the SCell. In the following description, the base station 104 may be the DU 174, the CU 172, or the DU 174 and CU 172.

In the event 302, the UE 102 may transmit UL PDUs and/or UL control signals to the base station 104 on the cell 124A and/or other cell(s) via one or multiple TRPs. In some implementations, the UE 102 communicates UL PDUs and/or DL PDUs with the base station 104 via radio bearers which may include SRBs and/or DRB(s). The base station 104 may configure the radio bearers to the UE 102. In some implementations, UL control signals include UL control information, channel state information, hybrid automatic repeat request, HARQ, acknowledgements, ACKs, HARQ negative ACKs, NACKs, scheduling request(s), and/or sounding reference signal(s).

Similarly, the UE 102 may receive DL PDUs and/or DL control signals from the base station 104 on the cell 124A and/or other cell(s) via one or multiple TRPs. In some implementations, the DL control signals include downlink control information, DCI, and reference signals (e.g., Synchronization Signals, SS, Physical Broadcast Channel, PBCH, Resource Block(s), SSB(s), channel state information reference signal(s), CSI-RS(s), and/or tracking reference signal(s)). The base station 104 may transmit the DCI on physical downlink control channel(s), PDCCH(s), monitored by the UE 102, on the cell 124A and/or other cell(s) via one or multiple TRPs.

In some implementations, the serving DU configuration includes physical layer configuration parameters, MAC configuration parameters, and/or RLC configuration parameters. In some implementations, the DU 174 may transmit these configuration parameters to the CU 172. The CU 172 generates one or more messages (e.g., RRC reconfiguration message(s)) including the configuration parameters and transmits the one or more messages to the UE 102 via the DU 174. In other implementations, the DU 174 transmits the configuration parameters to the UE 102 directly. In some implementations, the serving DU configuration is CellGroupConfig IE (e.g., defined in 3GPP specification TS 38.331). In other implementations, the serving DU configuration includes configuration parameters in the CellGroupConfig IE. In some implementations, the serving CU configuration includes PDCP configuration parameters, measurement configuration parameters, and/or radio bearer configuration parameters. In some implementations, the serving CU configuration includes a MeasConfig IE and/or a RadioBearerConfig IE (e.g., defined in 3GPP specification TS 38.331) or includes configuration parameters in the MeasConfig IE and/or RadioBearerConfig IE. In some implementations, the serving DU configuration includes a CSI-MeasConfig IE or configuration parameters for channel state information (CSI) measurement and reporting. In other implementations, the serving CU configuration includes a CSI-MeasConfig IE or configuration parameters for channel state information, CSI, measurement and reporting. In some implementations, the UE 102 receives the serving CU configuration or the configuration parameters in the serving CU configuration from the CU 172 via the DU 174. In other implementations, the UE 102 receives a portion of the serving CU configuration and/or a portion of the serving DU configuration from a base station other than the base station 104 and the remaining portion of these configuration parameters from the base station 104.

While communicating with the base station 104, the UE 102 transmits 304 at least one measurement report to the DU 174. In some implementations, the at least one measurement report includes Layer 1, L1, measurement report(s) and/or Layer 3, L3, measurement report(s) for at least one serving cell of the UE 102 and/or at least one non-serving cell. For each of the L3 measurement report(s), the DU 174 transmits 306 a DU-to-CU message including the L3 measurement report to the CU 172. In some implementations, the DU-to-CU message(s) of the event 306 is/are F1 application protocol, F1AP, message(s) (e.g., UL RRC Message Transfer message(s)). In some implementations, the DU 174 does not transmit or refrains from transmitting the L1 measurement report(s) to the CU 172. The at least one serving cell includes the cell 124A and/or other cell(s), and the at least one non-serving cell includes the cell 124B and/or cell 124C. In some implementations, the serving DU configuration or the serving CU configuration includes at least one measurement configuration. In some implementations, the UE 102 receives one or more RRC messages (e.g., RRCReconfiguration message(s)) including the at least one measurement configuration from the CU 172 via the DU 174 in the event 302. In accordance with the at least one measurement configuration, the UE 102 performs measurements and transmits 304 the at least one measurement report to the DU 174. In some implementations, the at least one measurement configuration includes L3 measurement configuration(s) (e.g., MeasConfig IE(s)) and/or L1 measurement configuration(s). The L1 measurement configuration(s) (e.g., CSI-MeasConfig IE(s)) may include L1 measurement resource configuration(s) and/or L1 measurement reporting configuration(s). The L1 measurement resource configuration(s) may configure reference signals or resources of reference signal(s) (e.g., CSI-RS(s)) for the UE 102 to measure and obtain L1 measurement results. In some implementations, the reference signals include CSI-RS(s) and/or SSB(s). For example, the L1 measurement resource configuration(s) is/are CSI-ResourceConfig IE(s). In another example, the L1 measurement reporting configuration(s) configures way(s) the UE 102 uses to transmit L1 measurement results/reports. For example, the L1 measurement report configuration(s) is/are CSI-ReportConfig IE(s). For example, The UE 102 transmits the L3 measurement report(s) to the CU 172 via the DU 174 in accordance with the L3 measurement configuration(s). The UE 102 transmits the L1 measurement report(s) to the DU 174 in accordance with the L1 measurement configuration(s) or L1 measurement reporting configuration(s). In one implementation, the DU 174 does not transmit the L1 measurement report(s) to the CU 172.

In some implementations, the L1 measurement configuration(s) are new RRC IE(s) (e.g., anticipated to be defined in 3GPP specification TS 38.331) for a lower layer triggered mobility, LTM. In some implementations, the L1 measurement resource configuration(s) are new RRC IE(s) (e.g., anticipated to be defined in 3GPP specification TS 38.331) for LTM. In some implementations, each of the L1 measurement reporting configuration(s) may include a trigger event configuration configuring a trigger event to trigger the UE 102 to transmit a L1 measurement report. If the UE 102 detects the trigger event, the UE 102 transmits an L1 measurement report to the DU 174.

In some implementations, (each of) the L1 measurement report(s) may include at least one L1 measurement result. In some implementations, the at least L1 measurement result includes at least one L1-reference signal received power, L1-RSRP, value and/or at least one L1-Signal to Interference Noise Ratio, L1-SINR, value. For each of the L1 measurement report(s), the UE 102 transmits a PUCCH transmission including the L1 measurement report to the DU 174, in some implementations. That is, the UE 102 transmits the each of the L1 measurement report(s) on a PUCCH to the DU 174. In other implementations, for each of the L1 measurement report(s), the UE 102 transmits a physical uplink shared channel, PUSCH, transmission including the L1 measurement report to the DU 174. That is, the UE 102 transmits the each of the L1 measurement report(s) on a PUSCH to the DU 174. In yet other implementations, the UE 102 transmits a portion of the L1 measurement report(s) on PUCCH(s) and the rest of the L1 measurement report(s) on PUSCH(s) to the DU 174. That is, for each of the portion of the L1 measurement report(s), the UE 102 transmits a PUCCH transmission including the L1 measurement report to the DU 174, and for each of the rest of the L1 measurement report(s), the UE 102 transmits a PUSCH transmission including the L1 measurement report to the DU 174. In some implementations, each of the L1 measurement report(s) is a part of CSI (i.e., a CSI component) or CSI. In some implementations, the UE 102 may include other CSI component(s) in (each of) the PUCCH transmission(s) and/or PUSCH transmission(s) described above. In one implementation, the other CSI component(s) include such as a channel quality indicator, CQI, a Precoding Matrix Indicator, PMI, a CSI-RS Resource Indicator, CRI, a Synchronization Signal/Physical Broadcast Channel Resource Block Indicator, SSBRI, a Layer Indicator, LI, and/or a Rank Indicator, RI. In some implementations, the UE 102 does not transmit the L1 measurement report(s) in format of RRC message(s) to the DU 174.

In some implementations, each of the L3 measurement report(s) may include at least one L3 measurement result. In some implementations, the at least one L3 measurement result includes at least one RSRP (value) and/or at least one SINR (value). In one implementation, the UE 102 transmits each of the L3 measurement report(s) on a PUSCH to the CU 172 via the DU 174. In some implementations, each of the L3 measurement report(s) may be an RRC message (e.g., MeasurementReport message). In some implementations, each of the L3 measurement configuration(s) includes a particular measurement identity (e.g., measId) and each of the L3 measurement report(s) includes a particular measurement identity in a particular L3 measurement configuration. When the CU 172 receives a L3 measurement report including a measurement identity and a L3 measurement result from the UE 102 via the DU 174, the CU 172 may determine that the L3 measurement report is associated to a L3 measurement configuration identified by the measurement identity.

In some alternative implementations, for each of the at least one measurement report (e.g., L1 measurement report(s)), the UE 102 transmits a MAC control element, CE, including the measurement report to the DU 174 in the event 304. To transmit the MAC CE(s), the UE 102 generates one or more MAC PDUs each including one or more of the MAC CE(s) to the DU 174 in the event 304.

In some implementations, the UE 102 performs measurements on one or more reference signals in accordance with the at least one measurement configuration. The one or more reference signals may include one or more SSBs and/or one or more CSI-RSs. The UE 102 obtains the at least one L1 measurement result and/or at least one L3 measurement result from the measurements. The DU 174 transmits the one or more reference signals on the cell 124A and other cell(s) (e.g., the cell 124B, the cell 124C, and/or cell(s) not shown in FIG. 1A).

After (e.g., in response to) receiving one or some of the at least one measurement report from the UE 102, the base station 104 (i.e., the CU 172 or DU 174) determines to prepare a first cell (e.g., the cell 124B) for LTM for the UE 102. In some implementations, the base station 104 determines to prepare the first cell for the UE 102 because the at least one measurement report indicates that the first cell could be used by the base station 104 to communicate with the UE 102. In some implementations, the base station 104 determines to prepare the first cell for the UE 102 because the at least one measurement report indicates that the first cell qualifies to be a candidate cell that could be used for communication with the UE 102. In some implementations, if the L3 measurement report(s) indicates that signal strength and/or quality of the first cell is (i) above a first predetermined threshold, (ii) is better than strength and/or quality of the cell 124A, and/or (iii) is better than strength and/or quality of the cell 124A by a first predetermined threshold, the CU 172 determines to prepare the first cell for the UE 102. In other implementations, if the L1 measurement report(s) indicates that signal strength and/or quality of the first cell is above a first predetermined threshold, is better than signal strength and/or quality of the cell 124A, and/or is better than signal strength and/or quality of the cell 124A by a first predetermined threshold, the DU 174 determines to prepare the first cell for the UE 102. Alternatively, the base station 104 determines to prepare the first cell for the UE 102 regardless of whether a measure report is received from the UE 102 or not.

In the case that the CU 172 determines to prepare the first cell for LTM, the CU 172 transmits 308 a first CU-to-DU message to the DU 174 to prepare the first cell for the UE 102. In some implementations, the CU 172 includes a cell identity, ID, 1 of the first cell in the first CU-to-DU message to request the DU 174 to prepare the first cell for LTM for the UE 102. For example, the cell ID 1 is a cell global identity, CGI. In another example, the cell ID 1 is a portion of the CGI. In yet another example, the cell ID 1 is a physical cell ID, PCI. In response to the first CU-to-DU message, the DU 174 generates a first LTM DU configuration (referred to herein after as LTM DU configuration 1) for the UE 102, which configures the first cell for LTM. The DU 174 then transmits 310 a first DU-to-CU message including the LTM DU configuration 1 to the CU 172 in response to the first CU-to-DU message. In some implementations, the DU 174 may transmit the cell ID 1 besides the LTM DU configuration 1 in an IE of the first DU-to-CU message to indicate that the LTM DU configuration 1 is associated with the first cell (i.e., the cell ID 1). In the case that the DU 174 determines to prepare the first cell, the DU 174 initiates transmission of the first DU-to-CU message to the CU 172 instead of in response to a CU-to-DU message received from the CU 172.

In some implementations, the DU 174 includes, in the first DU-to-CU message, the cell ID of the first cell associated with the LTM DU configuration 1 to indicate that the LTM DU configuration 1 is configured for or associated with the first cell. The CU 172 identifies the LTM DU configuration 1 is configured for or associated with the first cell. In some scenarios and implementations, the CU 172 may include additional cell ID(s) (e.g., cell ID(s) 2, . . . , N) in the first CU-to-DU message to prepare additional cell(s) (e.g., cell(s) 2, . . . , N) for LTM for the UE 102, and the DU 174 includes additional LTM DU configuration(s) (e.g., LTM DU configuration(s) 2, . . . , N) each configuring a particular cell of the additional cell(s), as described below. In such cases, the DU 174 includes, in the first DU-to-CU message, the additional cell ID(s) respectively associated with the additional LTM DU configuration(s) to indicate which LTM DU configuration is associated to which cell (ID). The cell(s) 1 and/or 2, . . . , N are candidate cell(s).

In some implementations, the CU 172 does not include a (reference) LTM DU configuration in the first CU-to-DU message. In such cases, the DU 174 generates a reference LTM DU configuration, generates the LTM DU configuration(s) 1 and/or 2, . . . , N (i.e., non-reference LTM DU configuration(s)) based on the reference LTM DU configuration, and includes the reference LTM DU configuration in the first DU-to-CU message. In other implementations, the CU 172 includes a reference LTM DU configuration in the first CU-to-DU message. In such cases, the DU 174 generates the LTM DU configuration(s) 1, and/or 2, . . . , N which are delta configuration(s) to augment the reference LTM DU configuration. In yet other implementations, the CU 172 includes a reference LTM DU configuration (e.g., a first reference LTM DU configuration) in the first CU-to-DU message. In such cases, the DU 174 generates a reference LTM DU configuration (e.g., a second reference LTM DU configuration) replacing the first reference LTM DU configuration, generates the LTM DU configuration(s) 1 and/or 2, . . . , N based on the second reference LTM DU configuration, and includes the second reference LTM DU configuration in the first DU-to-CU message.

In some implementations, the reference LTM DU configuration includes physical layer configuration parameters, MAC configuration parameters, and/or RLC configuration parameters. In some implementations, the reference LTM DU configuration is CellGroupConfig IE (e.g., defined in 3GPP specification TS 38.331). In other implementations, the reference LTM DU configuration includes configuration parameters in the CellGroupConfig IE. In some implementations, the reference LTM DU configuration includes a CSI-MeasConfig IE or configuration parameters for channel state information (CSI) measurement and/or reporting.

In some implementations, the reference LTM DU configuration is different from the serving DU configuration. In some implementations, a portion of the reference LTM DU configuration is the same as a portion of the serving DU configuration and the rest of the reference LTM DU configuration is different from the rest of the serving DU configuration. In other implementations, the reference LTM DU configuration is the same as the serving DU configuration.

After receiving the first DU-to-CU message, the CU 172 generates a RRC reconfiguration message (e.g., an RRCReconfiguration message) including the LTM DU configuration 1 and transmits 316 a second CU-to-DU message including the RRC reconfiguration message to the DU 174. In some implementations, the CU 172 includes the reference LTM DU configuration in the RRC reconfiguration message 316. In other implementations, the CU 172 does not include a/the reference LTM DU configuration in the RRC reconfiguration message 316. In some implementations, if the CU 172 transmits the reference LTM DU configuration to the UE 102 during the event 302, the CU 172 does not include the reference LTM DU configuration in the RRC reconfiguration message 316. In other implementations, if the CU 172 receives the reference LTM DU configuration from the DU 174, the CU 172 includes the LTM DU configuration in the RRC reconfiguration message 316. Otherwise, if the CU 172 does not receive a reference LTM DU configuration from the DU 174, the CU 172 does not include the reference LTM DU configuration in the RRC reconfiguration message 316.

In some implementations, the CU 172 includes the LTM DU configuration 1 and/or the LTM CU configuration 1 in a first container (e.g., a field/IE) and includes the first container (e.g., LTM configuration 1) in the RRC reconfiguration message of the events 316 and 318. In such cases, the CU 172 generates the first container. The first container informs the UE 102 to not apply the LTM DU configuration 1 and/or the LTM CU configuration 1 immediately. In some scenarios or implementations, the UE 102 receives an RRC reconfiguration message (e.g., the RRC reconfiguration message of the event 318) including a configuration (e.g., the LTM DU configuration 1). If the configuration is included in the first container, the UE 102 refrains from immediately applying the configuration. Otherwise, if the configuration is not included in the first container, the UE 102 may apply the configuration immediately. In some implementations, the first container may be a first addition or modification list (e.g., Itm-ConfigToAddModList field, LTM-ConfigToAddModList IE, Itm-CandidateToAddModList field, or LTM-CandidateToAddModList IE). The CU 172 includes the LTM DU configuration 1 and/or the LTM CU configuration 1 in a first element (referred to herein after as element 1) of the first addition or modification list. For example, the element 1 may be an addition or modification IE (LTM-Candidate IE, or LTM-CandidateToAddMod IE). When the UE 102 receives the first addition or modification list, the UE 102 may store the first addition or modification list, e.g., in a variable in its random access memory (RAM). In other alternative implementations, the DU 174 generates the first container and includes the first container in the first DU-to-CU message. In yet other alternative implementations, the DU 174 generates the element 1 and includes the element 1 in the first DU-to-CU message.

In some implementations, the CU 172 includes a LTM CU configuration 1 in the RRC reconfiguration message 316, the first container or the element 1. The LTM CU configuration 1 is associated with the LTM DU configuration 1. To associate the LTM CU configuration 1 with the LTM DU configuration 1, the CU 172 may include the LTM CU configuration 1 and the LTM DU configuration in the element 1. In some implementations, the CU 172 may include the LTM CU configuration 1 and the LTM DU configuration 1 in RRC message 1 and includes the RRC message 1 in the element 1. In some implementations, the CU 172 includes LTM CU configuration(s) 2, . . . , N in the RRC reconfiguration message 316 or the second container. The LTM CU configuration(s) 2, . . . , N are associated with the LTM DU configuration(s) 2, . . . , N, respectively. To associate the LTM CU configuration(s) 2, . . . , N with the LTM DU configuration(s) 2, . . . , N, the CU 172 may include the LTM CU configuration(s) 2, . . . , N and the LTM DU configuration(s) in the element(s) 2, . . . , N, respectively. In other implementations, the CU 172 includes, in the element(s) 2, . . . , N, the LTM CU configuration(s) 2, . . . , N associated with the LTM DU configuration(s) 2, . . . , N, respectively. In some implementations, the CU 172 may include the LTM CU configuration(s) 2, . . . , N and the LTM DU configuration(s) 2, . . . , N in RRC message(s) 2, . . . , N and includes the RRC message(s) 2, . . . , N in the element(s) 2, . . . , N, respectively. In some implementations, the RRC message(s) 1, . . . , N are RRC reconfiguration message(s). Alternatively, the CU 172 does not include, in the RRC reconfiguration message 316, LTM CU configuration(s) for some or all of the LTM DU configuration 1 and/or LTM DU configuration(s) 2, . . . , N.

After receiving the RRC reconfiguration message 316, the DU 174 transmits 318 the RRC reconfiguration message to the UE 102. In response, the UE 102 transmits 320 a RRC reconfiguration complete message (e.g., an RRCReconfigurationComplete message) to the DU 174, which in turn transmits 322 a second DU-to-CU message including the RRC reconfiguration complete message to the CU 172. In some implementations, the CU 172 performs security protection (e.g., integrity protection and/or encryption) on the RRC reconfiguration message. For example, the CU 172 generates a message authentication code for integrity, MAC-I, for the RRC reconfiguration message, encrypts the RRC reconfiguration message and the MAC-I to obtain an encrypted RRC reconfiguration message and an encrypted MAC-I, and transmits a PDCP PDU including the encrypted RRC reconfiguration message and encrypted MAC-I to the UE 102 via the DU 174 in the events 316 and 318. When the UE 102 receives the PDCP PDU from the CU 172 via the DU 174 (i.e., events 316 and 318), the UE 102 decrypts the encrypted RRC reconfiguration and encrypted MAC-I to obtain the RRC reconfiguration message and MAC-I and verifies whether the MAC-I is valid. If the UE 102 verifies the MAC-I is invalid, the UE 102 discards or ignores the RRC reconfiguration message. In some implementations, the UE 102 may perform a RRC connection reestablishment procedure in response to the invalid MAC-I. Otherwise, if the UE 102 verifies the MAC-I is valid, the UE 102 may process the RRC reconfiguration. The UE 102 refrains from applying (i.e., executing) the LTM DU configuration 1 until receiving an LTM configuration activation command activating the LTM DU configuration 1 (e.g., the event 330).

The events 308 (optional) and 310 are collectively referred to in FIG. 3 as a LTM preparation procedure 390. The events 316, 318, 320, 322 are collectively referred to in FIG. 3 as an LTM configuration delivery procedure 394.

In some implementations, the first CU-to-DU message is a UE Context Modification Request message, and the first DU-to-CU message is a UE Context Modification Response message or UE Context Modification Required message. In the case of the UE Context Modification Required message, the CU 172 may transmit a UE Context Modification Confirm message to the DU 174 in response to UE Context Modification Required message. In some implementations, the second CU-to-DU message is a DL RRC Message Transfer message. In other implementations, the second CU-to-DU message is a UE Context Modification Request message and the DU 174 may transmit a second DU-to-CU message (e.g., UE Context Modification Response message) to the CU 172 in response to the second CU-to-DU message.

In some implementations, the CU 172 may include a reference LTM CU configuration in the RRC reconfiguration message 316 or the first container. In some implementations, the CU 172 may generate the LTM CU configuration 1 (i.e., non-reference LTM CU configuration) as a delta configuration to augment the reference LTM CU configuration. Similarly, the CU 172 may generate some or all of the LTM CU configuration(s) 2, . . . , N as delta configuration(s) to augment the reference LTM CU configuration. Alternatively, in the RRC reconfiguration message 316 or the first container, the CU 172 includes the reference LTM CU configuration and does not include a non-reference LTM CU configuration. In some implementations, the CU 172 includes the reference LTM CU configuration and/or the reference LTM DU configuration in an additional container (e.g., reference LTM configuration) and includes the additional container in the RRC reconfiguration message 316.

In some implementations, the reference LTM CU configuration is different from the serving CU configuration. In some implementations, a portion of the reference LTM CU configuration is the same as a portion of the serving CU configuration and the rest of the reference LTM CU configuration is different from the rest of the serving CU configuration. In yet other implementations, the reference LTM CU configuration is the same as the serving LTM CU configuration.

### 1) CU Assigns an ID for the LTM DU Configuration 1

In some implementations, the CU 172 includes, in the RRC reconfiguration message, a first LTM ID (referred to herein after as ID 1) for identifying the LTM DU configuration 1 or the element 1. In some implementations, the CU 172 includes the ID 1 in the first container or element 1. In some implementations, the CU 172 assigns the ID 1. In other implementations, the CU 172 receives the ID 1 from the DU 174 in the first DU-to-CU message, as described below.

In the case that the CU 172 assigns or generates the ID 1, the CU 172 may transmit the ID 1 to the DU 174, and the DU 174 associates the ID 1 with the LTM DU configuration 1. In some implementations, in the first CU-to-DU message, the CU 172 includes the ID 1 and indicates the ID 1 is associated with the LTM DU configuration 1. In other implementations, after receiving the first DU-to-CU message, the CU 172 transmits 312 a third CU-to-DU message including the ID 1 to the DU 174 instead of including the ID 1 in the first CU-to-DU message. In some implementations, in the third CU-to-DU message, the CU 172 may include the LTM DU configuration 1 and the ID 1 and indicate the association between the ID 1 and LTM DU configuration 1. Thus, the DU 174 may directly associate the ID 1 with the LTM DU configuration 1. In other implementations, in the third CU-to-DU message, the CU 172 may include the cell ID 1 and the ID 1 (i.e., the first LTM ID) and indicate the association between the cell ID 1 and the ID 1. Thus, the DU 174 may associate the ID 1 with the LTM DU configuration 1, based on the association between the cell ID 1 and the ID 1 and the association between the cell ID 1 and the LTM DU configuration 1. In yet other implementations, in the third CU-to-DU message, the CU 172 may include the LTM DU configuration 1, the cell ID 1 and the ID 1 and indicate the association between the ID 1, LTM DU configuration 1 and the cell ID 1. In some implementations, the DU 174 may transmit 314 a third DU-to-CU message to the CU 172 in response to the third CU-to-DU message. In some implementations, the third CU-to-DU message and third DU-to-CU message are a UE Context Modification Request message and a UE Context Modification Response message. The events 312 (optional) and 314 (optional) are collectively referred to in FIG. 3 as a LTM ID assignment procedure 392. In other implementations, the CU 172 may include the ID 1, the cell ID 1, and/or the LTM DU configuration 1 in the second CU-to-DU message as described above. Thus, the third CU-to-DU message may be omitted.

In the case that the CU 172 includes the ID 1 in the first CU-to-DU message, the DU 174 may include the ID 1 in the LTM DU configuration 1, the first container or the element 1. Alternatively, the DU 174 does not include the ID 1 in the LTM DU configuration 1, the first container, and/or the element 1.

### 2) DU Assigns an ID for the LTM DU Configuration 1

In some alternative implementations, the DU 174 assigns the ID 1 identifying the LTM DU configuration 1. In some implementations, the DU 174 includes the ID 1 in the first DU-to-CU message. The CU 172 may include the ID 1 in the RRC reconfiguration message as described above. In other implementations, the DU 174 includes the ID 1 in the LTM DU configuration 1, the first container or the element 1. Thus, the CU 172 does not include an ID identifying the LTM DU configuration 1 in the RRC reconfiguration message, the first container, and/or the element 1.

In some implementations, the CU 172 includes the reference LTM DU configuration in the first container. For example, the CU 172 includes the reference LTM DU configuration in a field of the first container, different from a field of the first container including the LTM DU configuration 1. In other implementations, the CU 172 includes the reference LTM DU configuration in the RRC reconfiguration message 316 and outside the first container. For example, the CU 172 generates a third container (e.g., a field/IE) to include the first container and the reference LTM DU configuration and includes the third container in the RRC reconfiguration message 316. In yet other implementations, the DU 174 includes the reference LTM DU configuration in the first container. For example, the DU 174 includes the reference LTM DU configuration in a field of the first container, different from a field of the first container including the LTM DU configuration 1. In yet other implementations, the DU 174 generates a fourth container (e.g., a field/IE) to include the first container and the reference LTM DU configuration and includes the fourth container in the first DU-to-CU message 310. In such cases, the CU 172 includes the fourth container in the RRC reconfiguration message 316. Alternatively, the CU 172 retrieves the reference LTM DU configuration and the LTM DU configuration 1 from the fourth container and includes the reference LTM DU configuration and the LTM DU configuration 1 as described above.

In some implementations, neither the CU 172 nor the DU 174 assign an ID to identify the reference LTM DU configuration. In some implementations, neither the CU 172 nor the DU 174 assign an ID to identify the reference LTM CU configuration.

In some implementations, the LTM DU configuration 1 includes a plurality of configuration parameters for the UE 102 to communicate with the DU 174 on the first cell. In some implementations, the plurality of configuration parameters includes physical layer configuration parameters (e.g., PhysicalCellGroupConfig IE), MAC layer configuration parameters (e.g., MAC-CellGroupConfig IE) and/or RLC configuration parameters (e.g., RLC-BearerConfig IE(s)). In some further implementations, the plurality of configuration parameters includes a special cell configuration (e.g., SpCellConfig IE) and/or one or more SCell configurations (e.g., SCellConfig IE(s)). In some implementations, the LTM DU configuration 1 is CellGroupConfig IE (e.g., defined in 3GPP specification TS 38.331). In other implementations, the LTM DU configuration 1 includes configuration parameters in the CellGroupConfig IE.

In some implementations, the LTM CU configuration 1 includes PDCP configuration parameters, measurement configuration parameters, and/or radio bearer configuration parameters. In some implementations, the LTM CU configuration 1 includes a MeasConfig IE and/or a RadioBearerConfig IE (e.g., defined in 3GPP specification TS 38.331) or includes configuration parameters in the MeasConfig IE and/or RadioBearerConfig IE. In some implementations, the LTM DU configuration 1 includes a CSI-MeasConfig IE or configuration parameters for CSI measurement and reporting. In other implementations, the LTM CU configuration 1 includes a CSI-MeasConfig IE or configuration parameters for CSI measurement and reporting.

In some implementations, the DU 174 includes a random access configuration in the LTM DU configuration 1. In other implementations, the DU 174 does not include a random access configuration in the LTM DU configuration 1. In some implementations, if the cell 124A and first cell are not synchronized, the DU 174 determines to include the random access configuration in the LTM DU configuration 1. Otherwise, if the cell 124A and first cell are synchronized, the DU 174 determines to not include the random access configuration in the LTM DU configuration 1. In other implementations, if the DU 174 determines that the UE 102 has not synchronized in UL with the first cell, the DU 174 determines to include the random access configuration in the LTM DU configuration 1. Otherwise, if the DU 174 determines that the UE 102 has synchronized in UL with the first cell, the DU 174 determines to not include the random access configuration in the LTM DU configuration 1. If the LTM DU configuration 1 includes the random access configuration, the UE 102 performs the random access procedure in the event 332 in accordance with the random access configuration, as described below. Otherwise, if the LTM DU configuration 1 does not include the random access configuration, the UE 102 skips or refrains from performing the random access procedure of the event 332 in response to the LTM DU configuration 1 excluding the random access configuration.

In some implementations, the DU 174 includes random access configuration parameters in the LTM DU configuration 1 and/or the reference LTM DU configuration regardless of whether the cell 124A and first cell are synchronized or not. The UE 102 performs the random access procedure in the event 332 in accordance with the random access configuration parameters, as described below.

In some implementations, if the cell 124A and first cell are synchronized, the DU 174 determines to include, in the LTM DU configuration 1, a first indication configuring the UE 102 not to perform a random access procedure on the first cell. Otherwise, if the cell 124A and first cell are not synchronized, the DU 174 determines to not include the first indication in the LTM DU configuration 1. In other implementations, if the DU 174 determines that the UE 102 has synchronized in UL with the first cell, the DU 174 determines to include the first indication in the LTM DU configuration 1. Otherwise, if the DU 174 determines that the UE 102 has not synchronized in UL with the first cell, the DU 174 determines to not include the first indication in the LTM DU configuration 1. If the LTM DU configuration 1 includes the first indication, the UE 102 skips or refrains from performing the random access procedure of the event 332 in accordance with or in response to the first indication. Otherwise, if the LTM DU configuration 1 does not include the first indication, the UE 102 performs the random access procedure in accordance with the random access configuration in the event 332, in response to the LTM DU configuration 1 excluding the first indication, as described below.

In some implementations, the DU 174 includes a reconfiguration with sync configuration (e.g., ReconfigurationWithSync IE) in the LTM DU configuration 1 or special cell configuration. In other implementations, the DU 174 does not include a reconfiguration with sync configuration (e.g., ReconfigurationWithSync IE) in the LTM DU configuration 1 or special cell configuration. In some implementations, if the cell 124A and the first cell are not synchronized, the DU 174 determines to include the reconfiguration with sync configuration in the LTM DU configuration 1. Otherwise, if the cell 124A and the first cell are synchronized, the DU 174 determines to not include the reconfiguration with sync configuration in the LTM DU configuration 1. In other implementations, if the DU 174 determines that the UE 102 has not synchronized in UL with the first cell, the DU 174 determines to include the reconfiguration with sync configuration in the LTM DU configuration 1. Otherwise, if the DU 174 determines that the UE 102 has synchronized in UL with the first cell, the DU 174 determines to not include the reconfiguration with sync configuration in the LTM DU configuration 1. In some implementations, if the LTM DU configuration 1 includes the reconfiguration with sync configuration, the UE 102 performs the random access procedure in the event 332 as described below, in response to or in accordance with the reconfiguration with sync configuration. Otherwise, if the LTM DU configuration 1 does not include the reconfiguration with sync configuration, the UE 102 skips or refrains from performing the random access procedure of the event 332. In some implementations, the DU 174 includes a cell ID (i.e., cell ID 1) of cell 1 (i.e., the first cell) in the LTM DU configuration 1. In one implementation, the cell ID 1 may be a PCI. In another implementation, the cell ID 1 is a CGI. In some implementations, the cell ID 1 included in the LTM DU configuration 1 is a PCI, while the cell ID 1 included in the first CU-to-DU message is a CGI. In some further implementations, the LTM DU configuration 1 includes a cell index 1 indexing the cell ID 1 or the first cell. The cell index 1 is not a cell ID. The cell index takes fewer bits than the cell ID. In some implementations, the CU 172 sets the cell index 1 to a value and includes the cell index 1 in the first CU-to-DU message of the event 308.

In some implementations, after (e.g., in response to) receiving one or some of the at least one measurement report of the event 304, the base station 104 (i.e., the CU 172 or DU 174) determines to prepare additional cell(s) (i.e., cell(s) 2, . . . , N) of the base station 104 for LTM for the UE 102. In one implementation, the base station 104 determines to prepare the additional cell(s) for LTM for the UE 102 because the at least one measurement report indicates that the additional cell(s) could be used by the base station 104 to communicate with the UE 102. The additional cell(s) may include the cell 124C and/or cell(s) other than the cells 124A, 124B, and 124C. In some implementations, if the L3 measurement report(s) indicates that signal strength and/or quality of a particular cell of the additional cell(s) is above a respective predetermined threshold and/or is better than the cell 124A, the CU 172 determines to prepare the particular cell for LTM for the UE 102. In other implementations, if the L1 measurement report(s) indicates that signal strength and/or quality of a particular cell of the additional cell(s) is above a first predetermined threshold and/or is better than the cell 124A, the DU 174 determines to prepare the particular cell for LTM for the UE 102. In one implementation, the respective predetermined threshold(s) for the additional cells may be different from the first predetermined threshold. In another implementation, the respective predetermined threshold(s) for the additional cell(s) may be the same as the first predetermined threshold. In some implementations, the respective predetermined thresholds for the additional cells may be the same or different. Alternatively, the base station 104 determines to prepare the additional cell(s) for the UE 102 regardless of whether a measurement report is received from the UE 102 or not.

In the case that the CU 172 determines to prepare the additional cell(s), the CU 172 initiates and performs at least one additional LTM preparation procedure (LTM preparation procedure(s)) with the DU 174 to prepare the additional cell(s) for LTM, where each of the LTM preparation procedure(s) is similar to the procedure 390. In the case that the DU 174 determines to prepare the additional cell(s), the DU 174 initiates and performs at least one additional LTM preparation procedure (LTM preparation procedure(s)) with the CU 172 to prepare the additional cell(s) for LTM, where each of the LTM preparation procedure(s) is similar to the procedure 390.

In some implementations, the CU 172 and DU 174 perform LTM preparation procedure(s) 2, . . . , N to prepare the cell(s) 2, . . . , N, respectively, similar to the procedure 390. The CU 172 may include the cell ID(s) 2, . . . , N in CU-to-DU message(s) 2, . . . , N in the LTM preparation procedure(s) 2, . . . , N, respectively, similar to the first CU-to-DU message. In the LTM preparation procedure(s) 2, . . . , N, the DU 174 generates LTM DU configuration(s) 2, . . . , N configuring the cell(s) 2, . . . , N and includes the LTM DU configuration(s) 2, . . . , N in DU-to-CU message(s) 2, . . . , N, respectively, as described for the LTM DU configuration 1. In the case that the DU 174 receives the CU-to-DU message(s) 2, . . . , N, the DU-to-CU message(s) 2, . . . , N responds to the CU-to-DU message(s) 2, . . . , N, respectively. “N” is an integer and larger than one. For example, “N” is 2, 3, 4, 5, 6, 7, 8, 9, 10, 11, 12, 13 14, 15 or 16. In another example, the maximum number of “N” is 4, 8, 16 or 32. Examples and implementations of the LTM DU configuration 1 may apply to the LTM DU configuration(s) 2, . . . , N.

In other implementations, the CU 172 and DU 174 performs a single LTM preparation procedure (i.e., the LTM preparation procedure 390) to prepare the cell(s) 1, 2, . . . , N. In such cases, the DU 174 includes the LTM DU configuration(s) 1, 2, . . . , N for the cell(s) 1, 2, . . . , N, respectively in the first DU-to-CU message. In the first DU-to-CU message, the DU 174 may include the cell ID(s) 1, 2, . . . , N respectively associated with the LTM DU configuration(s) 1, 2, . . . , N to indicate that the LTM DU configuration(s) 1, 2, . . . , N are configured for the cell ID(s) 1, 2, . . . , N, respectively. In the case that the CU 172 determines to perform the LTM preparation procedure 390, the CU 172 includes the cell ID(s) 1, 2, . . . , N in the first CU-to-DU message to request the DU 174 to prepare the cell(s) 1, 2, . . . , N, respectively, for LTM.

After receiving the LTM DU configuration(s) 2, . . . , N from the DU 174, the CU 172 may include the LTM DU configuration(s) 2, . . . , N in the first container. In some implementations, the CU 172 may include the LTM DU configuration(s) 2, . . . , N in element(s) 2, . . . , N, respectively, and includes the element(s) 2, . . . , N in the first container. In some implementations, the CU 172 includes, in the RRC reconfiguration message, LTM ID(s) (i.e., ID(s) 2, . . . , N) for identifying the LTM DU configuration(s) 2, . . . , N, respectively. In some implementations, the CU 172 includes the ID(s) 2, . . . , N in the first container. For example, the CU 172 may include the ID(s) 2, . . . , N and LTM DU configuration(s) 2, . . . , N in the element(s) 2, . . . , N in the first addition or modification list.

In some implementations, the CU 172 assigns the ID(s) 2, . . . , N for the LTM DU configuration(s) 2, . . . , N, respectively. In other implementations, the CU 172 receives the ID(s) 2, . . . , N from the DU 174 in the first DU-to-CU message of the procedure 390. In yet other implementations, the CU 172 receives from the DU 174 the ID(s) 2, . . . , N in the DU-to-CU message(s) 2, . . . , N of the LTM preparation procedure(s) 2, . . . , N, respectively.

In some implementations, the CU 172 may perform a LTM ID assignment procedure with the DU 174 for each of the LTM DU configuration(s) 2, . . . , N, similar to the procedure 392. In other implementations, the CU 172 may include the ID(s) 2, . . . , N and the LTM DU configuration(s) 2, . . . , N in the third CU-to-DU message and indicate the association between the ID(s) 2, . . . , N and the LTM DU configuration(s) 2, . . . , N, respectively. Thus, the DU 174 may associate the LTM DU configuration(s) 2, . . . , N with the ID(s) 2, . . . , N, respectively. In yet other implementations, the CU 172 may include the cell ID(s) 2, . . . , N and the ID(s) 2, . . . , N in the third CU-to-DU message and indicate the association between the cell ID(s) 2, . . . , N and the ID(s) 2, . . . , N, respectively. Thus, the DU 174 may associate the LTM DU configuration(s) 2, . . . , N with the ID(s) 2, . . . , N, respectively, based on the association between the cell ID(s) 2, . . . , N and the ID(s) 2, . . . , N and the association between the cell ID(s) 2, . . . , N and the LTM DU configuration(s) 2, . . . , N, respectively. In other implementations, the CU 172 may include the ID(s) 2, . . . , N, the cell ID(s) 2, . . . , N and/or the LTM DU configuration(s) 2, . . . , N in the second CU-to-DU message as described above. Thus, the third CU-to-DU message may be omitted. In yet other implementations, the CU 172 may include the ID(s) 2, . . . , N in the first CU-to-DU message and indicate the ID(s) 2, . . . , N is/are respectively associated with the cell ID(s) 2, . . . , N. In one implementation, the DU 174 includes the ID(s) 2, . . . , N in the LTM DU configuration(s) 2, . . . , N. Thus, the CU 172 does not include the ID(s) 2, . . . , N in the RRC reconfiguration message, the first container, and/or the element(s) 2, . . . , N.

In some alternative implementations, the DU 174 assigns the ID(s) 2, . . . , N. In some implementations, the DU 174 includes the ID(s) 2, . . . , N in the first DU-to-CU message of the procedure 390. In yet other implementations, the DU 174 includes the ID(s) 2, . . . , N in the DU-to-CU message(s) 2, . . . , N of the LTM preparation procedure(s) 2, . . . , N. The CU 172 may include the ID(s) 2, . . . , N in the RRC reconfiguration message. In other implementations, the DU 174 includes the ID(s) 2, . . . , N in the LTM DU configuration(s) 2, . . . , N. Thus, the CU 172 does not include an ID (e.g., LTM ID) identifying each of the LTM DU configuration(s) 2, . . . , N in the RRC reconfiguration message, the first container, and/or the element 1.

In some alternative implementations, the CU 172 may generate a second container including the LTM DU configuration(s) 2, . . . , N or element(s) 2, . . . , N instead of using the first container. The CU 172 then transmits an additional RRC reconfiguration message including the second container to the UE 102 via the DU 174, similar to the events 316 and 318. In response, the UE 102 transmits an additional RRC reconfiguration complete message to the CU 172 via the DU 174, similar to the events 320 and 322. In some implementations, the second container may be a second addition or modification list (e.g., LTM-ConfigToAddModList field, LTM-ConfigToAddModList IE, LTM-CandidateConfigToAddModList field, or LTM-CandidateConfigToAddModList IE), and each of the element(s) 2, . . . , N may be an addition or modification IE (e.g., LTM-ConfigToAddMod field, LTM-ConfigToAddMod IE, LTM-CandidateConfigToAddMod field, or LTM-CandidateConfigToAddMod IE). When the UE 102 receives the second addition or modification list, the UE 102 may store the second addition or modification list together with the first addition or modification list, e.g., in a variable in its RAM.

In some implementations, the DU 174 includes cell ID(s) 2, . . . , N in the LTM DU configuration(s) 2, . . . , N to identify the cell(s) 2, . . . , N, respectively. In one implementation, each of the cell ID(s) 2, . . . , N is a PCI. In some further implementations, the LTM DU configuration(s) 2, . . . , N includes cell index(es) 2, . . . , N indexing the cell ID(s) 2, . . . , N or the cell(s) 2, . . . , N, respectively. In the case that the CU 172 prepares the cell(s) 2, . . . , N for LTM in the procedure 390, the CU 172 may set the cell index(es) 2, . . . , N to different value(s) and include the cell index(es) 2, . . . , N in the first CU-to CU-to-DU message of the event 308. In the case that the CU 172 prepares the cell(s) 2, . . . , N in the additional LTM preparation procedure(s), the CU 172 may set the cell index(es) 2, . . . , N to different values and include the cell index(es) 2, . . . , N in CU-to-DU message(s) of the additional LTM preparation procedure(s). The CU 172 sets the cell index(es) 1, . . . , N to different values. In some implementations, the cell ID(s) 1, ..., N in the LTM DU configuration(s) 1, . . . , N are different from the cell ID(s) 1, . . . , N in the CU-to-DU message(s) described above.

In some implementations, each of the LTM DU configuration(s) 1, . . . , N includes physical configuration parameters, MAC configuration parameters, RLC configuration parameters, and/or L1 measurement configuration(s). In some implementations, each of the LTM DU configuration(s) 1, . . . , N may be a CellGroupConfig IE (e.g., defined in 3GPP specification TS 38.331). In other implementations, each of the LTM DU configuration(s) 1, . . . , N include configuration parameters included in a CellGroupConfig IE (e.g., defined in 3GPP specification TS 38.331). In some further implementations, the plurality of configuration parameters in each of the LTM DU configuration(s) include a particular special cell configuration (e.g., SpCellConfig IE) and/or one or more SCell configurations (e.g., SCellConfig IE(s)). In some implementations, the LTM DU configuration(s) 1, . . . , N are CellGroupConfig IE(s) (e.g., defined in 3GPP specification TS 38.331). In other implementations, the LTM DU configuration(s) 1, . . . , N include configuration parameters in the CellGroupConfig IE.

In some implementations, the CU 172 may include one or more additional LTM CU configurations in at least one of the element(s) 2, . . . , N, the first container or the second container. Each of the additional LTM CU configurations are associated with a particular LTM DU configuration of the LTM DU configuration(s) 2, . . . , N. Examples and implementations of the additional LTM CU configurations are similar to the LTM CU configuration 1.

In some implementations, the CU 172 determines to release the LTM DU configuration M of the LTM DU configuration(s) 1, . . . , N (or the element M of the element(s) 1, . . . , M). 1≤M≤N. In response to the determination, the CU 172 transmits an RRC reconfiguration message to the UE 102 via the DU 174 to indicate the UE 102 to release the LTM DU configuration M or element M. In one implementation, the CU 172 generates a release list including the ID (i.e., LTM ID) M for releasing the LTM DU configuration M or element M and includes the release list in the RRC reconfiguration message. In response to the RRC reconfiguration message, the UE 102 releases the LTM DU configuration M or element M and transmits a RRC reconfiguration complete message to the CU 172 via the DU 174. In response to the determination, the CU 172 transmits a CU-to-DU message to the DU 174 to indicate the DU 174 to release the LTM DU configuration M. In order to prompt the DU 174 to release the LTM DU configuration M, the CU 172 may include the cell ID M or the ID (i.e., LTM ID) M in a release indication (e.g., a field or IE) in the CU-to-DU message. In response, the DU 174 releases the LTM DU configuration M and transmits a DU-to-CU message to the CU 172. In some implementations, the CU-to-DU message and DU-to-CU message are a UE Context Modification Request message and a UE Context Modification Response message, respectively.

In other implementations, the DU 174 determines to release the LTM DU configuration K. In response to the determination, the DU 174 transmits a DU-to-CU message to the CU 172 to release the LTM DU configuration K. To indicate the LTM DU configuration K is released, the DU 174 may include the cell ID K or the ID (i.e., LTM ID) K in a release indication (e.g., a field or IE) in the DU-to-CU message. 1≤K≤N. After (e.g., in response to) receiving the DU-to-CU message, the CU 172 generates a release list including the ID (i.e., LTM ID) K to release the LTM DU configuration K or element K and transmits a RRC reconfiguration message including the release list to the UE 102 via the DU 174. In response, the UE 102 releases the LTM DU configuration K or element K and transmits a RRC reconfiguration complete message to the UE 102 via the DU 174. The CU 172 may transmit a CU-to-DU message to the DU 174 in response to the DU-to-CU message. In some implementations, the DU-to-CU message and CU-to-DU message are a UE Context Modification Required message and a UE Context Modification Confirm message, respectively.

After receiving the RRC reconfiguration in the event 318 or transmitting the RRC reconfiguration complete message in the event 320, the UE 102 transmits 324 at least one measurement report to the DU 174, similar to the event 304. In some implementations, the DU 174 may transmit 326 a DU-to-CU message including the at least one measurement report to the CU 172, similar to the event 306. In other implementations, the DU 174 does not transmit the at least one measurement report to the CU 172. In some implementations, the at least one measurement report of the event 324 includes L1 measurement report(s) or L3 measurement report(s), as described for the event 304. In some implementations, the UE 102 transmits 324 the at least one measurement report on PUCCH(s) and/or PUSCH(s) to the DU 174, similar to the event 304. In other implementations, the UE 102 transmits 324 at least one MAC CE including the at least one measurement report to the DU 174, similar to the event 304. In some implementations, the UE 102 does not transmit the L1 measurement report(s) in the format of RRC message(s) to the DU 174.

In some implementations, the UE 102 transmits 324 the at least one measurement report to the DU 174 in accordance with at least one measurement configuration. The at least one measurement configuration configures the UE 102 to perform measurements and report measurement results. The CU 172 transmits the at least one measurement configuration to the UE 102 via the DU 174. For example, the CU 172 may transmit one or more RRC messages (e.g., RRCReconfiguration message(s)) including the at least one measurement configuration to the UE 102 via the DU 174 in the event 302 and/or 316 and/or after the event 306 or 316. The one or more RRC messages may or may not include the RRC reconfiguration message of the event 316. In accordance with the at least one measurement configuration, the UE 102 performs measurements on one or more reference signals. The one or more reference signals may include one or more SSBs and/or one or more CSI-RSs. The UE 102 obtains the at least one L1 measurement result and/or at least one L3 measurement result from the measurements and includes the at least one L1 measurement result and/or at least one L3 measurement result in the at least measurement report of the event 324. The DU 174 transmits the one or more reference signals on the cell 124A, the cell 1, and/or the cell(s) 2, . . . , N. The one or more reference signals may be CSI-RS(s) or SSB(s).

In some implementations, the at least one measurement configuration includes L3 measurement configuration(s) (e.g., MeasConfig IE(s)), as described for the event 304. In other implementations, the at least one measurement configuration includes L1 measurement configuration(s), as described for the event 304. For example, the L1 measurement configuration(s) may be CSI-MeasConfig IE(s) (e.g., anticipated to be defined in 3GPP specification TS 38.331). The L1 measurement configuration(s) may include measurement report configuration(s). The UE 102 transmits the L1 measurement report(s) on PUCCH(s) or MAC CE(s) to the DU 174 in accordance with the measurement report configuration(s). The DU 174 receives the L1 measurement report(s) on PUCCH(s) or MAC CE(s) in accordance with the measurement report configuration(s). In some implementations, the measurement report configuration(s) are CSI-ReportConfig IE(s). In other implementations, each of the measurement report configuration(s) is a new RRC IE. In some implementations, (each of) the measurement report configuration(s) configures periodically reporting and/or event-triggered reporting of the L1 measurement result(s).

In yet other implementations, the at least one measurement configuration includes new-type measurement configuration(s) (e.g., LTM measurement configuration(s)). The new-type measurement configuration is anticipated to be defined in a 3GPP specification. In some implementations, the new-type measurement configuration(s) includes reference signal resource configuration(s) configuring resources where the DU 174 transmits reference signal(s). For example, the reference signal resource configuration(s) include CSI-RS(s) and/or SSB(s). In one implementation, the reference signal resource configuration(s) is/are CSI-ResourceConfig IE(s). In another implementation, the new-type measurement configuration(s) include measurement report configuration(s), as described above. The UE 102 transmits the measurement report(s) on PUCCH(s) or MAC CE(s) to the DU 174 in accordance with the measurement report configuration(s). The DU 174 receives the measurement report(s) on PUCCH(s) or MAC CE(s) in accordance with the measurement report configuration(s). In such cases, the measurement report(s) may be L1 measurement report(s) or new-type measurement report(s) (e.g., LTM measurement report(s)). In some implementations, the new-type measurement configuration includes configuration parameters anticipated to be newly defined in a 3GPP specification.

After (e.g., in response to) receiving the at least one measurement report in the event 324, the DU 174 generates a first LTM command to activate the LTM DU configuration 1 (i.e., the first LTM command commands the UE 102 to apply the LTM DU configuration 1 or to perform a serving cell change to the cell 1). The DU 174 then transmits 330 the first LTM command to the UE 102. In some implementations, the DU 174 transmits the first LTM command on the cell 124A to the UE 102. In other implementations, the DU 174 transmits the first LTM command on the cell 124D to the UE 102. In some implementations, the DU 174 may include the ID 1 in the first LTM command to indicate the LTM DU configuration 1, and the UE 102 determines (e.g., identifies) the LTM DU configuration 1 or element 1 in accordance with the ID 1. In other implementations, the DU 174 may include the cell index 1 indexing the cell ID 1 in the first LTM command. The UE 102 determines (e.g., identifies) the LTM DU configuration 1 or element 1 based on the cell index 1. In still other implementations, the DU 174 may include a PCI (i.e., PCI 1) of the first cell in the first LTM command. The UE 102 determines (e.g., identifies) the LTM DU configuration 1 or element 1 based on the PCI 1. After determining the LTM DU configuration 1 or element 1, the UE 102 then applies the LTM DU configuration 1 and/or LTM CU configuration 1, in response to receiving the first LTM command.

In yet other implementations, the DU 174 includes cell ID 1 in the first LTM command, where the cell ID 1 identifies the cell 1. In some implementations, the cell ID 1 included in the first LTM command is the same as the cell ID 1 included in the first CU-to-DU message. In other implementations, the DU 174 determines the cell ID 1 (e.g., PCI) included in the first LTM command from the cell ID 1 (e.g., CGI) received in the first CU-to-DU message. The UE 102 determines (e.g., identifies) the LTM DU configuration 1 or element 1,based on the cell ID 1. Before receiving the first LTM command, the UE 102 retrieves the cell ID 1 from the LTM DU configuration 1 or element 1, and establishes an association 1 between the cell ID 1 and the LTM DU configuration 1 or element 1. In other words, the UE 102 decodes the LTM DU configuration 1 or element 1 to obtain the cell ID 1, before receiving the first LTM command. Thus, the UE 102 identifies the LTM DU configuration 1 or element 1 in accordance with the cell ID 1 (received in the first LTM command) and the association 1. Before receiving the first LTM command, the UE 102 retrieves the cell ID(s) 2, . . . , N from the LTM DU configuration(s) or element(s) 2, . . . , N and establishes association(s) 2, . . . , N between the cell ID(s) 2, . . . , N and the LTM DU configuration(s) or element(s) 2, . . . , N, respectively. In other words, the UE 102 decodes the LTM DU configuration(s) or element(s) 2, . . . , N to obtain the cell ID(s) 2, . . . , N, before receiving the first LTM command. In some implementations, the DU 174 has a mapping table to store mappings between the PCI(s) 1, . . . , N and the CGI(s) 1, . . . , N for the cell(s) 1, . . . , N, respectively.

In yet other implementations, the DU 174 may include a bit map in the first LTM command to activate the LTM DU configuration 1, instead of the ID 1 or cell index 1. The number of bits in the bit map is larger than or equal to “N”. In one implementation, bit 1, . . . , N corresponds to the cell index(es) 1, . . . , N, the ID(s) 1, . . . , N, the LTM DU configuration(s) 1, . . . , N or the element(s) 1, . . . , N, respectively, and the DU 174 sets a corresponding bit (e.g., bit 1) in the bit map to a first value to indicate the cell index 1, the cell ID 1, the ID 1, the LTM DU configuration 1 or the element 1. Thus, the UE 102 may determine the cell index 1, the cell ID 1, the ID 1, LTM DU configuration 1, or element 1 in accordance with the bit 1 set to the first value in the bit map. In another implementation, bit 0, . . . , N-1 corresponds to the cell index(es) 1, . . . , N, the ID(s) 1, . . . , N, the LTM DU configuration(s) 1, . . . , N or the element(s) 1, . . . , N, respectively, and the DU 174 sets a corresponding bit (e.g., bit 0) in the bit map to a first value to indicate the cell index 1, the cell ID 1, the ID 1, the LTM DU configuration 1 or the element 1. Thus, the UE 102 may determine the cell index 1, the ID 1 LTM DU configuration 1 or element 1 in accordance with the bit 0 set to the first value in the bit map. In such implementations, the DU 174 sets the remaining bits in the bit map to a second value to indicate that the rest of the LTM DU configuration(s) 1, . . . , N is/are not activated. In some implementations, the first value is one and the second value is zero. In other implementations, the first value is zero and the second value is one. Generally, if the DU 174 determines to activate the LTM DU configuration L or change a serving cell to the cell L, the DU 174 may set the corresponding bit (e.g., bit L or bit L-1) in the bit map to the first value and set the remaining bits to the second value, where 1≤L≤N. In some implementations, the DU 174 sets at most one bit in the bit map to the first value.

In some implementations, the at least one measurement report (e.g., L1 measurement report(s) or new-type measurement report(s)) of the event 324 includes at least one measurement result for the first cell, TRP(s) of the first cell or reference signal(s) transmitted on the first cell. The reference signal(s) may be CSI-RS(s) or SSB(s). The DU 174 determines to activate the LTM DU configuration 1 or transmit the first LTM command, based on the at least one measurement result. In some implementations, the DU 174 determines to activate the LTM DU configuration 1 when or if the at least one measurement result is above a second predetermined threshold. In some implementations, the at least one measurement result includes L1-RSRP value(s), L1-RSRQ value(s), and/or L1-SINR value(s). In other implementations, the at least one measurement result includes RSRP value(s), RSRQ value(s), and/or SINR value(s) for the new-type measurement report(s). In some implementations, the second predetermined threshold is different from the first predetermined threshold. In one implementation, the second predetermined threshold is larger than the first predetermined threshold. In this case, the at least one measurement result indicates that the first cell is suitable for communication with the UE 102. In another implementation, the second predetermined threshold is equal to the first predetermined threshold. In this case, the at least one measurement result indicates that the first cell has been continuously above the second predetermined threshold or the first predetermined threshold. This indicates that the first cell is suitable for communication with the UE 102. Thus, the DU 174 determines to activate the LTM DU configuration 1 in response to the signal strength or quality of the first cell being above the second predetermined threshold for the UE 102.

In some implementations, the at least one measurement report (e.g., L3 measurement report(s)) of the events 324 and 326 includes at least one measurement result for the first cell. The CU 172 determines to activate the LTM DU configuration 1 or transmit the first LTM command, because the at least one measurement result indicates that signal strength or quality of the first cell is above a second predetermined threshold. The second predetermined threshold is different from the first predetermined threshold. In one implementation, the second predetermined threshold is larger than the first predetermined threshold. In such an implementation, the at least one measurement report of the event 326 indicates that signal strength or quality of the first cell is suitable for communication with the UE 102. In another implementation, the second predetermined threshold is equal to the first predetermined threshold. In such an implementation, the at least one measurement report of the event 326 indicates that signal strength or quality of the first cell has been continuously above the second predetermined threshold or the first predetermined threshold. This also indicates that the first cell is suitable for communication with the UE 102. Thus, the CU 172 determines to activate the LTM DU configuration 1 in response to the signal strength or quality of the first cell being above the second predetermined threshold. In response to the determination, the CU 172 transmits 328 a fourth CU-to-DU message to the DU 174 to activate the LTM DU configuration 1 or trigger a serving cell change to the cell 1 for the UE 102. In some implementations, the CU 172 includes the ID 1 in the fourth CU-to-DU message. In other implementations, the CU 172 includes the cell index 1 in the fourth CU-to-DU message. In response to the fourth CU-to-DU message, the DU 174 transmits 330 the first LTM command to the UE 102 and optionally transmits a fourth DU-to-CU message to the CU 172. In some implementations, the CU 172 includes the cell index 1 in the fourth CU-to-DU message. Thus, the DU 174 may determine to activate the LTM DU configuration 1 in accordance with the cell index 1. In other implementations, the CU 172 may include the cell ID 1 in the fourth CU-to-DU message. Thus, the DU 174 determines to activate the LTM DU configuration 1 in accordance with the cell ID 1. In yet other implementations, the CU 172 may include the ID 1 in the fourth CU-to-DU message. Thus, the DU 174 may determine to activate the LTM DU configuration 1 in accordance with the ID 1. In some implementations, the fourth CU-to-DU message and fourth DU-to-CU message are a UE Context Modification Request message and a UE Context Modification Response message, respectively. In other implementations, the fourth CU-to-DU message and/or fourth DU-to-CU message are new interface messages (e.g., F1 application protocol (F1AP) messages anticipated to be defined in 3GPP specification TS 38.473).

When or in response to determining to activate the LTM DU configuration 1 or transmit the first LTM command 330, the DU 174 may transmit 329 to the CU 172 a DU-to-CU message indicating LTM (being) executed. In some implementations, the DU 174 includes the cell ID 1 or the ID 1 (i.e., LTM ID) in the DU-to-CU message 329 to indicate that the DU 174 is to activate the LTM DU configuration 1 or trigger a fast serving cell change. The DU may transmit the DU-to-CU message 329 to the CU 172 before or after transmitting the LTM command 330.

In some implementations, the first LTM command is a MAC CE included in a MAC PDU that the UE 102 receives from the DU 174 in the event 330. The MAC CE may be a new MAC CE (e.g., anticipated to be defined in 3GPP specification TS 38.321). In one implementation, the DU 174 includes a subheader identifying the new MAC CE in the MAC PDU and the UE 102 identifies the new MAC CE in the MAC PDU in accordance with the subheader. The subheader may include a logical channel ID or extended logical channel ID defined in a 3GPP specification to identify the new MAC CE. For example, the logical channel ID or extended logical channel ID anticipated to be newly defined in 3GPP specification 38.321. In other implementations, the first LTM command is a DCI that the UE 102 receives on a PDCCH from the DU 174 in the event 330. The DU 174 generates a CRC for the DCI, scrambles the CRC with a first cell radio network temporary identifier, C-RNTI, of the UE 102, and transmits the DCI and scrambled CRC on the PDCCH in the event 330. In one implementation, a format of the DCI may be an existing DCI format defined in a 3GPP specification (e.g., TS 38.212). In another implementation, the format of the DCI may be a new DCI format anticipated to be defined in a 3GPP specification (e.g., TS 38.212).

In some implementations, the DU 174 does not perform security protection (e.g., integrity protection and/or encryption) on the first LTM command. This speeds up processing the first LTM command in the UE 102 because the UE 102 does not perform a security check (e.g., a decryption and/or integrity check) on the first LTM command.

In some implementations, after receiving the first LTM command, the UE 102 may transmit 331 an acknowledgement to the DU 174 on the cell 124A or cell 124D to indicate that the UE 102 receives the first LTM command. In some implementations, the acknowledgement is a HARQ ACK. In other implementations, the acknowledgement is a MAC CE. For example, the MAC CE is an existing MAC CE (e.g., defined in 3GPP specification TS 38.321). In another example, the MAC CE is a new MAC CE (e.g., anticipated to be defined in 3GPP specification TS 38.321). In yet other implementations, the acknowledgement is a PUCCH transmission.

In some implementations, the CU 172 transmits 316 the RRC reconfiguration message in response to the L3 measurement report 306 for the first cell. To configure the UE 102 to transmit the L3 measurement report 306, the CU 172 may transmit a first RRC reconfiguration message including the L3 measurement configuration (e.g., a MeasConfig IE) to the UE 102 before the event 306. In some implementations, the DU 174 transmits 330 the first LTM command in response to the L1 measurement report(s) 324 for the first cell. To configure the UE 102 to transmit the L1 or new-type measurement report(s) 324, the CU 172 may transmit a second RRC reconfiguration message including the L1 or new-type measurement configuration(s) to the UE 102. In some implementations, the first and second RRC reconfiguration messages may be the same message (i.e., the same instance). In other implementations, the first and second RRC reconfiguration messages are different messages. In some implementations, the second RRC reconfiguration message is the RRC reconfiguration message of the event 316. In other implementations, the second RRC reconfiguration message is different from the RRC reconfiguration message of the event 316.

After (e.g., in response to) receiving the first LTM command, the UE 102 identifies the LTM DU configuration 1 in accordance with the ID 1 and applies the LTM DU configuration 1. In some implementations, the UE 102 may perform 332 a random access procedure on the first cell with the DU 174 in response to applying the LTM DU configuration 1 or receiving the first LTM command. In some implementations, the UE 102 disconnects from the cell 124A after (e.g., in response to) receiving the first LTM command or after transmitting the acknowledgement. In other words, the UE 102 stops communicating on the cell 124A after (e.g., in response to) receiving 330 the first LTM command or transmitting 331 the acknowledgement. In such cases, the UE 102 performs 332 the random access procedure after disconnecting from the cell 124A. The UE 102 may determine whether to perform the random access procedure in accordance with the LTM DU configuration 1. In one implementation, if the LTM DU configuration 1 configures the UE 102 to perform a random access procedure, the UE 102 performs the random access procedure in the event 332. For example, the LTM DU configuration 1 includes a reconfiguration with sync configuration (e.g., ReconfigurationWithSync IE) to configure the UE 102 to perform a random access procedure. Otherwise, if the LTM DU configuration 1 does not configure the UE 102 to perform a random access procedure or configures the UE 102 to skip a random access procedure, the UE 102 refrains from performing a random access procedure with the DU 174 upon receiving the first LTM command. In such a cases, the UE 102 skips the event 316. For example, if the LTM DU configuration 1 excludes a reconfiguration with sync configuration, the LTM DU configuration 1 configures the UE 102 not to perform a random access procedure. In some implementations, the random access procedure is a four-step random access procedure. In other implementations, the random access procedure is a two-step random access procedure. In some implementations, the random access procedure is a contention-free random access procedure. In other implementations, the random access procedure is a contention-based random access procedure.

In the case that the UE 102 performs 332 the random access procedure, the UE 102 communicates 336 with the DU 174 on the first cell using the LTM DU configuration 1 and/or reference LTM DU configuration and communicates with the CU 172 via the DU 174, after successfully completing the random access procedure. In such cases, the DU 174 communicates with the UE 102 on the first cell using the LTM DU configuration 1 in the event 332 and/or event 336. In some scenarios or implementations, the UE 102 communicates UL PDUs, DL PDUs, and/or physical layer signals (e.g., PUCCH transmissions and PDCCH transmissions) with the base station 104 in the event 336. In some implementations, the UE 102 determines that the UE 102 successfully completes the random access procedure when the UE 102 receives a contention resolution from the DU 174. In cases where the random access procedure is a four-step random access procedure, the UE 102 transmits a Message 3 including a UE identity to the DU 174 via the first cell in the random access procedure. In cases where the random access procedure is a two-step random access procedure, the UE 102 transmits a Message A including the UE identity to the DU 174 via the first cell in the random access procedure. In some implementations, if the LTM DU configuration 1 includes a second C-RNTI, the UE identity is the second C-RNTI of the UE 102. Otherwise, if the LTM DU configuration 1 does not include a C-RNTI, the UE identity is the first C-RNTI. In cases where the random access procedure is a contention free random access procedure, the UE 102 transmits the dedicated random access preamble to the DU 174 via the first cell. In such cases, the LTM DU configuration 1 includes the dedicated random access preamble.

The DU 174 identifies or determines that the UE 102 connects to the first cell upon receiving the UE identity or the dedicated preamble from the UE 102 in the random access procedure 332.

In the case that the UE 102 skips the random access procedure, the UE 102 directly communicates 336 with the DU 174 on the first cell in accordance with the LTM DU configuration 1 and communicates with the CU 172 via the DU 174, after (e.g., in response to) receiving the first LTM command. For example, the UE 102 directly communicates UL PDUs, DL PDUs, and/or physical layer signals (e.g., PUCCH transmissions and PDCCH transmissions) with the base station 104 in the event 336. In some implementations, the DU 174 may include, in the LTM DU configuration 1, configuration parameters configuring resources for the UE 102 to transmit the at least one PUCCH or PUSCH transmission, and the UE 102 transmits the at least one PUCCH or PUSCH transmission on the resources, using the configuration parameters, to indicate that the UE 102 connects to the first cell. In other implementations, the DU 174 may transmit to the UE 102 at least one DCI on a PDCCH on the first cell to command the UE 102 to transmit the at least one PUCCH or PUSCH transmission, after transmitting the first LTM command. The at least one DCI configures resources for the UE 102 to transmit the at least one PUCCH or PUSCH transmission, and the UE 102 transmits the at least one PUCCH or PUSCH transmission on the resources. The DU 174 identifies or determines that the UE 102 connects to the first cell upon receiving the PUCCH or PUSCH transmission. The DU 174 identifies or determines that the UE 102 connects to the first cell upon receiving the PUCCH or PUSCH transmission on the resources configured in the LTM DU configuration 1 or the at least one DCI.

In the case that the UE 102 receives the reference LTM DU configuration as described above, the UE 102 communicates 336 with and the DU 174 on the first cell in accordance with the LTM DU configuration 1 and at least a portion of the reference LTM DU configuration. In other words, the UE 102 communicates 336 with the DU 174 in accordance with configuration parameters in the LTM DU configuration 1 and the reference LTM DU configuration. Similarly, the DU 174 communicates 336 with the UE 102 on the first cell in accordance with the LTM DU configuration 1 and at least a portion of the reference LTM DU configuration. In other words, the DU 174 communicates 336 with the UE 102 in accordance with configuration parameters in the LTM DU configuration 1 and the reference LTM DU configuration.

In the case that the UE 102 receives neither the LTM CU configuration 1 nor a/the reference LTM CU configuration, the UE 102 communicates 336 with the CU 172 via the DU 174 using the serving CU configuration. Correspondingly, if the CU 172 neither transmits the LTM CU configuration 1 nor a/the reference CU configuration to the UE 102, the CU 172 communicates 336 with the UE 102 via the DU 174 using the serving CU configuration. In the case that the UE 102 receives the LTM CU configuration 1 and the reference LTM CU configuration from the CU 172, the UE 102 communicates 336 with the CU 172 via the DU 174 using the LTM CU configuration 1 and (at least a portion of) the reference LTM CU configuration not augmented by the LTM CU configuration 1. In this case, the CU 172 communicates 336 with the UE 102 via the DU 174 using the LTM CU configuration 1 and (at least a portion of) the reference LTM CU configuration not augmented by the LTM CU configuration 1.

In the case that the UE 102 receives the LTM CU configuration 1 and does not receive the reference LTM CU configuration from the CU 172, the UE 102 communicates 336 with the CU 172 via the DU 174 using the LTM CU configuration 1. In this case, the CU 172 communicates 336 with the UE 102 via the DU 174 using the LTM CU configuration 1. If the LTM CU configuration 1 is a full configuration (i.e., a complete configuration), the UE 102 and CU 172 communicates 336 with each other via the DU 174 using the LTM CU configuration 1 instead of the serving CU configuration. In some implementations, if the UE 102 does not receive a reference LTM CU configuration from the base station 104, the UE 102 determines that the LTM CU configuration 1 is a full configuration. Correspondingly, if the CU 172 determines to configure or configures the LTM CU configuration 1 as a full configuration, the CU 172 does not transmit a/the reference LTM CU configuration to the UE 102. In other implementations, the CU 172 includes a first indication (e.g., a field or IE) in the LTM CU configuration 1, the first container, the element 1 or the RRC reconfiguration message 316 to indicate that the LTM CU configuration 1 is a full configuration. If the LTM CU configuration 1 is a delta configuration to augment the serving CU configuration, the UE 102 and CU 172 communicates 336 with each other via the DU 174 using the LTM CU configuration 1 and at least a portion of the serving CU configuration not augmented by the LTM CU configuration 1. In some implementations, if the UE 102 does not receive a/the reference LTM CU configuration from the base station 104, the UE 102 determines that the LTM CU configuration 1 is a delta configuration to augment the serving CU configuration. Correspondingly, if the CU 172 determines to configure or configures the LTM CU configuration 1 as a delta configuration to augment the serving CU configuration, the CU 172 does not transmit a/the reference LTM CU configuration to the UE 102. In some implementations, the CU 172 indicates that the LTM CU configuration 1 is a delta configuration to augment to the serving CU configuration, by excluding the first indication in the LTM CU configuration 1, the first container, the element 1, and/or the RRC reconfiguration message 316. Alternatively, the CU 172 includes a second indication (e.g., a field or IE) in the LTM CU configuration 1, the first container, the element 1 or the RRC reconfiguration message 316 to indicate that the LTM CU configuration 1 is a delta configuration to augment the serving CU configuration. In some implementations, the CU 172 indicates that the LTM CU configuration 1 is a full configuration, by excluding the second indication in the LTM CU configuration 1, the first container, the element 1, and/or the RRC reconfiguration message 316.

In the case that the UE 102 receives the reference LTM CU configuration and does not receive the LTM CU configuration 1 from the CU 172, the UE 102 communicates 336 with the CU 172 via the DU 174 using the reference LTM CU configuration. In this case, the CU 172 communicates 336 with the UE 102 via the DU 174 using the reference LTM CU configuration. If the reference LTM CU configuration is a full configuration, the UE 102 and CU 172 communicates 336 with each other via the DU 174 using the reference LTM CU configuration instead of the serving CU configuration. In some implementations, the UE 102 and CU 172 determine that the reference LTM CU configuration 1 is a full configuration as specified in a 3GPP document (e.g., anticipated to be defined in 3GPP specification TS 38.331). In other implementations, the CU 172 includes a first indication (e.g., a field or IE) in the reference LTM CU configuration, the first container or the RRC reconfiguration message 316 to indicate that the reference LTM CU configuration is a full configuration. If the reference LTM CU configuration is a delta configuration to augment the serving CU configuration, the UE 102 and CU 172 communicates 336 with each other via the DU 174 using the reference LTM CU configuration and at least a portion of the serving CU configuration not augmented by the reference LTM CU configuration. In some implementations, the CU 172 indicates that the reference LTM CU configuration is a delta configuration to augment to the serving CU configuration, by excluding the first indication in the reference LTM CU configuration, the first container, the element 1, and/or the RRC reconfiguration message 316. Alternatively, the CU 172 includes a second indication (e.g., a field or IE) in the reference LTM CU configuration, the first container, the element 1 or the RRC reconfiguration message 316 to indicate that the reference LTM CU configuration is a delta configuration to augment the serving CU configuration. In some implementations, the CU 172 indicates that the reference LTM CU configuration is a full configuration, by excluding the second indication in the reference LTM CU configuration, the first container, the element 1, and/or the RRC reconfiguration message 316.

In the case that the UE 102 neither receives the reference LTM CU configuration nor the LTM CU configuration 1 from the CU 172, the UE 102 communicates 336 with the CU 172 via the DU 174 using the serving LTM CU configuration. In this case, the CU 172 communicates 336 with the UE 102 via the DU 174 using the serving LTM CU configuration.

In some implementations, the UE 102 transmits a RRC message (e.g., RRC reconfiguration complete message) to the CU 172 via the DU 174 and the first cell to indicate that the UE 102 applies the LTM DU configuration 1. In the case that the UE 102 performs the random access procedure 332, the UE 102 may include the RRC message in the Message 3 or Message A. Alternatively, the UE 102 transmits the RRC message after completing the random access procedure. In the case that the UE 102 skips the random access procedure 332, the UE 102 transmits a PUSCH transmission including the RRC message to the DU 174 via the first cell. In some implementations, the UE 102 transmits the PUSCH transmission in accordance with a preconfigured grant received in the LTM DU configuration 1. In other implementations, the UE 102 transmits the PUSCH transmission in accordance with a dynamic grant received on a PDCCH via the first cell. In some implementations, if the UE 102 maintains communication on the cell 124A with the base station 104 (i.e., the UE 102 does not disconnect from the cell 124A), the UE 102 may transmit the RRC message to the base station 104 via the cell 124A. When the DU 174 receives the RRC message, the DU 174 transmits the RRC message to the CU 172.

In other implementations, the UE 102 refrains from transmitting the RRC message to the base station 104 in response to applying the LTM DU configuration 1 or receiving the first LTM command. In such cases, the UE 102 may include or transmit data in the Message 3, Message A or PUSCH transmission as described above. The UE 102 may generate a MAC PDU and/or a RLC PDU including the data, and may transmit or include the MAC PDU and/or RLC PDU in the PUSCH transmission. For example, the data may be a PDCP PDU, a SDAP PDU, a LTE Positioning Protocol (LPP) PDU, a RRC PDU, and/or a NAS PDU. The RRC PDU includes a UL-DCCH-Message excluding a RRC reconfiguration complete message. The NAS PDU includes a Mobility Management, MM, message or a Session Management, SM, message. The MM message may be a 5G MM message or a 6G MM message, and the SM message may be a 5G SM message or a 6G SM message. When the DU 174 receives the data, the DU 174 transmits the data to the CU 172.

When the DU 174 determines that the UE 102 successfully connects to the first cell in the event 332 or 336, the DU 174 may transmit 334 a DU-to-CU message (e.g., an Access Success message) to the CU 172 (e.g., a control plane, CP, subunit 172A of the CU 172). In some implementations, the DU 174 may include the cell ID 1 of the first cell in the DU-to-CU message of the event 334. The cell ID may be a PCI or a CGI. Thus, the CU 172 determines that the UE 102 connects to the first cell upon receiving the DU-to-CU message of the event 334. When the DU 174 determines that the UE 102 successfully connects to the first cell in the event 332 or 336, the DU 174 may transmit a DL Data Delivery Status message or frame to the CU 172 (e.g., a UP of the CU 172). In some implementations, when or after the CU 172 receives the DU-to-CU message 329, the CU 172 may stop or suspend transmitting DL data for the UE 102 to the DU 174 until receiving the DU-to-CU message 334. The CU 172 may do so because the DU 174 may not buffer DL data for the UE 102 during the LTM execution in the events 330 and/or 332. After receiving the DU-to-CU message 334, the CU 172 continues or resumes transmitting DL data for the UE 102 to the DU 174. In other implementations, when the CU 172 receives the DU-to-CU message 329, the CU 172 may continue transmitting DL data for the UE 102 to the DU 174. The CU 172 may do so because the DU 174 may buffer DL data for the UE 102 during the LTM execution in the events 330 and/or 332. When or after the DU 174 detects that UE 102 accesses the cell 1, the DU 174 transmits the DL data to the UE 102 via the cell 1.

In some implementations, when determining that the UE 102 connects to the first cell, transmitting 330 the first LTM command, or receiving 331 the acknowledgement, the DU 174 may stop communicating with the UE 102 on the cell 124A and/or release resources of the cell 124A configured for the UE 102.

In some implementations, the DU 174 may generate some or all of the LTM DU configuration 1 and/or LTM DU configuration(s) 2, . . . , N as full configuration(s) (i.e., complete configuration(s)) to replace the serving DU configuration. If the LTM DU configuration 1 is a full configuration, the UE 102 and DU 174 communicate 336 with each other in accordance with the LTM DU configuration 1 instead of in accordance with the serving DU configuration. In some implementations, the DU 174 includes an indication indicating that the LTM DU configuration 1 is a full configuration in the LTM DU configuration 1. In each of the LTM DU configuration(s) 2, . . . , N, the DU 174 may include an indication to indicate that the corresponding DU configuration is a full configuration. Each of the indication(s) in the LTM DU configuration(s) 1, . . . , N may be a field or IE (i.e., the same field or IE). In other implementations, the CU 172 may include, in the RRC reconfiguration message of the events 316, 318, a single indication indicating that the LTM DU configuration(s) 1 and/or 2, . . . , N is/are full configuration(s). In the case of the second container, the CU 172 may include, in the additional RRC reconfiguration message, a single indication indicating that the LTM DU configuration(s) 2, . . . , N is/are full configuration(s). In yet other implementations, the CU 172 may include, in the first container, a single indication indicating that the LTM DU configuration(s) 1 and/or 2, . . . , N is/are full configuration(s). In yet other implementations, for each of the LTM DU configuration(s) 2, . . . , N, the CU 172 may include, in the first container, a particular indication indicating the corresponding LTM DU configuration is a full configuration. In the case of the second container, the CU 172 may include, in the second container, a single indication indicating that the LTM DU configuration(s) 2, . . . , N is/are full configuration(s). In yet other implementations, the CU 172 may include, in the element 1, includes an indication indicating that the LTM DU configuration 1 is a full configuration. In each of the element(s) 2, . . . , N, the CU 172 may include an indication indicating that the corresponding LTM DU configuration is a full configuration. The UE 102 may determine that the LTM DU configuration 1 and/or LTM DU configuration(s) 2, . . . , N is/are full configuration(s) based on the indication(s) above. In some implementations, each of the indication(s) above is different from a fullConfig field defined in the current 3GPP specification. In some implementations, each of the indication(s) above is a fullConfig field defined in the current 3GPP specification. In the case that the LTM DU configuration 1 is a full configuration, the UE 102 in the event 336 does not apply the reference LTM DU configuration if received from the base station 104, e.g., in the RRC reconfiguration message 318. In such cases, the DU 174 may not include a/the reference LTM DU configuration in the first DU-to-CU message 310.

In other implementations, the DU 174 may generate the LTM DU configuration 1 and/or LTM DU configuration(s) 2, . . . , N as delta configuration(s) that augment (a portion of) the reference LTM DU configuration. In other words, the DU 174 generates the LTM DU configuration(s) 1, . . . , N based on the reference LTM DU configuration. For example, if the LTM DU configuration 1 is a delta configuration, the UE 102 and DU 174 augment (the portion of) the reference LTM DU configuration with the LTM DU configuration 1. Thus, the UE 102 and DU 174 communicate 336 with each other in accordance with the LTM DU configuration 1 and unaugment portion of the reference LTM DU configuration. In some implementations, the LTM DU configuration(s) 1, and/or 2 . . . , N, first container, second container or element(s) 1, . . . , N exclude indication(s) indicating that the LTM DU configuration(s) 1, and/or 2 . . . , N is/are full configuration(s) to indicate that the LTM DU configuration(s) 1 and/or 2, . . . , N is/are delta configuration(s). The UE 102 may determine that each of the LTM DU configuration(s) 1 and/or 2, . . . , N is a delta configuration based on that the indication is excluded in the LTM DU configuration(s) 1 and/or 2, . . . , N, first container, second container or element(s) 1 and/or 2, . . . , N.

In some implementations, if the UE 102 does not receive a reference LTM DU configuration for the LTM DU configuration 1 and/or the LTM DU configuration(s) 2, . . . , N, the UE 102 determines that the LTM DU configuration 1, and/or the LTM DU configuration(s) 2, . . . , N are full configuration(s). Correspondingly, if the DU 174 does not obtain a reference LTM DU configuration for the UE 102 (i.e., the DU 174 does not generate a reference LTM DU configuration for the UE 102 and/or receive a reference LTM DU configuration for the UE 102 from the CU 172), the DU 174 generates the LTM DU configuration 1, and/or the LTM DU configuration(s) 2, . . . , N as full configuration(s).

In other implementations, if the UE 102 does not receive a reference LTM DU configuration for the LTM DU configuration 1 and/or the LTM DU configuration(s) 2, . . . , N, the UE 102 determines that the LTM DU configuration 1, and/or the LTM DU configuration(s) 2, . . . , N are delta configuration(s) to augment the serving DU configuration. In such cases, the UE 102 communicates 336 with the DU 174 in accordance with the LTM DU configuration 1 and at least a portion of the serving DU configuration not augmented by LTM DU configuration 1. Correspondingly, if the DU 174 does not obtain a reference LTM DU configuration for the UE 102 (i.e., the DU 174 does not generate a reference LTM DU configuration for the UE 102 and/or receive a reference LTM DU configuration for the UE 102 from the CU 172), the DU 174 generates the LTM DU configuration 1, and/or the LTM DU configuration(s) 2, . . . , N as delta configuration(s) to augment the serving DU configuration. In such cases, the DU 174 communicates 336 with the UE 102 in accordance with the LTM DU configuration 1 and the at least a portion of the serving DU configuration.

In some implementations, the UE 102 uses a UE MAC entity (e.g., MAC 204B) to communicate with a DU MAC entity (e.g., MAC 204B) of the DU 174 (e.g., the events 302, 304, 318, 320, 324, 330, and/or 331). In some implementations, the UE 102 resets the UE MAC entity, after or in response to receiving the first LTM command and before performing 332 the random access procedure or communicating 336 with the DU 174 via the first cell. In some implementations, the DU 174 resets the DU MAC entity after (e.g., in response to) transmitting the first LTM command, receiving the acknowledgement 331 or determining that the UE 102 connects to the first cell.

In some implementations, when the UE 102 resets the UE MAC entity, the UE 102 performs at least one of the following actions for the UE MAC entity (i.e., UE MAC reset or full UE MAC reset):
initialize Bj for configured logical channel(s) to zero;
stop one or more timers;
consider timeAlignment Timer(s) as expired, if the UE 102 is configured to perform the random access procedure (e.g., the event 332) in the configuration (e.g., the configuration 1);
set new data indicator(s), NDI(s), for UL HARQ process(es) to value 0;
set NDI(s) for HARQ process ID(s) to value 0 for monitoring PDCCH in Sidelink resource allocation mode 1;
flush MSG3 buffer;
flush MSGA buffer;
cancel, if any, triggered Scheduling Request procedure;
cancel, if any, triggered Buffer Status Reporting procedure;
cancel, if any, triggered Power Headroom Reporting procedure;
cancel, if any, triggered consistent listen-before-talk, LBT, failure;
cancel, if any, triggered Beam Failure Recovery, BFR, procedure;
cancel, if any, triggered Sidelink Buffer Status Reporting procedure;
cancel, if any, triggered Pre-emptive Buffer Status Reporting procedure;
cancel, if any, triggered Timing Advance Reporting procedure;
cancel, if any, triggered Recommended bit rate query procedure;
cancel, if any, triggered configured uplink grant confirmation;
cancel, if any, triggered configured sidelink grant confirmation;
cancel, if any, triggered Desired Guard Symbol query;
cancel, if any, triggered Positioning Measurement Gap Activation/Deactivation Request procedure;
flush soft buffers for DL HARQ process(es);
for each of the DL HARQ process(es), consider the next received transmission for a transmission block, TB, as the very first transmission;
release, if any, Temporary C-RNTI;
reset one or more counters (e.g., BFI_COUNTERs, with BFI standing for beam failure instance, and/or LBT_COUNTERs).

In some implementations, when the DU 174 resets the DU MAC entity, the DU performs at least one of the following actions for the DU MAC entity (i.e., DU MAC reset or full DU MAC reset):
stop one or more timers;
consider timeAlignmentTimer(s), that the DU 174 starts and/or maintains for the UE 102, as expired, if the UE 102 is configured to perform the random access procedure (e.g., the event 332) in the configuration (e.g., the configuration 1);
set NDI(s) for DL HARQ process(es) to value 0;
flush soft buffers for UL HARQ process(es);
for each of the UL HARQ process(es), consider the next received transmission for a TB as the very first transmission;
reset one or more counters (e.g., BFI_COUNTERs and/or LBT_COUNTERs)

Depending on implementations, the UE 102 may determine to reset the UE MAC entity partially or fully. In some implementations, when the UE 102 resets the UE MAC entity as described above, the UE 102 fully resets the UE MAC entity (i.e., a full UE MAC reset). In the full UE MAC reset, the UE 102 performs some or all of the actions described above. In other implementations, when the UE 102 resets the UE MAC entity as described above, the UE 102 partially resets the UE MAC entity (i.e., a partial UE MAC reset). In the partial UE MAC reset, the UE 102 performs a subset or portion of the some or all of the actions in the full UE MAC reset.

In some implementations, the partial UE MAC reset includes at least one of the following actions:
consider timeAlignmentTimer(s) of the UE 102 as expired, if the UE 102 is configured to perform the random access procedure (e.g., the event 332) in the configuration (e.g., the configuration 1);
flush MSG3 buffer;
flush MSGA buffer;
release, if any, Temporary C-RNTI;
reset one or more counters (e.g., BFI_COUNTERs and/or LBT_COUNTERs).

In some implementations, the partial UE MAC reset further includes at least one of the following actions:
cancel, if any, triggered Scheduling Request procedure;
cancel, if any, triggered Buffer Status Reporting procedure;
cancel, if any, triggered Power Headroom Reporting procedure;
cancel, if any, triggered consistent LBT failure;
cancel, if any, triggered BFR;
cancel, if any, triggered Sidelink Buffer Status Reporting procedure;
cancel, if any, triggered Pre-emptive Buffer Status Reporting procedure;
cancel, if any, triggered Timing Advance Reporting procedure;
cancel, if any, triggered Recommended bit rate query procedure;
cancel, if any, triggered configured uplink grant confirmation;
cancel, if any, triggered configured sidelink grant confirmation;
cancel, if any, triggered Desired Guard Symbol query;
cancel, if any, triggered Positioning Measurement Gap Activation/Deactivation Request procedure;

In some implementations, the partial UE MAC reset further includes at least one of the following actions:
stop a first portion of the one or more timers and retain the rest of the one or more timers;
set NDI(s) for UL HARQ process(es) to value 0;
set NDI(s) for HARQ process ID(s) to value 0 for monitoring PDCCH in Sidelink resource allocation mode 1;
flush soft buffers for DL HARQ process(es);
for each of the DL HARQ process(es), consider the next received transmission for a TB as the very first transmission;

Depending on implementations, the DU 174 may determine to partially or fully reset the DU MAC entity. In some implementations, when the DU 174 resets the DU MAC entity as described above, the DU 174 fully resets the DU MAC entity (i.e., a full DU MAC reset). In the full DU MAC reset, the DU 174 performs some or all of the actions described above. In other implementations, when the DU 174 resets the DU MAC entity as described above, the DU 174 partially resets the DU MAC entity (i.e., a partial DU MAC reset). In the partial DU MAC reset, the DU 174 performs a subset or portion of the some or all of the actions in the full DU MAC reset.

In some implementations, the partial DU MAC reset includes at least one of the following actions in the partial MAC reset:
consider timeAlignmentTimer(s), that the DU 174 starts and/or maintains for the UE 102, as expired, if the UE 102 is configured to perform the random access procedure (e.g., the event 332) in the configuration (e.g., the configuration 1);
reset one or more counters (e.g., BFI_COUNTERs and/or LBT_COUNTERs) In some implementations, when the partial DU MAC reset includes at least one of the following actions for the MAC entity (i.e., DU MAC reset):
stop a first portion of the one or more timers and retain the rest of the one or more timers;
set NDI(s) for DL HARQ process(es) to value 0;
flush soft buffers for UL HARQ process(es);
for each of the UL HARQ process(es), consider the next received transmission for a TB as the very first transmission;
reset one or more counters (e.g., BFI_COUNTERs and/or LBT_COUNTERs)

In other implementations, the UE 102 refrains from resetting the UE MAC entity in response to receiving the first LTM command. Similarly, the DU 174 refrains from resetting the DU MAC entity after (e.g., in response to) transmitting the first LTM command, receiving the acknowledgement 331 or determining that the UE 102 connects to the first cell. In other words, the UE 102 communicates with the DU 174 on the first cell using the UE MAC entity (not reset). Similarly, the DU 174 communicates with the UE 102 using the DU MAC entity (not reset) on the first cell during or after the random access procedure 332 or after determining that the UE 102 connects to the first cell.

In some implementations, the UE 102 uses at least one UE RLC entity (e.g., RLC 206B) to communicate RLC PDUs with at least one DU RLC entity (e.g., RLC 206B) of the DU 174 (e.g., the events 302, 304, 318, 320, 324, 330, and/or 331). In some implementations, the UE 102 reestablishes some or all of the at least one UE RLC entity, after or in response to receiving the first LTM command and before performing 332 the random access procedure or communicating 336 with the DU 174 via the first cell. In some implementations, the DU 174 reestablishes some or all of the at least one DU RLC entity after (e.g., in response to) transmitting the first LTM command, receiving the acknowledgement 331 or determining that the UE 102 connects to the first cell.

In some implementations, the LTM DU configuration 1 may or may not include one or more RLC reestablishment indications (e.g., reestablishRLC field(s)) configuring the UE 102 to reestablish some or all of the at least one UE RLC entity. In some implementations, if the LTM DU configuration 1 includes a RLC reestablishment indication configuring the UE 102 to reestablish a first UE RLC entity, of the at least one UE RLC entity, that the UE 102 uses to communicate RLC PDU(s) with the DU 174, the UE 102 reestablishes the first UE RLC entity in response to the RLC reestablishment indication and the first LTM command. In some implementations, the UE 102 may reestablish the first UE RLC entity before performing 332 the random access procedure or communicating 336 with the DU 174 via the first cell. In other implementations, the UE 102 may reestablish the first UE RLC entity while or after performing 332 the random access procedure. Otherwise if the LTM DU configuration 1 does not include the RLC reestablishment indication, the UE 102 refrains from reestablishing the first UE RLC entity in response to the first LTM command. In other implementations, the CU 172 indicates that the first cell and the cell 124A (i.e., a serving cell) belong to the same group (e.g., the same DU or the same cell group) in the element 1, and the UE 102 refrains from reestablishing the at least one UE RLC entity in response to the indication. If the CU 172 indicates that the first cell and the cell 124A belong to different groups (e.g., different DUs or different cell groups), the UE 102 reestablishes the at least one UE RLC entity.

In some implementations, when the UE 102 reestablishes the first UE RLC entity, the UE 102 performs at least one of the following actions for the first UE RLC entity:
discard RLC SDU(s), RLC SDU segment(s), and RLC PDU(s), if any;
stop and reset timer(s), if running;
reset state variables to initial values.

In some implementations, the state variables and timer(s) are defined in a 3GPP specification (e.g., TS 38.322).

Otherwise, if the LTM DU configuration 1 does not include the RLC reestablishment indication for the first UE RLC entity, the UE 102 refrains from reestablishing the first UE RLC entity upon or when receiving the first LTM command. In other words, the UE 102 refrains from performing the actions for reestablishing the first UE RLC entity of the UE 102 upon or when receiving the first LTM command. In some implementations, if the LTM DU configuration 1 or element 1 does not include the RLC reestablishment indication and includes an indication indicating that the configuration 1 is a full configuration, the UE 102 may reestablish the first UE RLC entity of the UE 102 upon or when receiving the first LTM command. Otherwise, if the LTM DU configuration 1 or element 1 does not include the RLC reestablishment indication and the indication indicating that the configuration 1 is a full configuration, the UE 102 refrains from reestablishing the first UE RLC entity upon or when receiving the first LTM command.

Similarly, the DU 174 reestablishes some or all of at least one DU RLC entity (e.g., NR RLC 206B) that the DU 174 uses to communicate with the at least one UE RLC entity of the UE 102 (e.g., the events 302, 304, 318, 320, 324, 330, and/or 331) in response to the RLC reestablishment indication. In some implementations, the DU 174 reestablishes a first DU RLC entity of the at least one DU RLC entity after transmitting the first LTM command, receiving an acknowledgement for the first LTM command from the UE 102, or determining that the UE 102 connects to the first cell. In some implementations, the acknowledgement is a HARQ ACK. In other implementations, the acknowledgement is a MAC CE. In yet other implementations, the acknowledgement is a PUCCH transmission. In some implementations, when the base station 104 reestablishes the first DU RLC entity, the DU 174 performs at least one of the following actions for the first DU RLC entity:
discard RLC SDU(s), RLC SDU segment(s), and RLC PDU(s), if any;
stop and reset timer(s), if running;
reset state variables to initial values.

In some implementations, the state variables and timer(s) are defined in a 3GPP specification (e.g., TS 38.322).

In other implementations, the UE 102 refrains from reestablishing some or all of the at least one UE RLC entity in response to receiving the first LTM command. Similarly, the DU 174 refrains from reestablishing some or more of the at least one DU RLC entity after (e.g., in response to) transmitting the first LTM command, receiving the acknowledgement 331 or determining that the UE 102 connects to the first cell. In other words, the UE 102 communicates with the DU 174 on the first cell using the some or all of the at least one UE RLC entity (not reestablished). For example, the some or all of the at least one UE RLC entity includes the first UE RLC entity and/or a second UE RLC entity. Similarly, the DU 174 communicates with the UE 102 using the some or all of the at least one DU RLC entity (not reestablished) on the first cell during or after the random access procedure 332 or after determining that the UE 102 connects to the first cell. For example, the some or all of the at least one DU RLC entity includes the first DU RLC entity and/or a second DU RLC entity.

In some implementations, the UE 102 uses at least one UE PDCP entity (e.g., PDCP 210) to communicate UL PDCP PDUs and/or DL PDCP PDUs with at least one CU PDCP entity (e.g., PDCP 210) of the CU 172 in the event 302. In some implementations, the UE 102 performs a PDCP recovery procedure for some or all of the at least one UE PDCP entity, after or in response to receiving the first LTM command. For example, the UE 102 performs a PDCP recovery procedure for a first UE PDCP entity of the at least one UE PDCP entity, after or in response to receiving the first LTM command. In the PDCP recovery procedure, the UE 102 may or may not reestablish the first UE PDCP entity. After or in response to performing the PDCP recovery procedure, the UE 102 may retransmit at least a portion of the UL PDCP PDUs to the CU 172 via the DU 174 and the first cell in the event 336. Similarly, the CU 172 performs a PDCP recovery procedure for some or all of the at least one CU PDCP entity after or in response to transmitting the first LTM command. For example, the CU 172 performs a PDCP recovery procedure for a first CU PDCP entity of the at least one CU PDCP entity, after or in response to transmitting the first LTM command. In some implementations, the CU 172 performs the PDCP recovery procedure for the first CU PDCP entity in response to receiving the DU-to-CU message 329 or 334. In other implementations, the CU 172 performs the PDCP recovery procedure for the first CU PDCP entity in response to receiving the DL Data Delivery Status message. In the PDCP recovery procedure, the CU 172 may or may not reestablish the first CU PDCP entity. After or in response to performing the PDCP recovery procedure, the CU 172 may retransmit at least a portion of the DL PDCP PDUs to the UE 102 via the DU 174 and the first cell in the event 336.

In other implementations, the UE 102 refrains from reestablishing some or all of the at least one UE PDCP entity in response to receiving the first LTM command. For example, the some or all of the at least one UE PDCP entity includes the first UE PDCP entity and/or a second UE PDCP entity. Similarly, the CU 172 refrains from reestablishing some or more of the at least one CU PDCP entity, after (e.g., in response to) receiving the DU-to-CU message 329 or 340 or after (e.g., in response to) receiving the DL Data Delivery Status message. In other words, the UE 102 communicates with the CU 172 via the DU 174 and the first cell using the some or all of the at least one UE PDCP entity (not reestablished). For example, the some or all of the at least one UE PDCP entity includes the first UE PDCP entity and/or a second UE PDCP entity. Similarly, the CU 172 communicates with the UE 102 using the some or all of the at least one CU PDCP entity (not reestablished) via the DU 174 and the first cell. For example, the some or all of the at least one CU PDCP entity includes the first CU PDCP entity and/or a second CU PDCP entity.

In some implementations, after determining that the UE 102 connects to the first cell, the CU 172 may transmit 338 a CU-to-DU message (e.g., a UE Context Modification Request message) to the DU 174 to indicate the DU 174 to stop communicating with the UE 102 and/or to release or suspend resources, of the cell 124A, configured for the UE 102. In response, the DU 174 may stop communicating on the cell 124A with the UE 102 and/or release or suspend resources, of the cell 124A, configured for the UE 102, and transmit 340 a DU-to-CU message (e.g., a UE Context Modification Response message) to the CU-172. The events 338 (optional) and 340 (optional) are collectively referred to in FIG. 3 as a resource release procedure 396.

After or while communicating with the DU 174 on the first cell, events 344, 346, 348, 350, 351, 352, 354, and/or 356 may occur, similar to the events 324, 326, 328, 330, 331, 332, 334, and/or 336, respectively. The UE 102 transmits 344 at least one measurement report to the DU 174. The at least one measurement report includes at least one measurement result for a second cell (i.e., the cell 2). The at least one measurement result indicates that the second cell is suitable for communication with UE 102 and/or the first cell is not suitable for communication with the UE 102. After (e.g., in response to) receiving the at least one measurement report, the DU 174 determines to activate the LTM DU configuration 2 and generates a second LTM command to activate the LTM DU configuration 2 (i.e., the second LTM command commands the UE 102 to apply the LTM DU configuration 2). The DU 174 then transmits 350 the second LTM command to the UE 102 on the first cell.

When or in response to determining to activate the LTM DU configuration 2 or to transmit the second LTM command, the DU 174 may transmit 349 to the CU 172 a DU-to-CU message indicating LTM (being) executed. In some implementations, the DU 174 includes the cell ID 2 or the ID 2 (i.e., LTM ID) in the DU-to-CU message 349 to indicate that the DU 174 is to activate the LTM DU configuration 2. The DU may transmit the DU-to-CU message 349 to the CU 172 before or after transmitting the LTM command 350.

The descriptions for the events 324, 326, 328, 330, 331, 332, 334, and/or 336 may be applied to the events 344, 346, 348, 350, 351, 352, 354, and/or 356 with simple changes. For example, “cell 124A”, “first LTM command”, “first cell”, “ID 1”, “LTM DU configuration 1”, and/or “LTM CU configuration 1” are replaced with “first cell”, “second LTM command” and “second cell”, “ID 2”, “LTM DU configuration 2”, and/or “LTM CU configuration 2”, respectively.

The events 344, 346, 348, 350, 351, 352, 354 are collectively referred to in FIG. 3 as an LTM execution procedure 398. The events 304, 306, 390, 392, 394, 324, 326, 328, 329, 330, 331, 332, 334, 336, 396, 398, 356 are collectively referred to in FIG. 3 as a LTM DU configuration and/or activation procedure 380.

Referring next to FIG. 4, in a scenario 400, the base station 104 includes a CU 172, a source DU (S-DU) 174A and a target DU (T-DU) 174B. The S-DU 174A operates the cell 124A and optionally additional cell(s), while the T-DU 174B operates a first cell (e.g., cell 124C). The scenario 400 is similar to the scenario 300. Thus, the descriptions for the scenario 300 may generally apply to the scenario 400. Note that events 446, 448, 449, 450 and 451 in FIG. 4 are the same as steps events 346, 348, 349, 350 and 351 in FIG. 3 with T-DU 174B in FIG. 4 operating as DU 174 in FIG. 3. The differences between the scenarios 300 and 400 are described below.

Initially, the UE 102 communicates 402 with the S-DU 174A on cell 124A using a serving DU configuration and communicates with the CU 172 via the S-DU 174A. During the communication 402, the UE 102 transmits 404, 406 at least one measurement report (e.g., L3 measurement report(s)) to the CU 172 via the S-DU 174A. Based on the at least one measurement report, the CU 172 determines to prepare cell(s) 1, . . . , N (operated by the T-DU 174B) for LTM for the UE 102, where N is a positive integer larger than 1. The cell(s) 1, . . . , N are identified by cell ID(s) 1, . . . , N, respectively. In response to the determination, the CU 172 performs 490 a LTM preparation procedure with the T-DU 174B to (request the T-DU 174B to) prepare cell(s) 1, . . . , N for LTM for the UE 102. N may be a positive integer larger than zero or 1. In the LTM preparation procedure 490, the CU 172 transmits a CU-to-DU message including the cell ID(s) 1, . . . , N to the T-DU 174B to request the T-DU 174B to prepare the cell(s) 1, . . . , N for LTM for the UE 102, similar to the event 308. In response, the T-DU 174B transmits a DU-to-DU message including the LTM DU configuration(s) 1, . . . , N to the CU 172, similar to the event 310. The LTM DU configuration(s) 1, . . . , N configures the cell(s) 1, . . . , N for LTM, respectively. In details, the LTM DU configuration(s) 1, . . . , N include configuration parameters for communication on the cell(s) 1, . . . , N, respectively. In some implementations, the CU-to-DU message and DU-to-CU message in the procedure 490 are a UE Context Setup Request message and a UE Context Setup Response message, respectively. The CU 172 then transmits the LTM DU configuration(s) 1, . . . , N in a RRC reconfiguration message in a LTM configuration delivery procedure 494, similar to the LTM configuration delivery procedure 394. In some implementations, the T-DU 174B may include cell index(es) 1, . . . , N in the LTM DU configuration(s) 1, . . . , N, respectively. In some implementations, the CU 172 may set the cell index(es) 1, . . . , N to different values and include the cell index(es) 1, . . . , N in the CU-to-DU message of the procedure 490.

After performing the LTM preparation procedure 490, the CU 172 may perform an additional LTM preparation procedure(s) with the T-DU 174B to prepare cell(s) N+1, . . . , N+M for LTM for the UE 102. M is a positive integer larger than zero. The CU 172 may determine to do so based on one or more measurement reports received from the UE 102 via the S-DU 174A, similar to the events 404, 406. In the additional LTM preparation procedure, the CU 172 transmits a CU-to-DU message including cell ID(s) N+1, . . . , N+M to the T-DU 174B to request the T-DU 174B to prepare the cell(s) N+1, . . . , N+M for LTM for the UE 102. The cell ID(s) N+1, . . . , N+M identifies the cell ID(s) N+1, . . . , N+M, respectively. In response to the CU-to-DU message, the T-DU 174B transmits a DU-to-DU message including the LTM DU configuration(s) N+1, . . . , N+M to the CU 172. The LTM DU configuration(s) N+1, . . . , N+M configures the cell(s) N+1, ..., N+M for LTM, respectively. The LTM DU configuration(s) N+1, . . . , N+M include configuration parameters for communication on the cell(s) N+1, . . . , N+M, respectively. The CU 172 then transmits the LTM DU configuration(s) N+1, . . . , N+M in a RRC reconfiguration message in an additional LTM configuration delivery procedure, similar to the LTM configuration delivery procedure 394 or 494.

In some implementations, the LTM preparation procedure 490 is a UE Context Setup procedure and the additional LTM preparation procedure is a UE Context Modification procedure.

In some implementations, the CU 172 and S-DU 174A may perform the procedure 380 with the UE 102, as described for FIG. 3. In the procedure 380, the CU 172 and S-DU 174A performs the procedure(s) 390 and/or 392 to prepare cell(s) of the S-DU 174A for LTM for the UE 102. Note, the value N in the procedure 380 or described for FIG. 3 may be the same as or different from the value N described for FIG. 4. In the procedure 390, the CU 172 may receive the first DU-to-CU message including the reference LTM DU configuration from the S-DU 174A in the event 310. In other implementations, the CU 172 and S-DU 174A do not perform the procedure 380 with the UE 102. In such cases, the CU 172 may perform 488 a reference LTM DU configuration query procedure with the S-DU 174A to obtain a reference LTM DU configuration. In the procedure 488, the CU 172 transmits 460 a CU-to-DU message to the S-DU 174A to request or query a reference LTM DU configuration. In some implementations, the CU 172 may include an indication in the CU-to-DU message to request or query a reference LTM DU configuration. In response to the indication or CU-to-DU message 460, the S-DU 174A transmits 462 a DU-to-CU message including a reference LTM DU configuration to the CU 172. In some implementations, the indication is a reference LTM DU configuration query indication. In other implementations, the indication is a LTM indication, and the CU 172 may include a query indication (e.g., GNB-DU Configuration Query IE) in the CU-to-DU message. After receiving the reference LTM DU configuration (i.e., either in the procedure 390 or in the procedure 488), the CU 172 includes the reference LTM DU configuration (received from the S-DU 174A) in the CU-to-DU message in the LTM preparation procedure 490. The T-DU 174B generates the LTM DU configuration(s) 1, . . . , N based on the reference LTM DU configuration received from the CU 172. In such cases, the T-DU 174B does not include a reference LTM DU configuration in the DU-to-CU message in the procedure 490. In the case of the additional LTM preparation procedure, the T-DU 174B does not include a reference LTM DU configuration in the DU-to-CU message in the additional LTM preparation procedure. The CU 172 may not include the reference LTM DU configuration in CU-to-DU message in the additional LTM preparation procedure with the T-DU 174B. In the case of the additional LTM preparation procedure, the T-DU 174B generates the LTM DU configuration(s) N+1, . . . , N+M based on the reference LTM DU configuration received from the CU 172.

In some implementations, the CU 172 does not provide a reference LTM DU configuration to the T-DU 174B in the LTM preparation procedure 490. In such cases, the T-DU 174B generates a reference LTM DU configuration and generates the LTM DU configuration(s) 1, . . . , N based on the reference LTM DU configuration. In such cases, the T-DU 174B includes the reference LTM DU configuration in the DU-to-CU message in the procedure 490. The CU 172 transmits the reference LTM DU configuration in the RRC reconfiguration message in the procedure 490. In the case of the additional LTM preparation procedure, the T-DU 174B generates the LTM DU configuration(s) N+1, . . . , N+M based on the reference LTM DU configuration. In this case, the T-DU 174B may not include the reference LTM DU configuration in the DU-to-CU message in the additional LTM preparation procedure. In some implementations, the reference LTM DU configuration generated by the T-DU 174B is different from the reference LTM DU configuration generated by the S-DU 174A. In other implementations, the reference LTM DU configuration generated by the T-DU 174B is the same as the reference LTM DU configuration generated by the S-DU 174A.

In some implementations, the CU 172 assigns ID(s) 1, . . . , N identifying the LTM DU configuration(s) 1, . . . , N (received from the T-DU 174B), respectively, and performs the procedure 492 with the T-DU 174B to provide the ID(s) 1, . . . , N and/or cell ID(s) 1, . . . , N to the T-DU 174B, similar to the procedure 392. Thus, the T-DU 174B associates the ID(s) 1, . . . , N with the LTM DU configuration(s) 1, . . . , N and/or the cell ID(s) 1, . . . , N, respectively. In other implementations, the T-DU 174B assigns ID(s) 1, . . . , N identifying the LTM DU configuration(s) 1, . . . , N (generated by the T-DU 174B), respectively and includes the ID(s) 1, . . . , N in the DU-to-CU message of the procedure 490, similar to the event 310. In some implementations, the CU 172 assigns ID(s) N+1, . . . , N+M identifying the LTM DU configuration(s) N+1, . . . , N+M, respectively, and performs a procedure (similar to the procedure 492) with the T-DU 174B to provide the ID(s) N+1, . . . , N+M and/or cell ID(s) N+1, . . . , N+M to the T-DU 174B, similar to the procedure 392. Thus, the T-DU 174B associates the ID(s) N+1, . . . , N+M with the LTM DU configuration(s) N+1, . . . , N+M and/or the cell ID(s) N+1, . . . , N+M, respectively. In other implementations, the T-DU 174B assigns ID(s) N+1, . . . , N+M identifying the LTM DU configuration(s) N+1, . . . , N+M, respectively and includes the ID(s) 1, . . . , N in the DU-to-CU message of the additional LTM preparation procedure, similar to the event 310.

In some implementations, the CU 172 transmits 412 a CU-to-DU message including the ID(s) 1, . . . , N to the S-DU 174A and receives 414 a DU-to-CU message from the S-DU 174A in response. The CU-to-DU message 412 and DU-to-CU message 414 are collectively referred to in FIG. 4 as a LTM ID transfer procedure 493 or a LTM cell index transfer procedure 493. In some implementations, the message 412 and message 414 may be a UE Context Modification Request message and a UE Context Modification Response message, respectively. In some implementations, the CU 172 includes the LTM DU configuration(s) 1, . . . , N and/or cell ID(s) 1, . . . , N in the CU-to-DU message 412. In one implementation, the CU 172 includes the ID(s) 1, . . . , N in the CU-to-DU message 412. In another implementation, the CU 172 includes the cell index(es) 1, . . . , N in the CU-to-DU message 412. In some alternative implementations, the CU 172 may perform multiple LTM ID transfer procedures to transmit the ID(s) 1, . . . , N, cell ID(s) 1, . . . , N and/or LTM DU configuration(s) 1, . . . , N to the S-DU 174A. In each of the procedures, the CU 172 includes particular portion of the ID(s) 1, . . . , N, cell ID(s) 1, . . . , N and/or LTM DU configuration(s) 1, . . . , N in a CU-to-DU message similar to the message 412. Thus, the S-DU 174A associates the ID(s) 1, . . . , N with the LTM DU configuration(s) 1, . . . , N and/or the cell ID(s) 1, . . . , N, respectively. In other alternative implementations, the CU 172 may perform multiple LTM cell index transfer procedures to transmit the cell index(es) 1, . . . , N, cell ID(s) 1, . . . , N and/or LTM DU configuration(s) 1, . . . , N to the S-DU 174A. In each of the procedures, the CU 172 includes a subset of the cell index(es) 1, . . . , N, cell ID(s) 1, . . . , N and/or LTM DU configuration(s) 1, . . . , N in a CU-to-DU message similar to the message 412. Thus, the S-DU 174A associates the cell index(es) 1, . . . , N with the LTM DU configuration(s) 1, . . . , N and/or the cell ID(s) 1, . . . , N, respectively.

In some implementations, the CU 172 transmits a CU-to-DU message including the ID(s) N+1, . . . , N+M to the S-DU 174A and receives a DU-to-CU message from the S-DU 174A in response, similar to the CU-to-DU message 412 and the DU-to-CU message 414, respectively. In some implementations, the CU 172 includes the LTM DU configuration(s) N+1, . . . , N+M and/or cell ID(s) N+1, . . . , N+M in the CU-to-DU message. In some alternative implementations, the CU 172 may perform multiple LTM ID transfer procedures to transmit the ID(s) N+1, . . . , N+M, cell ID(s) N+1, . . . , N+M and/or LTM DU configuration(s) N+1, . . . , N+M to the S-DU 174A. In each of the procedures, the CU 172 includes a subset of the ID(s) N+1, . . . , N+M, cell ID(s) N+1, . . . , N+M and/or LTM DU configuration(s) 1, . . . , N in a CU-to-DU message similar to the message 412. Thus, the S-DU 174A associates the ID(s) N+1, . . . , N+M with the LTM DU configuration(s) N+1, . . . , N+M and/or the cell ID(s) N+1, . . . , N+M, respectively.

In some implementations, in the case that the CU 172 and S-DU 174A perform the procedure 380 with the UE 102, value(s) of the ID(s) 1, . . . , N of the procedure 380 are different from value(s) of the ID(s) 1, . . . , N, and the ID(s) N+1, N+M described for the scenario 400. In some implementations, in the case that the CU 172 and S-DU 174A perform the procedure 380 with the UE 102, value(s) of the cell ID(s) 1, . . . , N of the procedure 380 are different from value(s) of the cell ID(s) 1, . . . , N, and the cell ID(s) N+1, . . . , N+M described for the scenario 400. In some implementations, in the case that the CU 172 and S-DU 174A perform the procedure 380 with the UE 102, value(s) of the cell index(es) 1, . . . , N of the procedure 380 are different from value(s) of the cell index(es) 1, . . . , N, and the cell index(es) N+1, . . . , N+M described for the scenario 400.

Later in time, the UE 102 may transmit 424 at least one measurement report to the S-DU 174A, similar to the event 324. The at least one measurement report (e.g., L1 measurement report(s)) includes an event ID, first measurement result(s) for the cell 1 of the T-DU 174B, and/or includes second measurement result(s) for the cell 124A. In some implementations, the first measurement result(s) may be or may include RSRP, RSRQ, and/or SINR that the UE 102 obtains from reference signal(s) transmitted on the cell 1.Likewise, the second measurement result(s) may be or may include RSRP, RSRQ, and/or SINR that the UE 102 obtains from reference signal(s) transmitted on the cell 124A. In some implementations, the event ID, RSRP, RSRQ, and/or SINR are L1-event ID, L1-RSRP, L1-RSRQ, and/or L1-SINR, respectively. Based on the first measurement result(s) and/or second measurement result(s), the S-DU 174A may transmit 430 a first LTM command (i.e., LTM command 1) including the ID 1 to the UE 102 to order the UE 102 to perform a serving cell change to the cell 1 of the T-DU 174B. In some implementations, the first LTM command includes the ID 1. In other implementations, the first LTM command includes the cell index 1. When the UE 102 receives the first LTM command, the UE 102 performs a serving cell change to the cell 1 from a serving cell in accordance with the LTM DU configuration 1. After (e.g., in response to) receiving the first LTM command, the UE 102 may or may not perform 432 a random access procedure with the T-DU 174B, similar to the event 332. After (e.g., in response to) receiving the first LTM command or completing the random access procedure 432, the UE 102 may communicate 436 with the T-DU 174B on the first cell using the LTM DU configuration 1 and/or reference LTM DU configuration and communicates with the CU 172 via the T-DU 174B, similar to the event 336. If a serving cell change occurs in the procedure 380, the serving cell may be the cell 1 or cell 2 of the S-DU 174A. Otherwise, if no serving cell change occurs in the procedure 380 or the procedure 380 is not performed, the serving cell is the cell 124A. If the first LTM command includes the ID 1, the UE 102 identifies the LTM DU configuration 1 and/or cell ID 1 (i.e., the cell 1), based the ID 1, as described for FIG. 3. If the first LTM command includes the cell index 1, the UE 102 identifies the LTM DU configuration 1, cell ID 1 (i.e., the cell 1), and/or LTM ID 1, based the cell index 1, as described for FIG. 3. The UE 102 applies the LTM DU configuration 1 to communicate with the T-DU 174B, after (e.g., in response to) receiving the first LTM command or successfully accessing the cell 1.

When or in response to determining to activate the LTM DU configuration 1 or to transmit the first LTM command 430, the S-DU 174A may transmit 429 to the CU 172 a DU-to-CU message indicating LTM (being) executed. In some implementations, the S-DU 174A includes the cell ID 1 or the ID 1 (i.e., LTM ID) in the DU-to-CU message 429 to indicate that the S-DU 174A is to activate the LTM DU configuration 1 or trigger a fast serving cell change. The S-DU 174A may transmit the DU-to-CU message 429 to the CU 172 before or after transmitting the LTM command 430. In some implementations, when or after the CU 172 receives the DU-to-CU message 429, the CU 172 may stop or suspend transmitting DL data for the UE 102 to the S-DU 174A until receiving the DU-to-CU message 434. After receiving the DU-to-CU message 434, the CU 172 starts, continues or resumes transmitting DL data for the UE 102 to the T-DU 174B. When or after the T-DU 174B detects that UE 102 accesses the cell 1, the T-DU 174B transmits the DL data to the UE 102 via the cell 1.

The resource release procedure 496 may be similar to the procedure 396. Alternatively, in the resource release procedure 496, the CU 172 may transmit a CU-to-DU message (e.g., a UE Context Release Command message) to the S-DU 174A to release a UE context of the UE 102. In response, the S-DU 174A releases a UE context of the UE 102 and transmits 440 a DU-to-CU message (e.g., a UE Context Release Complete message) to the CU-172.

The events 380, 404, 406, 490, 492, 493, 494, 424, 426, 428, 429, 430, 431, 432, 434, 436, 496, 498, 456 are collectively referred to in FIG. 4 as a LTM configuration and/or activation procedure 480.

Referring next to FIG. 5A, in a scenario 500A, the base station 106 operates as an MN, and the base station 104 operates as an SN. The SN 104 includes a CU 172 and a DU 174. The scenario 500A is similar to the scenario 300, except that the scenario 500A is a dual connectivity, DC, scenario and the scenario 300 is a single connectivity, SC, scenario. The MN 106 may include a CU and a DU similar to the base station 104 of FIG. 3.

Initially, the UE 102 in DC communicates with the MN 106 and with SN 104. In the event 502, the UE 102 communicates with the DU 174 on cell 124A using a serving DU configuration and communicates with the CU 172 via the DU 174 using a serving CU configuration, similar to the event 302. In some alternative implementations, the UE 102 does not communicate with the CU 172 via the DU 174 in the event 302. In some implementations, the UE 102 in DC may communicate 502 UL PDUs and/or DL PDUs with the MN 106 and/or SN 104 via radio bearers which may include SRBs and/or DRB(s). The MN 106 and/or the SN 104 may configure the radio bearers to the UE 102. The UE 102 in DC communicates 502 UL PDUs and/or DL PDUs with the SN 104 on an SCG (i.e., SCG radio resources) that the SN 104 configures for communication with the UE 102. The UE 102 in DC communicates UL PDUs and/or DL PDUs with the MN 106 on an MCG (i.e., MCG radio resources) in accordance with a MN configuration (i.e., MCG configuration). In some implementations, the serving DU configuration is a SN configuration (i.e., SCG configuration). In the MN configuration, the MN 106 configures the MCG which includes at least one serving cell (e.g., the cell 126 and/or other cell(s)) operated by the MN 106. In the serving DU configuration, the SN 106A configures the SCG which includes at least one serving cell (e.g., the cell 124A and/or other cell(s)) operated by the SN 104. In some implementations, the MN configuration includes multiple configuration parameters, and the UE 102 receives the configuration parameters in one or more RRC messages from the MN 106. As described for FIG. 3, the serving DU configuration includes multiple configuration parameters. In some implementations, the UE 102 receives these configuration parameters in one or more RRC messages from the SN 104, e.g., via the MN 106 and/or on an SRB (e.g., SRB3) that the MN 106 or SN 104 configures to exchange RRC messages between the UE 102 and the SN 104.

While the UE 102 communicates in DC with the MN 106 and SN 104, the MN 106 may perform 580 a LTM DU configuration and/or activation procedure with the UE 102, similar to the procedures 380 and/or 480. In some implementations, while communicating in DC with the MN 106 and SN 104, the UE 102 may transmit the at least one measurement report to the CU 172 via the DU 174 and cell 124A in the events 504 and 506, similar to the events 304 and 306, respectively. In other implementations, while communicating in DC with the MN 106 and SN 104, the UE 102 may transmit 505 at least one measurement report to the MN 106 via the cell 126. The MN 106 in turn transmits 507 the at least one measurement report to the CU 172. In some implementations, the MN 106 generates at least one SN message including the at least one measurement report and transmits the at least one SN message to the CU 172 in the event 507. In one implementation, the at least one SN message includes an RRC Transfer message(s) and/or an SN Modification Request message(s).

After (e.g., in response to) receiving the at least one measurement report or while the SN 104 communicates with the UE 102, the SN 104 determines to prepare the first cell for the UE 102, as described relative to FIG. 3. The events 590, 592, 594, 524, 526, 528, 529, 530, 531, 532, 534, 536, 596, 598, and 556 are similar to the events 390, 392, 394, 324, 326, 328, 329, 330, 331, 332, 334, 336, 396, 398, and 356, respectively. After receiving the first LTM command 530, transmitting the acknowledgement 531, or determining that the UE 102 successfully connects to the first cell 532 or 536, the UE 102 operating in DC with the MN 106 and SN 104 communicates 536 with the DU 174 on the first cell in accordance with the LTM DU configuration 1 and communicates 536 with the CU 172 via the DU 174, similar to the event 336. Later in time, the DU 174 and/or CU 172 may perform the LTM execution procedure 598 with the UE 102 to command the UE 102 to perform a cell change from the first cell to the second cell, similar to the procedure 398 or 498. As a result of the procedure 598, the UE 102 operating in DC with the MN 106 and SN 104 communicates 556 with the DU 174 on the second cell in accordance with the LTM DU configuration 2 and communicates 556 with the CU 172 via the DU 174, similar to the event 356.

The events 504, 506, 505, 507, 590, 592, 594, 524, 526, 528, 529, 530, 531, 532, 534, 536, 596, 598, 556 are collectively referred to in FIG. 5A as a LTM DU configuration and/or activation procedure 581.

Referring next to FIG. 5B, a scenario 500B is generally similar to the scenario 500A, except that the SN 104 transmits 517, 519 the RRC reconfiguration message to the UE 102 via the MN 106 and receives 521, 523 the RRC reconfiguration complete message from the UE 102 via the MN 106. The RRC reconfiguration message 517, 519 is similar to the RRC reconfiguration message 316, 318. The RRC reconfiguration complete messages 521 and 523 are similar to the RRC reconfiguration message 320 and 322. In some implementations, the SN 104 generates a first SN message (e.g., SN Modification Required message, SN Modification Required message, or RRC Transfer message) including the RRC reconfiguration message and transmits the first SN message to the MN 106 in the event 517. The MN 106 generates a MN RRC message including the RRC reconfiguration message and transmits 519 the MN RRC message to the UE 102. In response, the UE 102 generates a MN RRC response message including the RRC reconfiguration complete message and transmits 521 the MN RRC response message to the MN 106. In some implementations, the MN 106 generates a second SN message (e.g., SN Reconfiguration Complete message or RRC Transfer message) including the RRC reconfiguration complete message and transmits the second SN message to the SN 104 in the event 523. In some implementations, the MN RRC message and MN RRC response message may be a RRC reconfiguration message and a RRC reconfiguration complete message, respectively.

The events 504, 506, 505, 507, 590, 592, 517, 519, 521, 523, 524, 526, 528, 529, 530, 531, 532, 534, 536, 596, 598, 556 are collectively referred to in FIG. 5B as a LTM DU configuration and/or activation procedure 582.

Referring next to FIG. 6A, in a scenario 600A, the base station 106 operates as an MN, and the base station 104 operates as an SN, similar to the scenarios 300-500B. The SN 104 includes a CU 172, an S-DU 174A and a T-DU 174B, similar to the base station 104 in the scenario 400. While the UE 102 communicates in DC with the MN 106 and SN 104, the MN 106 may perform 680 a LTM DU configuration and/or activation procedure with the UE 102, similar to the procedures 380 and/or 480. While the UE 102 communicates in DC with the MN 106 and the S-DU 174A, the CU 172 may perform 681 a LTM DU configuration and/or activation procedure with the UE 102 via the MN 106 or S-DU 174A, similar to the procedure 581 or 582. UE 102 sends a measurement report 604 to MN 106 and/or 605 to S-DU 174A, either of which or both then forwarding 606 and/or 607 the measurement report to CU 172. The events 688, 690, 692, 693, 694, 626, 628, 629, 630, and 631 in FIGS. 6A and 6B are similar with are similar to the events 488, 490, 492, 493, 494, 426, 428, 429, 430, and 431 in FIG. 4.

Referring next to FIG. 6B, a scenario 600B similar to the scenarios 300-500B and 600A, except that that the SN 104 transmits 617, 619 the RRC reconfiguration message to the UE 102 via the MN 106 and receives 621, 623 the RRC reconfiguration complete message from the UE 102 via the MN 106.

Referring next to FIG. 7A, in a scenario 700A, the base station 104 operates as an MN and an SN, similar to the scenarios 300-600B. The base station 104 includes a CU 172, a master DU (M-DU) 174A and a secondary DU (S-DU) 174B. The CU 172 operates with the M-DU 174A as a MN, similar to the base station 104 in the FIG. 3 or the MN 106 in FIGS. 5A-6B, and the CU 172 operates with the S-DU 174B as a SN, similar to the SN 104 in FIGS. 5A-6B.

In the scenario 700A, the UE 102 initially communicates 702 in DC with the M-DU 174A and S-DU 174B and communicates 702 with the CU 172 via the M-DU 174A and S-DU 174B. In the event 702, the UE 102 communicates with the S-DU 174B on cell 124A using a serving DU configuration and communicates with the CU 172 via the S-DU 174B using a serving CU configuration, similar to the event 302. Events 704 and 706 are similar to the events 304 and 306. In some implementations, the UE 102 may transmit 705 at least one measurement report to the M-DU 174A, similar to the event 304. The M-DU 174A in turn transmits 707 at least one DU-to-CU message including the at least one measurement report to the CU 172, similar to the event 306. While the UE 102 communicates in DC with the M-DU 174A and S-DU 174B, the CU 172 may perform 780 a LTM DU configuration and/or activation procedure with the UE 102 via the M-DU 174A, similar to the procedure 380.

The events 704, 706, 705, 707, 790, 792, 794, 724, 726, 728, 729, 730, 731, 732, 734, 736, 796, 798, 756 in FIG. 7A may be collectively referred to as a second LTM configuration and/or activation procedure following the first LTM configuration and/or activation procedure 780.

Referring next to FIG. 7B, a scenario 700B similar to the scenarios 300-600B and 700A, except that that the CU 172 transmits 717, 719 the RRC reconfiguration message to the UE 102 via the M-DU 174A and receives 721, 723 the RRC reconfiguration complete message from the UE 102 via the M-DU 174A.

The events 704, 706, 705, 707, 790, 792, 794, 717, 719, 721, 723, 724, 726, 728, 729, 730, 731, 732, 734, 736, 796, 798, 756 in FIG. 7B may be collectively referred to as a second LTM DU configuration and/or activation procedure following the first LTM configuration and/or activation procedure 780.

Referring next to FIG. 8A, in a scenario 800A, the base station 104 operates as an MN and an SN, similar to the scenarios 300-700B. The base station 104 includes a CU 172, a master DU (M-DU) 174A, a secondary DU (S-DU) 174B and a target secondary DU (T-DU) 174C. The CU 172 operates with the M-DU 174A as a MN and operates with the S-DU 174B as an SN. While the UE 102 communicates in DC with the M-DU 174A and S-DU 174B, the CU 172 may perform 880 a LTM DU configuration and/or activation procedure with the UE 102 via the M-DU 174A, similar to the procedure 380. While the UE 102 communicates in DC with the M-DU 174A and S-DU 174B, the CU 172 may perform 881 a LTM DU configuration and/or activation procedure with the UE 102 via the S-DU 174A, similar to the procedure 581 or 582. At 804 and/or 805, the UE 102 transmits the measurement report to S-DU 174B and M-DU 174A respectively, either of which or both then forwarding 806 and/or 807 the measurement report to CU 172. The events 888, 890, 892, 893, 894, 826, 828, 829, 830, and 831 in FIGS. 8A and 8B are similar with are similar to the events 488, 490, 492, 493, 494, 426, 428, 429, 430, and 431 in FIG. 4.

Referring next to FIG. 8B, a scenario 800B similar to the scenarios 300-700B and 800A, except that that the CU 172 transmits 817, 819 the RRC reconfiguration message to the UE 102 via the M-DU 174A and receives 821, 823 the RRC reconfiguration complete message from the UE 102 via the M-DU 174A.

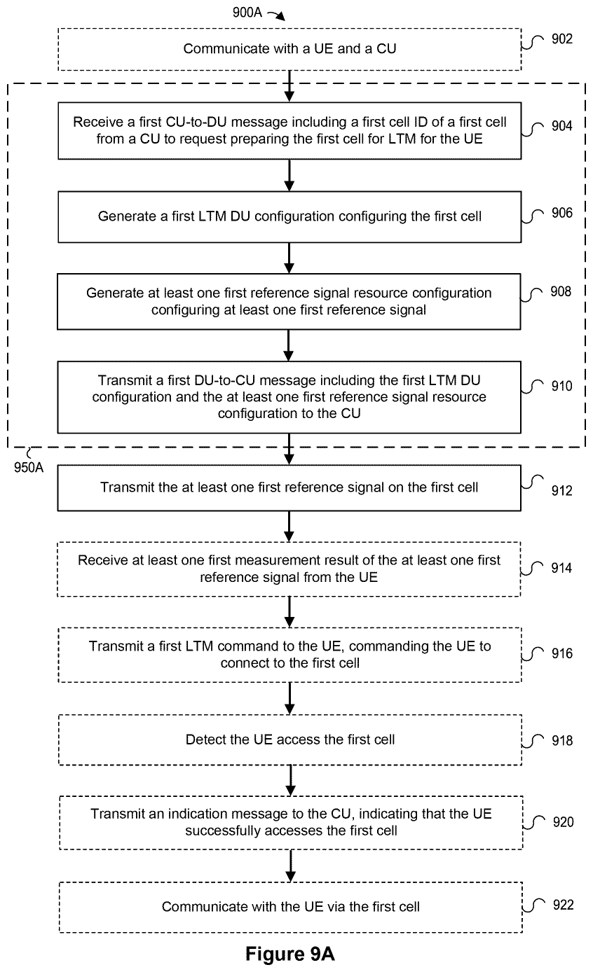

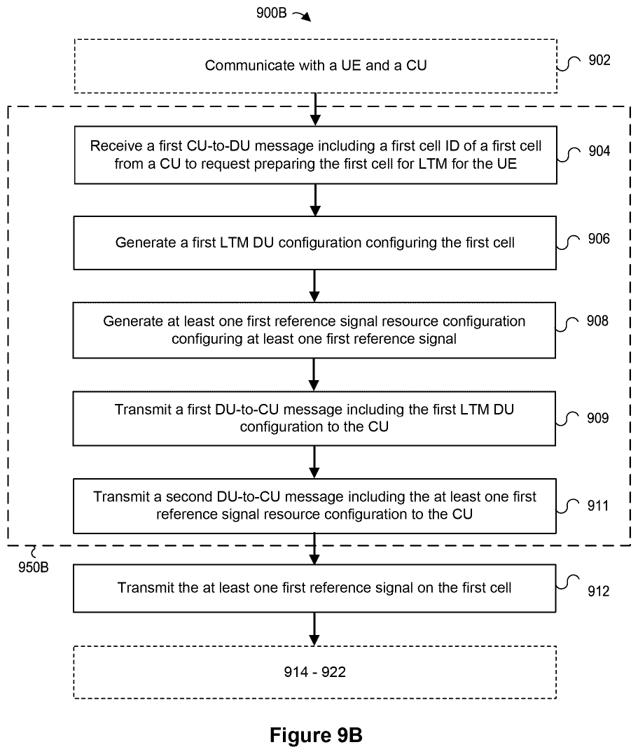

Next, several example methods, which may be implemented in a RAN node such as a DU or a CU to support configuring necessary configurations for enabling LTM, are discussed next with reference to FIGS. 9A-13. Examples and implementations described for FIGS. 3-8B may apply to FIGS. 9A-13.

FIG. 9A illustrates an example method 900A, which may be implemented by a DU (e.g., the DU 174, 174A, 174B or 174C of the base station 104 or 106 in FIGS. 3-8B), for enabling LTM for a UE (e.g., the UE 102).

The method 900A begins at block 902, where the DU communicates with the UE and a CU (e.g., events 302, 402, 502, 602, 702, 802, 380, 480, 580, 680, 780, 880, 581, 582, 681, 881). At block 904, the DU receives a first CU-to-DU message including a first cell ID of a first cell from a CU to request preparing the first cell for LTM for the UE (e.g., events 308, 390, 380, 490, 480, 580, 590, 581, 582, 680, 690, 681, 780, 790, 880, 890, 881). At block 906, the DU generates a first LTM DU configuration configuring the first cell. At block 908, the DU generates at least one first reference signal resource configuration configuring at least one first reference signal. In some implementations, the at least one first reference signal resource configuration configures resources of the at least one first reference signal. In some implementations, the at least one first reference signal includes one or more CSI-RSs, and/or one or more SSBs. At block 910, the DU transmits a first DU-to-CU message including the first LTM DU configuration and the at least one first reference signal resource configuration to the CU (e.g., events 310, 390, 380, 490, 480, 580, 590, 581, 582, 680, 690, 681, 780, 790, 880, 890, 881). Blocks 904, 906, 908, and 910 are grouped as block 950A.

In some implementations, the CU transmits the first LTM DU configuration and the at least one first reference signal resource configuration to the UE via the DU (e.g., events 318, 394, 380, 594, 580, 581, 780, 794). In other implementations, the CU transmits the first LTM DU configuration and the at least one first reference signal resource configuration to the UE via a RAN node (e.g., another DU, another CU or another base station) (e.g., events 494, 480, 517, 519, 582, 694, 680, 681, 617, 619, 717, 719, 894, 880, 881, 817, 819). For example, the CU transmits a RRC message (e.g., RRC reconfiguration message), including the first LTM DU configuration and the at least one first reference signal resource configuration, to the UE via the DU or the RAN node. In another example, the CU transmits a first RRC message and a second RRC message to the UE via the DU or the RAN node. The first RRC message includes the first LTM DU configuration, and the second RRC message includes the at least one first reference signal resource configuration. In some implementations, the first RRC message and the second RRC message are RRC reconfiguration messages.

In some implementations, the DU generates at least one first report configuration configuring radio resources (e.g., PUCCH resources or PUSCH resources) for reporting of measurement results of the at least one first reference signal. For example, the radio resources may be periodic or semi-persistent radio resources for the UE to periodically transmit one or some of the at least one first measurement result. In some implementations, the at least one first reporting configuration is similar to the L1 measurement report configuration(s) described above. The DU includes the at least one first report configuration in the first DU-to-CU message. In some implementations, the CU transmits the at least one first report configuration to the UE via the DU (e.g., events 316, 318, 394, 380, 594, 580, 581, 780, 794) or the RAN node (e.g., events 494, 480, 517, 519, 582, 694, 680, 681, 617, 619, 717, 719, 894, 880, 881, 817, 819). For example, the CU includes the at least one first report configuration in the RRC message, the first RRC message or the third RRC message. In another example, the CU transmits a third RRC message (e.g., a RRC reconfiguration message) including the at least one first report configuration to the UE via the DU or the RAN node. In some implementations, the DU at block 908 generates a first DU configuration (e.g., an RRC IE such as a CellGroupConfig IE) including the at least one first reference signal resource configuration and/or the at least one first report configuration. In such cases, the DU includes the first DU configuration in the first DU-to-CU message. In some implementations, the UE applies the first DU configuration immediately upon receiving the first DU configuration. In such cases, the DU applies the first DU configuration immediately upon transmitting the first DU configuration to the CU or the UE. In some implementations, the DU includes the first DU configuration in the second interface protocol IE/field in the DU-to-CU message. In some implementations, the second interface protocol IE/field is a DU to CR RRC Information IE/field or a CellGroupConfig IE/field in the DU to CR RRC Information IE/field.

In some implementations, after transmitting the at least one first reference signal resource configuration and the at least one first report configuration to the UE (e.g., via the CU), the DU transmits an activation command (e.g., a DCI) to the UE. In response to receiving the activation command, the UE starts transmitting one or more measurement results (e.g., including the at least one first measurement result) of the at least one first reference signal on the radio resources periodically. After transmitting the activation command, the DU starts receiving one or more measurement results (e.g., including the at least one first measurement result) of the at least one first reference signal on the radio resources periodically. In other implementations, the UE starts transmitting one or more measurement results (e.g., including the at least one first measurement result) of the at least one first reference signal upon receiving the at least one first reference signal resource configuration. After transmitting the at least one first reference signal resource configuration, the DU starts receiving one or more measurement results (e.g., including the at least one first measurement result) of the at least one first reference signal on the radio resources periodically.

At block 912, the DU transmits the at least one first reference signal on the first cell. In some implementations, the DU transmits the at least one first reference signal in accordance with the at least one first reference signal resource configuration.

For example, the DU transmits the at least one first reference signal on the resources configured in the at least one first reference signal resource configuration. At block 914, the DU receives at least one first measurement result of the at least one first reference signal from the UE (e.g., events 324, 344, 380, 398, 524, 580, 581, 598, 582, 724, 780, 798). At block 916, the DU transmits a first LTM command to the UE, commanding the UE to connect to the first cell. At block 918, the DU detects the UE access the first cell (e.g., events 332, 336, 352, 356, 380, 432, 436, 452, 456, 498, 480, 532, 536, 552, 598, 556, 580, 581, 582, 632, 636, 698, 656, 680, 681, 732, 736, 798, 756, 780, 832, 836, 898, 880, 881). At block 920, the DU transmits an indication message to the CU, indicating that the UE successfully accesses the first cell (e.g., events 334, 354, 380, 398, 434, 454, 498, 480, 534, 598, 580, 581, 582, 734, 798, 780, 834, 898, 880, 881).

At block 922, the DU communicates with the UE via the first cell (e.g., events 336, 356, 380, 436, 456, 480, 536, 556, 580, 581, 582, 636, 656, 680, 681, 736, 756, 780, 836, 856, 880, 881).

In some implementations, the DU transmits the first LTM command based on the at least one first measurement result. In some implementations, the DU performs filtering to the at least one first measurement result to obtain a filtered measurement result and transmits the first LTM command based on the filtered measurement result.

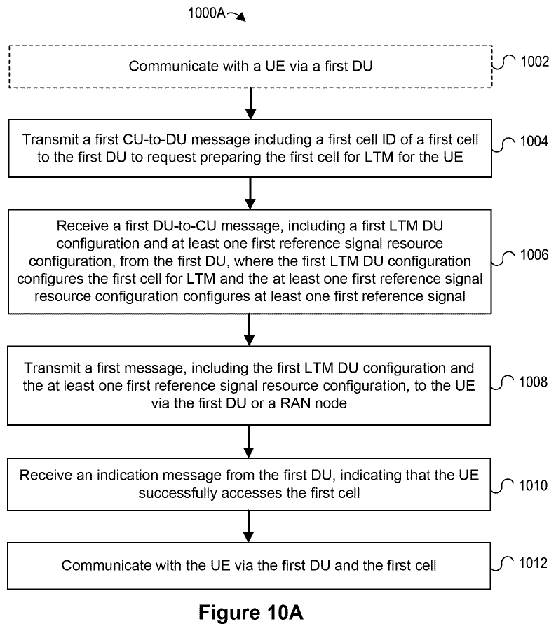

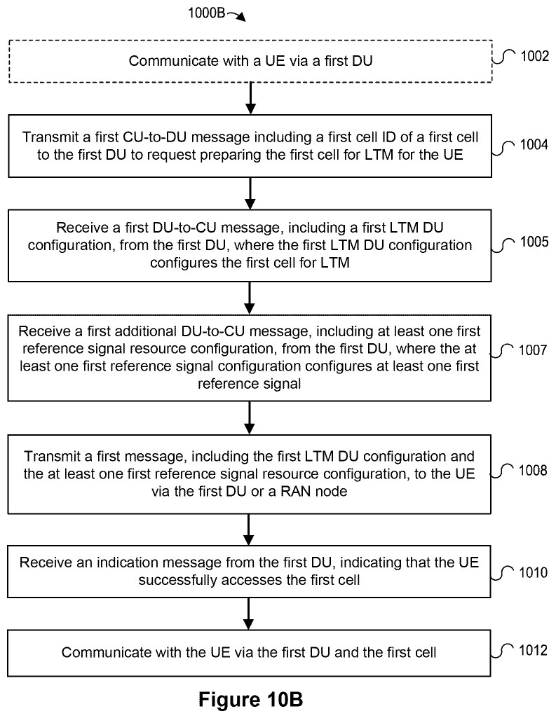

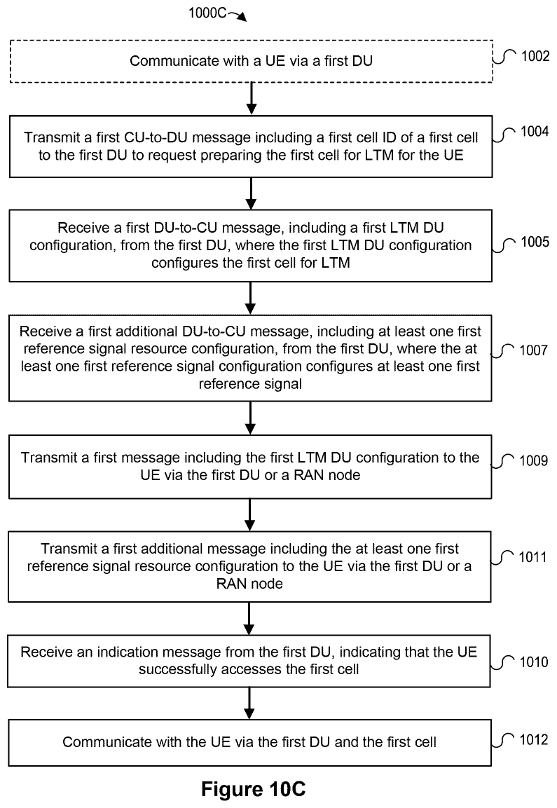

In some implementations, the DU includes the first LTM DU configuration in a first interface protocol IE or field (IE/field) in the first DU-to-CU message. In some implementations, the DU includes the at least one first reference signal resource configuration in a second interface protocol IE/field in the first DU-to-CU message. In some implementations, one of the first interface protocol IE/field and the second interface protocol IE/field is a CellGroupConfig IE/field and the other is different from the CellGroupConfig IE/field. In other implementations, one of the first interface protocol IE/field and the second interface protocol IE/field is a DU to CU RRC Information IE/field and the other is different from the DU to CU RRC Information IE/field. The DU includes the first LTM DU configuration and the at least one first reference signal resource configuration in the different interface protocol IEs/fields, so that the CU may retrieve or identifies the first LTM DU configuration and the at least one first reference signal resource configuration from the first interface protocol IE/field and the second interface protocol IE/field, respectively. Thus, the CU may properly transmit the first LTM DU configuration and the at least one first reference signal resource configuration to the UE as described for FIGS. 10A-10C.

In other implementations, the DU includes the first LTM DU configuration and the at least one first reference signal resource configuration in an interface protocol IE/field of the first DU-to-CU message. In some implementations, the DU includes the first LTM DU configuration and the at least one first reference signal resource configuration in a first child IE/field and a second child IE/field, respectively, and includes the first child IE/field and second IE/field in the interface protocol IE/field of the first DU-to-CU message. The DU includes the first LTM DU configuration and the at least one first reference signal resource configuration in the different child IEs/fields, so that the CU may retrieve or identifies the first LTM DU configuration and the at least one first reference signal resource configuration from the first child IE/field and the second child IE/field, respectively. Thus, the CU may properly transmit the first LTM DU configuration and the at least one first reference signal resource configuration to the UE as described for FIGS. 10A-10C.

In some implementations, the first CU-to-DU message and the first DU-to-CU message are a UE Context Setup Request message and a UE Context Setup Response message. In other implementations, the first CU-to-DU message and the first DU-to-CU message are a UE Context Modification Request message and a UE Context Modification Response message. In yet other implementations, the first CU-to-DU message and the first DU-to-CU message are a UE Context Modification Request message and a UE Context Modification Required message. In such cases, the DU transmits a UE Context Modification Response message to the CU in response to the UE Context Modification Request message, and the DU receives a UE Context Modification Confirm message from the CU in response to the UE Context Modification Required message.

In some implementations, the DU receives a second CU-to-DU message including a second cell ID of a second cell from the CU to request preparing the second cell for LTM for the UE (e.g., events 310, 390, 380, 490, 480, 580, 590, 581, 582, 680, 690, 681, 780, 790, 880, 890, 881). In such cases, the DU generates a second LTM DU configuration configuring the second cell and at least one second reference signal resource configuration configuring at least one first reference signal. The DU transmits a second DU-to-CU message including the second LTM DU configuration and the at least one second reference signal resource configuration to the CU (e.g., events 310, 390, 380, 490, 480, 580, 590, 581, 582, 680, 690, 681, 780, 790, 880, 890, 881). The DU transmits the at least one second reference signal on the second cell. In some implementations, the DU receives at least one second measurement result of the at least one second reference signal from the UE (e.g., events 324, 344, 380, 398, 424, 444, 480, 498, 524, 580, 581, 598, 582, 624, 680, 698, 681, 724, 780, 798, 880, 881, 824, 898).

In some implementations, the DU generates at least one second report configuration configuring radio resources (e.g., PUCCH resources or PUSCH resources) for reporting of measurement results of the at least one second reference signal. In some implementations, the DU receives the at least one second measurement result and the at least one first measurement result on the same radio resources (e.g., PUCCH resources or PUSCH resources) on the same slot or different slots. In other implementations, the DU receives the at least one second measurement result and the at least one first measurement result on different radio resources (e.g., PUCCH resources or PUSCH resources) on the same slot or different slots. In some implementations, the first CU-to-DU message and the second CU-to-DU message may be combined as a single CU-to-DU message, and the first DU-to-CU message and second DU-to-CU message may be combined as a single DU-to-CU message. Examples and implementations described for the first CU-to-DU message, the first DU-to-CU message, the at least one first reference signal resource configuration, and the at least one first report configuration may apply to the second CU-to-DU message, the second DU-to-CU message, the at least one second reference signal resource configuration, and the at least one second report configuration, respectively.

FIG. 9B is a flow diagram of an example method 900B similar to the method 900A, except that the method 900B includes blocks 909 and 911 instead of block 910. At block 909, the DU transmits a first DU-to-CU message including the first LTM DU configuration to the CU (e.g., events 310, 390, 380, 490, 480, 580, 590, 581, 582, 680, 690, 681, 780, 790, 880, 890, 881). At block 911, the DU transmits a first additional DU-to-CU message including the at least one first reference signal resource configuration to the CU. Blocks 904, 906, 908, 909, and 911 are grouped as block 950B. Unlike FIG. 9A, the DU includes the at least one first reference signal resource configuration in the first additional DU-to-CU message instead of the first DU-to-CU message.

In some implementations, the DU includes the first LTM DU configuration in a first interface protocol IE or field (IE/field) in the first DU-to-CU message. In some implementations, the DU includes the at least one first reference signal resource configuration in a second interface protocol IE/field in the first additional DU-to-CU message. In some implementations, one of the first interface protocol IE/field and the second interface protocol IE/field is a CellGroupConfig IE/field and the other is different from the CellGroupConfig IE/field. In other implementations, one of the first interface protocol IE/field and the second interface protocol IE/field is a DU to CU RRC Information IE/field and the other is different from the DU to CU RRC Information IE/field. The DU includes the first LTM DU configuration and the at least one first reference signal resource configuration in the different interface protocol IEs/fields, so that the CU may retrieve or identifies the first LTM DU configuration and the at least one first reference signal resource configuration from the first interface protocol IE/field and the second interface protocol IE/field, respectively. Thus, the CU may properly transmit the first LTM DU configuration and the at least one first reference signal resource configuration to the UE as described for FIGS. 10A-10C.

In some implementations, the DU generates at least one first report configuration configuring radio resources (e.g., PUCCH resources or PUSCH resources) for reporting of measurement results of the at least one first reference signal, as described for FIG. 9A. In some implementations, the DU includes the at least one first report configuration in the first DU-to-CU message or the first additional DU-to-CU message. In some implementations, the DU transmits a second DU-to-CU message including the second LTM DU configuration to the CU and transmits a second additional DU-to-CU message including the at least one second reference signal resource configuration to the CU, unlike FIG. 9A. In some implementations, the DU generates at least one second report configuration configuring radio resources (e.g., PUCCH resources or PUSCH resources) for reporting of measurement results of the at least one second reference signal, as described for FIG. 9A. In some implementations, the DU includes the at least one second report configuration in the second DU-to-CU message or the second additional DU-to-CU message.

Examples and implementations described for the first or second CU-to-DU message and first or second DU-to-CU message in FIG. 9A may apply to the first or second CU-to-DU message and the first or second DU-to-CU message in FIG. 9B. In some implementations, the first or second additional DU-to-CU message is a UE Context Modification Required message, and the DU receives a UE Context Modification Confirm message from the CU in response to the UE Context Modification Required message. In other implementations, the first or second additional DU-to-CU message is a UE Context Modification Response message in response to a UE Context Modification Request message that the DU receives from the CU.

FIG. 10A illustrates an example method 1000A, which may be implemented by a CU (e.g., the CU 172 of the base station 104 or 106), for enabling LTM for the UE (e.g., the UE 102).

The method 1000A begins at block 1002, where the CU communicates with the UE operating via a first DU (e.g., events 302, 402, 502, 602, 702, 802, 380, 480, 580, 680, 780, 880, 581, 582, 681, 881). At block 1004, the CU transmits a first CU-to-DU message including a first cell ID of a first cell to the first DU to request preparing the first cell for LTM for the UE (e.g., events 308, 390, 380, 490, 480, 580, 590, 581, 582, 680, 690, 681, 780, 790, 880, 890, 881).

In some implementations for block 1008, the CU includes the first LTM DU configuration and the at least one first reference signal resource configuration in a first container (e.g., LTM-Candidate, LTM-Candidate-r18, LTM-CandidateToAddMod, or LTM-Candidate ToAddMod-r18 IE) and includes the first container in the first message.

In other implementations, the CU transmits a second CU-to-DU message including the at least one first reference signal resource configuration to the serving DU. In response, the CU receives, from the serving DU, a second DU-to-CU message including at least one first report configuration. The at least one first report configuration configures radio resources (e.g., PUCCH resources or PUSCH resources) for reporting measurement results of the at least one first reference signal. In some implementations, the CU includes the at least one first report configuration in the first message. Alternatively, the CU transmits a second message including the at least one first report configuration to the UE via the serving DU or the RAN node. In some implementations, the at least one first report configuration is included in a first DU configuration and the second DU-to-CU message includes the first DU configuration. In some implementations, the CU includes the first DU configuration in the first message. Alternatively, the CU transmits a second message including the first DU configuration to the UE via the serving DU or the RAN node. In some implantations, the at least one first reference signal resource configuration is included in the first DU configuration.

In some implementations, the first DU configuration is an RRC IE (e.g., CellGroupConfig IE). In some implementations, the UE applies the first DU configuration immediately upon receiving the first DU configuration. In such cases, the serving DU applies the first DU configuration immediately upon transmitting the first DU configuration to the CU or UE. In some implementations, the UE applies the at least one first report configuration upon receiving the at least one first report configuration.

For example, the UE starts transmitting measurement results of the at least one first reference signal in accordance with the at least one first report configuration, upon receiving the at least one first report configuration. In such cases, the serving DU applies the at least one first report configuration immediately upon transmitting the at least one first report configuration to the CU or the UE. For example, the serving DU starts receiving measurement results of the at least one first reference signal from the UE in accordance with the at least one first report configuration, upon transmitting the at least one first report configuration to the CU or the UE.

In some implementations, the second CU-to-DU message and the second DU-to-CU message are a UE Context Modification Request message and a UE Context Modification Response message, respectively. In other implementations, the second CU-to-DU message and the second DU-to-CU message are a UE Context Modification Request message and a UE Context Modification Required message, respectively. In such cases, the serving DU may transmit a UE Context Modification Response message to the CU in response to the UE Context Modification Request message, and the CU may transmit a UE Context Modification Confirm message to the serving DU in response to the UE Context Modification Required message.

In some implementations, the first DU is the serving DU. In other implementations, the first DU is not the serving DU. At block 1006, the CU receives a first DU-to-CU message, including a first LTM DU configuration and at least one first reference signal resource configuration, from the first DU, where the first LTM DU configuration configures the first cell for LTM and the at least one first reference signal resource configuration configures at least one first reference signal (e.g., events 310, 390, 380, 490, 480, 580, 590, 581, 582, 680, 690, 681, 780, 790, 880, 890, 881). At block 1008, the CU transmits a first message, including the first LTM DU configuration and the at least one first reference signal resource configuration, to the UE via the serving DU or a RAN node (e.g., events 316, 318, 394, 380, 480, 494, 580, 594, 581, 517, 519, 582, 680, 694, 681, 617, 619, 780, 794, 717, 719, 880, 894, 881, 817, 819).

The RAN node may be another DU (e.g., a second DU or a third DU), another CU or a base station. At block 1010, the CU receives an indication message from the first DU, indicating that the UE successfully accesses the first cell (e.g., events 334, 354, 380, 398, 434, 454, 498, 480, 534, 598, 580, 581, 582, 734, 798, 780, 834, 898, 880, 881).

At block 1012, the CU communicates with the UE via the first DU (e.g., events 336, 356, 380, 436, 456, 480, 536, 556, 580, 581, 582, 636, 656, 680, 681, 736, 756, 780, 836, 856, 880, 881).

In some implementations, the CU transmits a third CU-to-DU message including a second cell ID of a second cell to the second DU to request preparing the second cell for LTM for the UE (e.g., events 308, 390, 380, 490, 480, 580, 590, 581, 582, 680, 690, 681, 780, 790, 880, 890, 881). The CU receives a third DU-to-CU message, including a second LTM DU configuration and at least one second reference signal resource configuration, from the second DU (e.g., events 310, 390, 380, 490, 480, 580, 590, 581, 582, 680, 690, 681, 780, 790, 880, 890, 881). The second LTM DU configuration configures the second cell for LTM and the at least one second reference signal resource configuration configures at least one second reference signal. The CU then transmits a third message, including the second LTM DU configuration and the at least one second reference signal resource configuration, to the UE via the first DU or the RAN node (e.g., events 316, 318, 394, 380, 480, 494, 580, 594, 581, 517, 519, 582, 680, 694, 681, 617, 619, 780, 794, 717, 719, 880, 894, 881, 817, 819). In some implementations, the first message and the third message may be combined as a single message.

FIG. 10B is a flow diagram of an example method 1000B similar to the method 1000A, except that method 1000B includes blocks 1005 and 1007 instead of block 1006. At block 1005, the CU receives a first DU-to-CU message, including a first LTM DU configuration, from the first DU, where the first LTM DU configuration configures the first cell for LTM. At block 1007, the CU receives a first additional DU-to-CU message, including at least one first reference signal resource configuration, from the first DU, where the at least one first reference signal configuration configures at least one first reference signal. Unlike FIG. 10A, the CU receives the at least one first reference signal resource configuration in the first additional DU-to-CU message instead of the first DU-to-CU message.

In some implementations, the CU transmits a third CU-to-DU message including a second cell ID of a second cell to the second DU to request preparing the second cell for LTM for the UE (e.g., events 308, 390, 380, 490, 480, 580, 590, 581, 582, 680, 690, 681, 780, 790, 880, 890, 881). The CU receives a third DU-to-CU message, including a second LTM DU configuration from the second DU (e.g., events 310, 390, 380, 490, 480, 580, 590, 581, 582, 680, 690, 681, 780, 790, 880, 890, 881). The CU receives a second additional DU-to-CU message including at least one second reference signal resource configuration from the second DU. The second LTM DU configuration configures the second cell for LTM and the at least one second reference signal resource configuration configures at least one second reference signal. The CU then transmits a third message, including the second LTM DU configuration and the at least one second reference signal resource configuration, to the UE via the serving DU or the RAN node (e.g., events 316, 318, 394, 380, 480, 494, 580, 594, 581, 517, 519, 582, 680, 694, 681, 617, 619, 780, 794, 717, 719, 880, 894, 881, 817, 819).

FIG. 10C is a flow diagram of an example method 1000C similar to the methods 1000A and 1000B, except that method 1000C includes blocks 1009 and 1011 instead of block 1010. At block 1009, the CU transmits a first message including the first LTM DU configuration to the UE via the first (serving) DU or the RAN node (e.g., events 316, 318, 394, 380, 480, 494, 580, 594, 581, 517, 519, 582, 680, 694, 681, 617, 619, 780, 794, 717, 719, 880, 894, 881, 817, 819). At block 1011, the CU transmits a first additional message including the at least one first reference signal resource configuration to the UE via the serving DU or the RAN node. Unlike FIGS. 10A and 10B, the CU transmits the first LTM DU configuration and the at least one first reference signal resource configuration in the first message and the first additional message, respectively. In some implementations, the first message and the first additional message are RRC messages (e.g., RRC reconfiguration messages).

In some implementations, the CU transmits a third CU-to-DU message including a second cell ID of a second cell to the second DU to request preparing the second cell for LTM for the UE (e.g., events 308, 390, 380, 490, 480, 580, 590, 581, 582, 680, 690, 681, 780, 790, 880, 890, 881). The CU receives a third DU-to-CU message, including a second LTM DU configuration from the second DU (e.g., events 310, 390, 380, 490, 480, 580, 590, 581, 582, 680, 690, 681, 780, 790, 880, 890, 881). The CU receives a second additional DU-to-CU message including at least one second reference signal resource configuration from the second DU. The second LTM DU configuration configures the second cell for LTM and the at least one second reference signal resource configuration configures at least one second reference signal. The CU then transmits a third message, including the second LTM DU configuration and the at least one second reference signal resource configuration, to the UE via the serving DU or the RAN node (e.g., events 316, 318, 394, 380, 480, 494, 580, 594, 581, 517, 519, 582, 680, 694, 681, 617, 619, 780, 794, 717, 719, 880, 894, 881, 817, 819). Alternatively, the CU does not include the at least one second reference signal resource configuration in the second message and transmits a third additional message including the at least one second reference signal resource configuration to the UE via the serving DU or the RAN node. In some implementations, the second message and/or the second additional messages are RRC messages (e.g., RRC reconfiguration messages).

Examples and implementations described for FIGS. 9A and 9B may apply to FIGS. 10A-10C. Examples and implementations described for one of FIGS. 10A-10C may apply to the other.

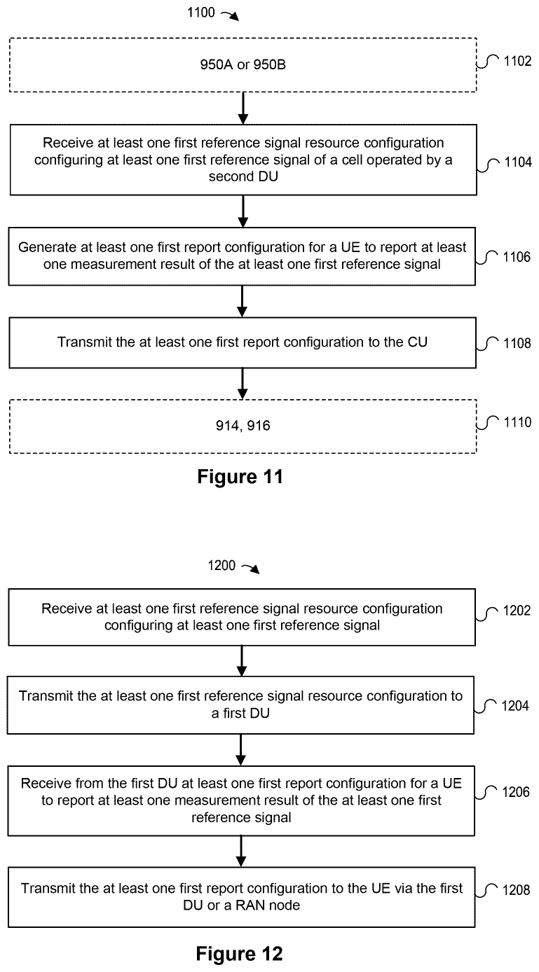

FIG. 11 illustrates an example method 1100, which may be implemented by a first DU (e.g., the DU 174, 174A, 174B or 174C of the base station 104 or 106 in FIGS. 3-8B), for enabling LTM for a UE (e.g., the UE 102).

The method 1100 begins at block 1102, where the first DU performs actions described in block 950A of FIG. 9A or block 950B of FIG. 9B. At block 1104, the first DU receives at least one first reference signal resource configuration configuring at least one first reference signal of a cell operated by a second DU. In some implementations, the first DU receives the at least one first reference signal resource configuration from the CU. In other implementations, the first DU receives the at least one first reference signal resource configuration from an Operations, Administration and Maintenance, OAM, node. In yet other implementations, the first DU receives the at least one first reference signal resource configuration from the second DU.

At block 1106, the first DU generates at least one first report configuration for the UE to report at least one measurement result of the at least one first reference signal. At block 1108, the first DU transmits the at least one first report configuration to the CU. At block 1110, the first DU performs actions described in blocks 914 and 916 of FIG. 9A. In some implementations, when the CU receives the at least one first report configuration from the first DU, the CU transmits the at least one first report configuration to the UE via the first DU or a RAN node (e.g., the second DU, another DU, another CU or a baes station).

In some implementations, the first DU receives a CU-to-DU message including the at least one first reference signal resource configuration from the CU at block 1104. In response, the first DU transmits a DU-to-CU message including the DU configuration to the CU at block 1108. In some implementations, the CU-to-DU message and DU-to-CU message is the first CU-to-DU message and the first DU-to-CU message in block 950A or 950B, respectively. In other implementations, the DU-to-CU message is the first additional DU-to-CU message in block 950B. In such cases, the CU-to-DU message is the first CU-to-DU message or the first additional CU-to-DU message described for FIG. 9A or 9B.

In some implementations, the first DU includes the at least one first report configuration in a DU configuration and transmits the DU configuration to the CU at block 1108, and the CU transmits the DU configuration to the UE via the DU or RAN node. For example, the DU configuration is an RRC IE (e.g., CellGroupConfig IE). In some implementations, the DU may include the at least one first reference signal resource configuration in the DU configuration. Alternatively, the DU does not include the at least one first reference signal resource configuration in the DU configuration.

In some implementations, if the first DU is a target DU (e.g., the T-DU 174B of FIGS. 4, 6A-6B, and 8A-8B), the DU configuration is an LTM DU configuration (e.g., the first LTM DU configuration in block 950A or 950B). In some implementations, the first DU may include the LTM DU configuration in a first interface protocol IE/field in the DU-to-CU message. When the CU receives the LTM DU configuration, the CU transmits the LTM DU configuration to the UE via the first DU or RAN node as described above.

The UE does not apply the LTM DU configuration or the at least one first report configuration until receiving an LTM command from a/the DU of the RAN node activating the LTM DU configuration.

In some implementations, if the first DU is a serving DU (e.g., the DU 174 of FIGS. 3, 5A, and 5B, S-DU 174A of FIGS. 4, 6A, and 6B, M-DU 174A of FIGS. 7A-8B, S-DU 174B of FIGS. 7A-8B), the DU configuration is not an LTM DU configuration. That is, the UE applies the DU configuration upon receiving the DU configuration without receiving an LTM command.

Examples and implementations described for FIGS. 9A-10C may apply to FIG. 11.

FIG. 12 illustrates an example method 1200, which may be implemented by a CU (e.g., the CU 172 of the base station 104 or 106) connecting to a first DU and a second DU, for enabling LTM for the UE (e.g., the UE 102).

The method 1200 begins at block 1202, where the CU receives at least one first reference signal resource configuration configuring at least one first reference signal. In some implementations, the CU receives the at least one first reference signal resource configuration from the second DU. At block 1204, the CU transmits the at least one first reference signal resource configuration to the first DU. At block 1206, the CU receives from the first DU at least one first report configuration for the UE to report at least one measurement result of the at least one first reference signal. At block 1208, the CU transmits the at least one first report configuration to the UE via the first DU or a RAN node.

Examples and implementations described for FIGS. 9A-11 may apply to FIG. 12.

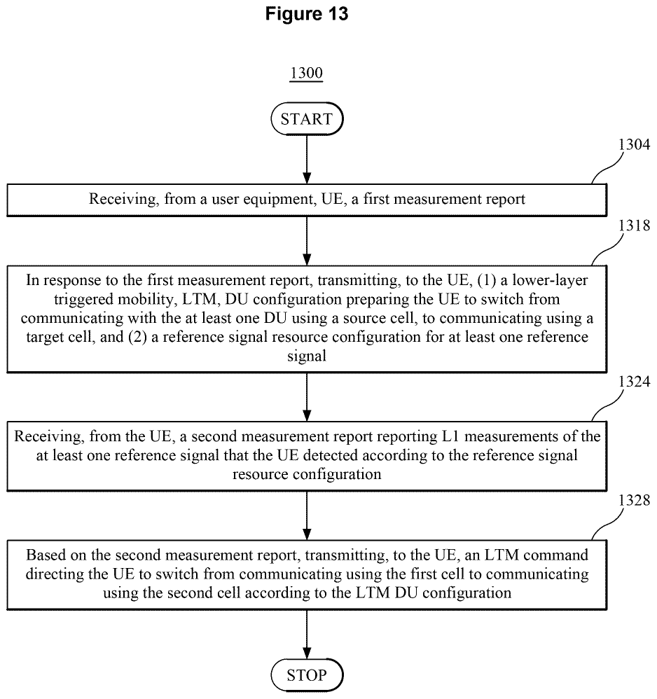

FIG. 13 is a flowchart of a method 1300 performed by a performed by a network entity, NE, (such as NE 280 or base station 104, 106) including a DU (such as DU 174) and a CU (such as CU 172) according to an embodiment. Method 1300 includes the NE receiving 1304, from a user equipment, UE, a first measurement report. In response to the first measurement report, the NE transmits 1318: (1) an LTM DU configuration preparing the UE to switch from a first cell (e.g., source cell) to a second cell (e.g., target cell), and (2) a reference signal resource configuration for at least one reference signal. Method 1300 further includes the NE receiving 1324, from the UE, a second measurement report reporting L1 measurements of the at least one reference signal based on the reference signal resource configuration. Then, based on the second measurement report, the NE transmits 1328, to the UE, an LTM command directing the UE to switch from the first cell to the second cell according to the LTM DU configuration.

Examples and implementations described for FIGS. 9A-12 may apply to FIG. 13.

The following description may be applied to the description above.

Generally speaking, a description for one of the above figures may apply to another of the above figures. Examples, implementations and methods described above may be combined, if there is no conflict. An event or block described above may be optional or omitted. For example, an event or block with dashed lines in the figures may be optional. In some implementations, “message” is used and may be replaced by “information element (IE)”, and vice versa. In some implementations, “IE” is used and may be replaced by “field”, and vice versa. In some implementations, “configuration” may be replaced by “configurations” or “configuration parameters”, and vice versa. In some implementations, the “LTM command” may be replaced by “serving cell change command”, “Layer 1/Layer 2 switching command”, “lower layer switching command” or “lower layer serving cell change command”. In some implementations, “some” means “one or more”. In some implementations, “at least one” means “one or more”. In some implementations, the “DU configuration” may be replaced by “cell group configuration”. In some implementations, the “cell index” may be replaced with “serving cell index”, “LTM cell index”, “special cell (SpCell) index”, “PCell index” or “PSCell index”. In some implementations, the “serving” can be replaced by “source” and vice versa. In some implementations, the “measurement report” can be replaced by “measurement result(s)” and vice versa.

A user device in which the techniques of this disclosure may be implemented (e.g., the UE 102) may be any suitable device capable of wireless communications such as a smartphone, a tablet computer, a laptop computer, a mobile gaming console, a point-of-sale, POS, terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system, ADAS. Still further, the user device may operate as an internet-of-things, IoT, device or a mobile-internet device, MID. Depending on the type, the user device may include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module may comprise dedicated circuitry or logic that is permanently configured (e.g., as a special-purpose processor, such as a field programmable gate array, FPGA, or an application-specific integrated circuit. ASIC, a digital signal processor, DSP, etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques may be provided as part of the operating system, a library used by multiple applications, a particular software application, etc. The software may be executed by one or more general-purpose processors or one or more special-purpose processors.

Upon reading this disclosure, those of skill in the art will foresee additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

Example 1. A wireless communication method performed by a DU of an NE, the DU communicating with a UE and a CU of the NE, includes: (1) receiving, from the CU, a CU-to-DU message identifying a cell and requesting to prepare a lower-layer triggered mobility, LTM, for connecting to the NE via the cell; (2) transmitting to the CU, an LTM DU configuration for the LTM and at least one reference signal resource configuration for a reference signal on the cell; (3) transmitting, to the UE, the reference signal on the cell according to the at least one reference signal resource configuration; and (4) receiving, from the UE, a measurement report in response to the reference signal transmitted on the cell.

Example 2. The wireless communication method of example 1 that further includes transmitting, to the UE, an LTM command directing the UE to connect via the cell.

Example 3. The wireless communication method of any of example 1 or 2 that further includes transmitting, to the UE, a report configuration for the UE to report the measurement report.

Example 4. The wireless communication method of any of examples 1 to 3, wherein the transmitting of the LTM DU configuration and of the at least one reference signal resource configuration includes: sending, to the CU, a first DU-to-CU message including the LTM DU configuration; and sending, to the CU, a second DU-to-CU message including the at least one reference signal resource configuration.

Example 5. The wireless communication method of any of examples 1 to 4 that further includes: detecting a UE access via the cell, and transmitting, to the CU, an indication signaling that the UE successfully connected via the cell.

Example 6. The wireless communication method of any of examples 1 to 5 that further includes forwarding an initial measurement report received from the UE to the CU, wherein the receiving of the CU-to-DU message follows the forwarding of the initial measurement report.

Example 7. The wireless communication method of example 6, wherein the initial measurement report includes at least one of a Layer 1 measurement report or a Layer 3 measurement report.

Example 8. A wireless communication method performed by a CU of an NE includes: (1) transmitting, to a DU of the NE, a CU-to-DU message identifying a cell and requesting to prepare a LTM for connecting a UE, which communicates to the CU via the DU, to the distributed NE via the cell; (2) receiving, from the DU, a LTM DU configuration for the LTM and at least one reference signal resource configuration for a reference signal on the cell; and (3) transmitting, to the UE, the LTM DU configuration and the at least one reference signal resource configuration.

Example 9. The wireless communication method of example 8 that further includes: receiving, from the DU, a report configuration for the UE to report a measurement report associated with the reference signal on the cell; and transmitting, to the UE, the report configuration.

Example 10. The wireless communication method of example 9, wherein the transmitting of the report configuration employs another network entity.

Example 11. The wireless communication method of any of examples 8 to 10, wherein the receiving of the LTM DU configuration and the at least one reference signal resource configuration includes: receiving a first DU-to-CU2 message including the LTM DU configuration; and receiving a second DU-to-CU message including the at least one reference signal resource configuration.

Example 12. The wireless communication method of any of examples 8 to 11, further includes: receiving, from the DU, an indication that the UE successfully connected via the cell.

Example 13. The wireless communication method of any of examples 8 to 12, wherein the transmitting of the LTM DU configuration and the at least one reference signal resource configuration includes: transmitting a first CU-to-UE message including the LTM DU configuration; and transmitting a second CU-to-UE message including the at least one reference signal resource configuration.

Example 14. The wireless communication method of any of examples 8 to 13, wherein at least one of the LTM DU configuration and the at least one reference signal resource configuration is transmitted to the UE via the DU.

Example 15. The wireless communication method of any of examples 8 to 13, wherein at least one of the LTM DU configuration and the at least one reference signal resource configuration is transmitted to the UE via another network entity.

Example 16. A wireless communication method performed by an NE including at least one DU and a CU, that includes: (1) receiving, from a UE, a first measurement report for the CU using a first UE-to-CU connection via the at least one DU; (2) in response to the first measurement report, transmitting, to the UE, a LTM DU configuration message for preparing the UE to switch from the first UE-to-CU connection to a second UE-to-CU connection and including information for a lower-layer measurement; (3) receiving, from the UE, a second measurement report reporting layer 1, L1, measurements of reference signals received via at least two cells according to the information for the lower-layer measurement; and (4) transmitting, to the UE, an LTM command for switching from the first UE-to-CU connection to the second UE-to-CU connection based on the second measurement report.

Example 17. The wireless communication method of example 16, wherein the first UE-to-CU connection employs a first cell and the second UE-to-CU connection employs a second cell different from the first cell.

Example 18. The wireless communication method of example 17, wherein the LTM command includes an identifier of the second cell.

Example 19. The wireless communication method of any of examples 17 or 18, that further includes receiving a third measurement report, from the UE, reporting L1 measurements; and transmitting another LTM command for switching from the second UE-to-CU connection to a third UE-to-CU connection based on the third measurement report, the third UE-to-CU connection using a third cell different from the second cell.

Example 20. The wireless communication method of example 19, wherein the other LTM command includes an identifier of the third cell.

Example 21. The wireless communication method of any of examples 16 to 20, wherein the information for the lower-layer measurement includes a reference signal configuration and/or an L1 measurement report configuration.

Example 22. The method of any of examples 16 to 21, that further includes: releasing communication resources included in the first UE-to-CU connection and excluded from the second UE-to-CU connection.

Example 23. The wireless communication method of any of examples 16 to 22, wherein the at least one DU includes a source DU and a target DU, the first UE-to-CU connection uses the source DU and the second UE-to-CU connection uses the target DU.

Example 24. The wireless communication method of example 23, that further includes exchanging messages between the CU and the source DU during a configuration query before the transmitting of the reference lower-layer triggered mobility.

Example 25. The wireless communication method of any of examples 16 to 22, wherein the at least one DU includes a master DU and a secondary DU, and the first UE-to-CU connection includes the secondary DU.

Example 26. The wireless communication method of example 25, wherein the transmitting of the reference LTM DU configuration message to the UE includes a first transmission from the CU to the master DU and a second transmission from the master DU to the UE.

Example 27. The wireless communication method of any of examples 16 to 22, wherein the at least one DU includes a master DU, a source DU, and a target DU, and the first UE-to-CU connection includes the source DU.

Example 28. The wireless communication method of example 27 that further includes exchanging messages between the CU and the source DU during a configuration query before the transmitting of the reference lower-layer triggered mobility.

Example 29. The wireless communication method of any of examples 26 or 27, wherein the transmitting of the reference LTM DU configuration message to the UE includes a first transmission from the CU to the master DU and a second transmission from the master DU to the UE.

Example 30. A wireless communication method performed by an NE with at least one DU and a CU, the NE operating as a secondary node, SN, for a user equipment, UE, that is also connected to a master node, MN, includes: (1) receiving a first measurement report from a UE using a first UE-to-CU connection via the at least one DU; (2) in response to the first measurement report, transmitting, to the UE, a reference LTM DU configuration message for preparing the UE to switch from the first UE-to-CU connection to a second UE-to-CU connection and including information for a lower-layer measurement; (3) receiving, from the UE, a second measurement report reporting layer 1, L1, measurements of reference signals received via at least two cells, according to the information for the lower-layer measurement; and (4) transmitting, to the UE, an LTM command for switching from the first UE-to-CU connection to the second UE-to-CU connection based on the second measurement report.

Example 31. The wireless communication method of example 30, wherein the first UE-to-CU connection employs a first cell and the second UE-to-CU connection employs a second cell different from the first cell.

Example 32. The wireless communication method of example 31, wherein the LTM command includes an identifier of the second cell.

Example 33. The wireless communication method of any of examples 30 to 32, wherein the information for the lower-layer measurement includes a reference signal configuration.

Example 34. The wireless communication method of any of examples 30 to 33 that further includes: releasing communication resources included in the first UE-to-CU connection and excluded from the second UE-to-CU connection.

Example 35. The wireless communication method of any of examples 30 to 34, wherein the transmitting of the LTM is performed via the MN.

Example 36. The wireless communication method of any of examples 30 to 35, wherein the at least one DU includes a source DU and a target DU, the first UE-to-CU connection uses the source DU and the second UE-to-CU connection uses the target DU.

Example 37. A wireless communication method performed by a UE in communication with a network entity including at least one DU and a CU includes: (1) transmitting a first measurement report for the CU using a first UE-to-CU connection via the at least one DU; (2) receiving, in response to the first measurement report, a reference LTM DU configuration message preparing the UE for switching from the first UE-to-CU connection to a second UE-to-CU connection, and including information for a lower-layer measurement; (3) transmitting, for the CU, a second measurement report reporting layer 1, L1, measurements of reference signals received via at least two cells according to the information for the lower-layer measurement; and (4) receiving, an LTM command for switching from the first UE-to-CU connection to the second UE-to-CU connection.

Example 38. The wireless communication method of example 37, wherein the first UE-to-CU connection employs a first cell and the second UE-to-CU connection employs a second cell different from the first cell.

Example 39. The wireless communication method of example 38, wherein the LTM command includes an identifier of the second cell.

Example 40. The wireless communication method of any of examples 37 to 39, wherein the information for the lower-layer measurement includes a reference signal configuration.

A wireless communication device having a transceiver, a processor and computer-readable storage media storing executable instructions for the processor to perform any one of the methods recited in examples 1-40, using the transceiver.

1-17. (canceled)

18. A wireless communication method performed by a first distributed unit, DU, of a network entity, NE, the first DU communicating with a user equipment, UE, and a centralized unit, CU, of the NE, the method comprising:
receiving, from the CU, a CU-to-DU message, including a cell ID of a first cell and at least one first reference signal resource configuration configuring at least one first reference signal;
generating, at least one report configuration for the UE to report at least one measurement result of the at least one first reference signal; and
transmitting, to the CU, a DU-to-CU message, including the at least one report configuration.

19. The wireless communication method of claim 18, wherein the CU-to-DU message and the DU-to-CU message are a UE Context Modification Request message and a UE Context Modification Response message, respectively.

20. The wireless communication method of claim 18, wherein the first DU is a target DU or a serving DU.

21. The wireless communication method of claim 18, wherein the CU-to-DU message and the DU-to-CU message are a UE Context Setup Request message and a UE Context Setup Response message, respectively.

22. The wireless communication method of claim 18, further comprising:
including the at least one report configuration in a DU configuration for the first cell, wherein the transmitting includes transmitting the DU configuration.

23. The wireless communication method of claim 18, further comprising:
receiving, from the UE, a lower-layer measurement report related to the at least one first reference signal; and
based on the lower-layer measurement report, transmitting, to the UE, a lower-layer triggered mobility (LTM) command directing the UE to switch to a target cell.

24. The wireless communication method of claim 18, further comprising:
receiving, from the CU, the CU-to-DU message identifying the target cell and directing the DU to prepare a LTM DU configuration for switching the UE from a source cell to the target cell; and
transmitting, to the CU, the LTM DU configuration and a reference signal resource configuration for the at least one first reference signal to be transmitted on the target cell.

25. A wireless communication method performed by a centralized unit, CU, of a network entity, NE, the method comprising:
transmitting, a CU-to-DU message, including a cell ID of a first cell and at least one reference signal resource configuration configuring at least one first reference signal to a first distributed unit, DU, of the NE;
receiving, from the first distributed unit, DU, of the NE, a DU-to-CU message including at least one first report configuration for a user equipment, UE, to report at least one measurement result of the at least one first reference signal; and
transmitting, to the UE, the at least one first report configuration.

26. The wireless communication method of claim 25, further comprising:
receiving, the at least one reference signal resource configuration configuring the at least one first reference signal.

27. The wireless communication method of claim 25, wherein the at least one reference signal resource configuration is received from a second DU.

28. The wireless communication method of claim 25, wherein the at least one reference signal resource configuration is transmitted to the UE via the first DU or a radio access network, RAN, node.

29. The wireless communication method of claim 25, further comprising connecting the first DU and a second DU to enable lower-layer triggered mobility, LTM, for the UE.

30. The wireless communication method of claim 25, further comprising receiving an LTM DU configuration for switching a user equipment, UE, from a source cell to a target cell.

31. A first distributed unit (DU) of a network entity (NE), the first DU communicating with a user equipment (UE) and a centralized unit (CU) of the NE, the first DU comprising:
a transceiver; and
a processor coupled to the transceiver and configured to:
receive, from the CU, a CU-to-DU message, including a cell ID of a first cell and at least one first reference signal resource configuration configuring at least one first reference signal,
generate, at least one report configuration for the UE to report at least one measurement result of the at least one first reference signal, and
transmit, to the CU, a DU-to-CU message, including the at least one report configuration.

32. The first DU of claim 31, wherein the processor is further configured to:
include the at least one report configuration in a DU configuration for the first cell, and transmit the DU configuration.

33. The first DU of claim 31, wherein the processor is further configured to:
receive, from the UE, a lower-layer measurement report related to the at least one first reference signal, and
based on the lower-layer measurement report, transmit, to the UE, an LTM command directing the UE to switch to a target cell.

34. The first DU of claim 31, wherein the CU-to-DU message and the DU-to-CU message are a UE Context Modification Request message and a UE Context Modification Response message, respectively.

35. The first DU of claim 31, wherein the first DU is a target DU or a serving DU.

36. A centralized unit (CU) of a network entity (NE) comprising:
a transceiver; and
a processor coupled to the transceiver and configured to:
transmit, a CU-to-DU message, including a cell ID of a first cell and at least one reference signal resource configuration configuring at least one first reference signal to a first distributed unit (DU) of the NE,
receive, from the first DU of the NE, a DU-to-CU message including at least one first report configuration for a user equipment (UE), to report at least one measurement result of the at least one first reference signal, and
transmit, to the UE, the at least one first report configuration.

37. The CU of claim 36, wherein the processor is further configured to receive an LTM DU configuration for switching a UE, from a source cell to a target cell.
